(19) United States
(12) Patent Application Publication
(10) Pub. No.: US 2026/0213883 A1
(43) Pub. Date: Jul. 23, 2026

(54) ETHERNET DATA TRANSFER FOR AUTONOMOUS AND SEMI-AUTONOMOUS SYSTEMS AND APPLICATIONS

(71) Applicant: NVIDIA Corporation, Santa Clara, CA (US)

(72) Inventors: Sanjeev JAIN, Chandler, AZ (US); Srinivas RAMACHANDRAN, Santa Clara, CA (US); Mrudula KANURI, Campbell, CA (US)

(21) Appl. No.: 18/450,984

(22) Filed: Aug. 16, 2023

(51) Int. Cl. H04L 1/1607; H04L 1/1812

(52) U.S. Cl. CPC H04L 1/1642; H04L 1/1816

(57) ABSTRACT

Embodiments of the present disclosure relate to a system and method used to transfer data via Ethernet. The system may include memory for storing data that may be received via Ethernet packets. In particular, the Ethernet packets may include a payload that may include one or more segments and a header. The header may include a sequence number field indicating a respective sequence number that corresponds to the respective segment, and a byte offset field that may indicate a respective byte offset that may be applied to the segment. Further, the system may include hardware that may be configured to perform packet analysis operations including determining whether a previously transmitted segment was lost. The system may additionally include a processing system for performing data processing operations including storing individual segments at respective memory locations based on the respective byte offsets included in the Ethernet packets.

### BACKGROUND

Many systems, such as many modern vehicles, include one or more components that transmit and receive large amounts of data. For example, autonomous and semi-autonomous vehicles or machines include many electronically connected components communicating data, such as sensor data, deep learning models, image data, control commands, map data, and other data that may be communicated between components, systems, subsystems, etc. of the machine. The data may be communicated to manipulate the data, perform calculations, perform one or more other operations corresponding to the data and/or the vehicle, and/or perform one or more control operations such as braking, accelerating, steering, notifications regarding objects, etc.

In many instances, the electrically connected components may include one or more electronic control units (ECUs). The one or more ECUs include one or more controllers, microcontrollers, devices, systems, embedded systems, modules, etc. that may control one or more specific functions corresponding to the vehicle. In many instances, the one or more ECUs are interconnected to collaborate and perform various tasks, such as managing engine control, transmission control, braking systems, and other subsystems. In many instances, given that the data may be used to assess an environment corresponding to the vehicle operations in real-time or near real-time to allow for decision making based on the environment, the faster the data is communicated between one or more ECUs, the better.

Additionally or alternatively, the vehicles often incorporate one or more image sensors (e.g., cameras) used to obtain information about the environment at which the vehicles may be located. The image data that may be obtained using the cameras may be sent to a processing system for analysis and processing. The processing of the image data may be used for any number of operations such as perception, planning, actuation (e.g., braking, accelerating, steering), notifications regarding objects, etc. Further, like the ECU-to-ECU communication, the faster the image data may be communicated and processed to analyze the environment in which the vehicle is located, the better.

In many instances, an amount of data communicated between systems has increased commensurate with increases in system complexity, the number of sensors corresponding to a system, increases in map data detail and complexity, etc. Correspondingly, an amount of bandwidth used to communicate the data has increased and continues to increase.

In response to the increase in bandwidth used for data communication, many systems resort to using Ethernet protocols for communication. Ethernet protocols are typically used due to their capability for handling higher bandwidth as compared with other protocols. Many traditional protocols for communication of data to corresponding processing systems in the automotive/robotics context include a Gigabit Multimedia Serial Link (GMSL) communication interface that may be used to communicate large amounts of data between components, devices, systems, etc. However, such an approach may require the use of substantial amounts of proprietary cabling along with multiple serializers and de-serializers.

Additionally or alternatively, other traditional approaches to Ethernet data transfer require large amounts of data processing using one or more processing units, such as, for example, one or more central processing units (CPUs). In some instances, the number of processing units needed may be dependent on an amount of data being transferred and/or communicated. As the amount of data that may be transferred via Ethernet increases, a corresponding number of processing units may also increase to process data being transferred. Further, using processing units for data transfer preoccupies the processing units that may be used for different tasks.

### SUMMARY

According to one or more embodiments of the present disclosure, a system may be configured to perform one or more operations corresponding to data transferred via Ethernet. In some embodiments, the system may include memory that may be configured to store data, where the data may be received via Ethernet packets. In some embodiments, the data may be divided into data segments that may be sequentially ordered according to a sequence, where one or more of the Ethernet packets may respectively include a payload and a header. In some embodiments, the payload may include a respective data segment. In some embodiments, the header may include a sequence number field that may indicate a respective sequence number within the sequence that may correspond to the respective data segment. Further, in some embodiments, the header may include a byte offset field that may indicate a respective byte offset that may be applied to the data segment.

Further, in some embodiments, the system may additionally include hardware that may be configured to perform one or more packet analysis operations. The packet analysis operations may include determining whether a previously transmitted data segment was lost based on a first sequence number that may correspond to a first data segment and based on a second sequence number that may correspond to a second data segment that may have been received prior to the first data segment.

In some embodiments, the system may further include a processing system for performing one or more data processing operations with respect to the Ethernet packets. The data processing operations may include causing individual data segments to be stored at respective memory locations included in the memory based on the respective byte offsets that may have been included in the Ethernet packets. In some embodiments, the respective memory locations may be derived using data and/or information included in one or more header fields.

The embodiments of the present disclosure may help reduce the amount of processing resources that may be used as compared to other mechanisms for communicating sensor data. Additionally or alternatively, one or more embodiments described in the present disclosure may help facilitate and/or expedite one or more processing operations corresponding to the communicated sensor data as compared with other traditional approaches to communicating sensor data.

### BRIEF DESCRIPTION OF THE DRAWINGS

The present systems and methods for Ethernet data transfer are described in detail in the present disclosure with reference to the attached drawing figures, wherein:

FIG. 1A is a diagram representing an example environment related to transmitting and receiving data, in accordance with one or more embodiments of the present disclosure;

FIG. 1B is an example diagram representing a modified header modified from a traditional header corresponding to the packets of FIG. 1A, in accordance with one or more embodiments of the present disclosure;

FIG. 1C illustrates an example diagram representing packet information, in accordance with one or more embodiments of the present disclosure;

FIG. 2A is a diagram representing an example environment related to transmitting and receiving image data, in accordance with one or more embodiments of the present disclosure;

FIG. 2B is an example diagram representing a modified 1722 header corresponding to image data and/or packets of FIG. 2A, in accordance with one or more embodiments of the present disclosure;

FIG. 3 is a flow diagram showing a method for processing data transferred via Ethernet, in accordance with one or more embodiments of the present disclosure;

FIG. 4A is an illustration of an example autonomous vehicle, in accordance with some embodiments of the present disclosure;

FIG. 4B is an example of camera locations and fields of view for the example autonomous vehicle of FIG. 4A, in accordance with some embodiments of the present disclosure;

FIG. 4C is a block diagram of an example system architecture for the example autonomous vehicle of FIG. 4A, in accordance with some embodiments of the present disclosure;

FIG. 4D is a system diagram for communication between cloud-based server(s) and the example autonomous vehicle of FIG. 4A, in accordance with some embodiments of the present disclosure;

FIG. 5 is a block diagram of an example computing device suitable for use in implementing some embodiments of the present disclosure; and

FIG. 6 is a block diagram of an example data center suitable for use in implementing some embodiments of the present disclosure.

### DETAILED DESCRIPTION

One or more embodiments of the present disclosure may relate to transferring data via one or more communication protocols. For example, the communication protocol may include one or more Ethernet protocols that may be able to communicate large amounts of data between one or more components corresponding to a system in a shorter amount of time than various other protocols. In particular, the communication protocol may include adding and/or modifying header fields and corresponding data that may allow for a reduction in processing that is traditionally done using one or more processing units (e.g., one or more CPUs). In the present disclosure, the new header fields and/or corresponding new header data populated in those fields may be referred to generally as a “new header” or “modified header.” Although primarily described with respect to Ethernet herein, this is not intended to be limiting, and other communication protocols may use the systems and methods described herein without departing from the scope of the present disclosure.

For example, in some embodiments, a set of data (also referred to as a “data frame”) may be divided into multiple data segments (also referred to in general as “segments”) that are respectively communicated via individual Ethernet packets (also referred to in general as “packets”). In some embodiments, the segments may be included in respective payloads corresponding to respective packets. In some instances in the present disclosure, reference to a particular payload may be synonymous with reference to a particular segment. Additionally or alternatively, reference to a particular payload may include a particular segment and other data; for example, one or more reserved bits.

In some embodiments, the segments may be sequentially ordered according to a sequence. For example, the sensor data may be organized in a particular manner prior to being divided into the segments and the ordering of the sequence may reflect such organization.

In some embodiments, by contrast, the sensor data may not be organized in a particular manner prior to being divided into particular segments. Rather, the segments may include a set amount of data therein such that sensor data may be divided into segments based on the set amount of data. For example, a data frame may include ten (10) kilobytes of data and segments corresponding to the data frame may each include one (1) kilobyte of such data. Continuing the example, the first kilobyte of data in the data frame may correspond to a first segment, a second kilobyte of data in the data frame may correspond to a second data frame, and so on.

In some embodiments, the new header may include a sequence number field. The sequence number field may indicate a respective sequence number within the sequence that corresponds to a respective segment that is included in the payload of a corresponding packet. In some embodiments, without limitation, the sequence numbering may be an integer, begin at zero “0”, and incrementally move upward in increments of one. Continuing the above example with the data frame including ten (10) kilobytes, a first sequence number field corresponding to the first segment may include a first sequence number zero (0), a second sequence number field corresponding to the second segment may include a second sequence number one (1), and so on.

Additionally or alternatively, the new header may include a byte offset field. The byte offset field may indicate a respective byte offset to be applied to the respective segment included in the payload of the corresponding packet. The byte offset may indicate how many bytes away the respective segment is to be stored from a base memory location that may be assigned to a corresponding data frame. The base memory location may include a beginning memory address (“base address”) for storage of the data frame. In some embodiments, the base address may include a pointer that may indicate a particular location in memory to store a data frame. As such, in some embodiments, the byte offset may indicate an offset away from the base address at which the respective segment corresponding to a particular data frame is to be stored.

In some embodiments, the new header may be used by a receiving system to direct the storage of the segments to their corresponding memory addresses. For example, receive hardware of the receiving system may be configured to read the byte offsets included in the byte offset fields of respective packets. Based on the byte offset and the base memory address, the receive hardware may be configured to direct the storage of the segments of the corresponding packets to corresponding memory locations.

Additionally or alternatively, in some embodiments, the new header may be used to determine whether all the segments associated with a particular data frame have been received. In some embodiments, the sequence numbers included in the sequence number fields of the new header may be used to make such a determination.

In some embodiments, the receive hardware may be configured to report, to a processing system, instances in which received sequence numbers do not follow the sequence, which may indicate that a particular packet carrying a particular segment was lost somewhere during transmission. In these or other embodiments, the processing system may be configured to request that the data frame be retransmitted in response to one or more segments being missing. Additionally or alternatively, the processing system may request a retransmission of the missing segment.

In some embodiments, the receive hardware may be configured to detect that one or more segments corresponding to data received in real time or near real-time (e.g., image data, sensor data, and other real-time data) may not have been sent in a particular transmission. In some embodiments, in response to detecting and/or determining that one or more segments may be missing from a particular transmission of real-time (or near real-time) data, one or more processing systems may delete, remove, or otherwise not store data corresponding to the data frame associated with the missing segment or segments.

In some embodiments, even when particular packets including respective segments may be missing, segments received after the missing segment(s) may be stored in their designated memory locations. In these or other embodiments, the receive hardware may be configured to write segments received after the missing segments to their correct memory locations due to the byte offsets included in the byte offset fields. The byte offsets may enable the receive hardware to determine memory locations for each segment individually rather than basing memory locations corresponding to particular segments on memory locations of previously received segments.

By comparison, implementation of traditional data transfer protocols may copy segments to sequential memory locations even in instances in which the segments may be lost, thereby storing particular data in memory locations different from those that may have been designated for the particular data. Further, the traditional data transfer protocols may require additional processing to reshuffle the data in such instances such that it is stored where it was originally designated. By contrast, embodiments of the present disclosure may include one or more modifications to existing communication protocols that may help reduce an amount of processing and/or memory resources used for data transfer.

In many instances, as capabilities, technology, and processes associated with autonomous or semi-autonomous vehicles continue to develop, an amount of bandwidth used, for example, for ECU-to-ECU communication correspondingly increases. Currently, for example, inter-ECU communication uses on the order of fifty (50) gigabits per second (gbps) for data communication. To process the increase in communicated data, vehicles and various subsystems corresponding to the vehicles use one or more processing units (e.g., CPUs). However, in some instances, bandwidth usage of ten (10) gbps typically uses one (1) CPU core, and, as data communication increases, the number of CPU cores and corresponding processing power correspondingly increase. Further, additional processing power that could be used to perform one or more other functions is used instead for data communication and storage.

One or more embodiments of the present disclosure may help to decrease the number of CPU cores and/or the amount of processing power used to process and/or store data in-memory. In some embodiments, the new and/or modified header(s) may include information that may allow one or more other hardware components to write one or more segments onto correct data storage locations. Further, the new header may include information such that a processing unit is notified only in certain instances (e.g., a start of a data frame, end of a data frame, missing data, etc.). Accordingly, embodiments described herein may decrease processing power and resources dedicated to ECU-to-ECU transfer while accurately storing and processing data transferred between components.

In addition to ECU-to-ECU data transfer, embodiments of the present disclosure may relate to communicating image data throughout one or more systems (e.g., autonomous and/or semi-autonomous vehicles). In some instances, with advancements made in autonomous driving, communication of image data from one or more image sensors is a critical component of vehicle operations. For example, in a given automotive chassis, there may be several cameras and/or image sensors (e.g., twenty (20) or more) that may be capturing image data corresponding to various angles associated with an environment in which the vehicle may be located. The image sensors generate image data that may be communicated to one or more systems within the vehicle for driver assistance, self-driving systems, perception systems, etc. In many instances, the image data may be used to generate control or actuation operations corresponding to steering, acceleration, braking, route information, etc. To determine accurate control operations, image data is communicated as quickly and accurately as possible, the faster the image data may be accurately communicated, the better the vehicle may operate in real time or near real-time.

One or more existing solutions for transporting image data to, for example, one or more processing systems, is by using a camera serial interface (CSI) protocol. In many instances, the communication of large amounts of image data is accompanied by many proprietary cabling and serializers/de-serializers.

By contrast, the communication protocol of the present disclosure may include a modification to the existing IEEE 1722 standard (“1722 standard”). In general, the 1722 standard includes a link layer protocol that has been established for transporting media and control data over Ethernet-based time-sensitive networks. As such, the communication protocol of the present disclosure leverages the advantages of building on an already established communication protocol that is configured for high-speed data communication in time-sensitive applications. Further, the modification to the 1722 standard described in the present disclosure may help improve the 1722 standard by reducing an amount of processing and/or memory resources that may be used for the image data communication as compared to using the 1722 standard as currently established. In these or other embodiments, the 1722 standard may include, for example, existing IEEE 1722b, 1722c standards, and other IEEE standards corresponding to transmitting data over Ethernet.

In particular, the modification of the 1722 standard includes adding header fields and corresponding header data to the Ethernet packet header corresponding to the 1722 standard (“1722 header”). The new header fields may include fields and corresponding data that allow for a reduction in the processing that is traditionally done using a processing unit (e.g., by software running on a CPU).

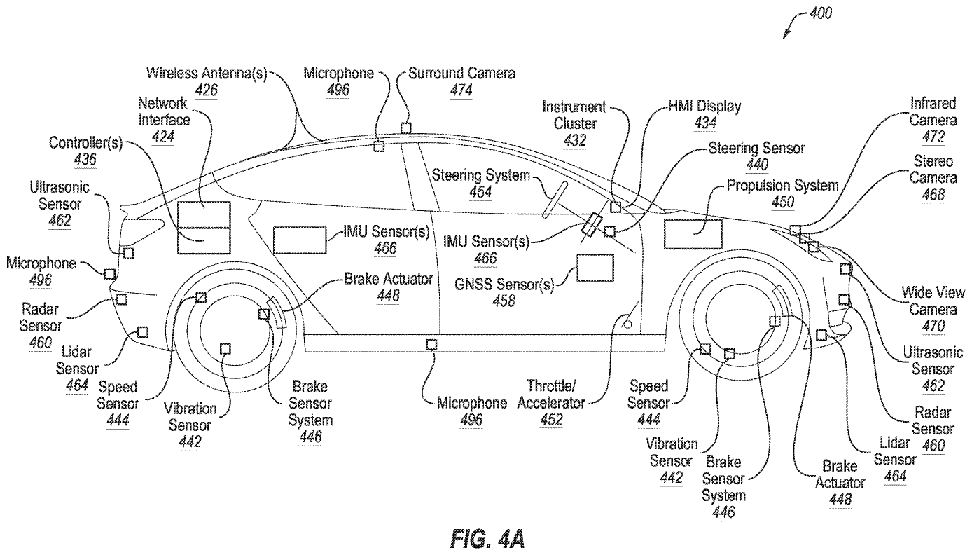

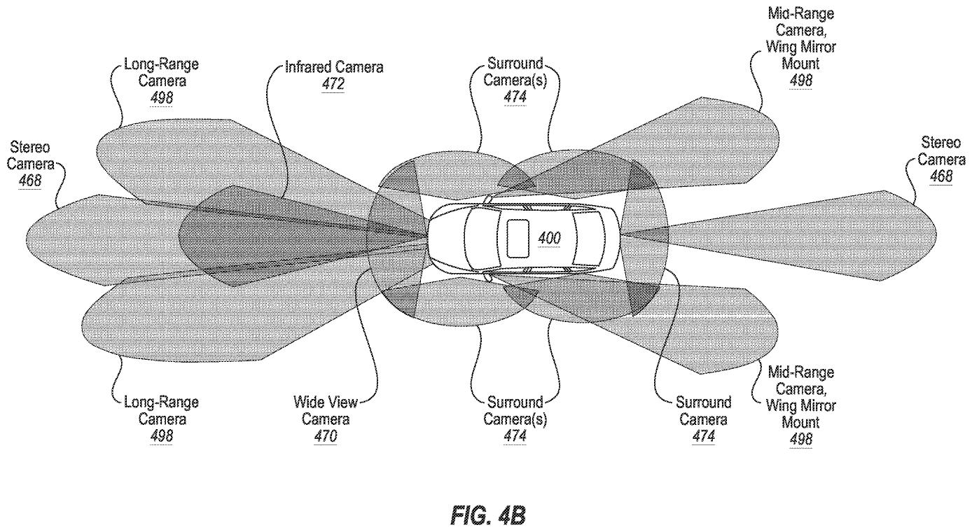

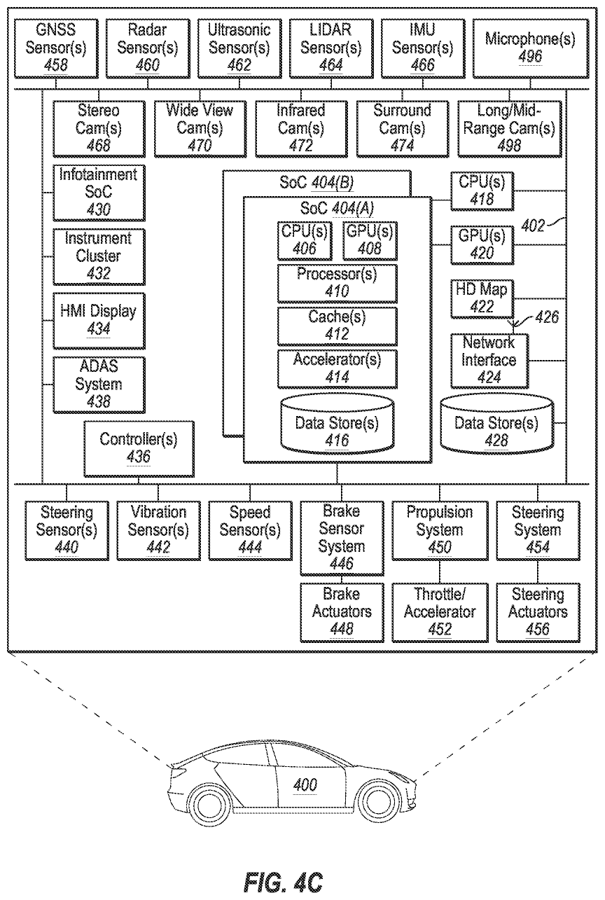

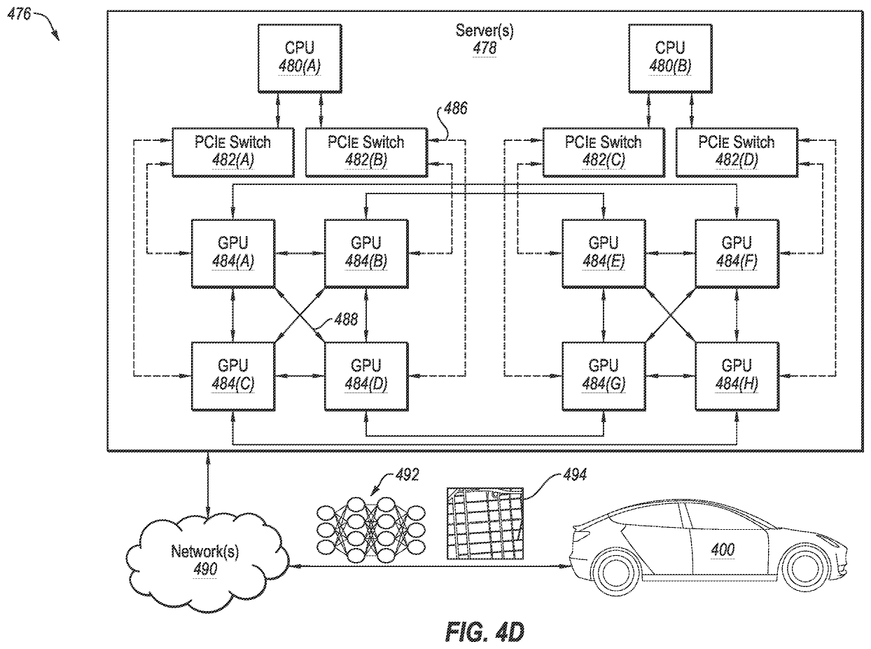

One or more of the embodiments disclosed herein may relate to data transfer via Ethernet protocols that may be performed using one or more ego-machines, which may include any applicable machine or system that is capable of performing one or more autonomous and/or semi-autonomous operations. Example ego-machines may include, but are not limited to, vehicles (land, sea, space, and/or air), robots, robotic platforms, etc. By way of example, the ego-machine computing applications may include one or more applications that may be executed by an autonomous vehicle or semi-autonomous vehicle, such as an example autonomous or semi-autonomous vehicle or machine 400 (alternatively referred to herein as “vehicle 400” or “ego-machine 400”) described with respect to FIGS. 4A-4D. In the present disclosure, reference to an “autonomous vehicle” or “semi-autonomous vehicle” may include any vehicle that may be configured to perform one or more autonomous or semi-autonomous navigation or driving operations. As such, such vehicles may also include vehicles in which an operator is required or in which an operator may perform such operations as well.

The systems and methods described herein may be used by, without limitation, non-autonomous vehicles or machines, semi-autonomous vehicles or machines (e.g., in one or more adaptive driver assistance systems (ADAS)), autonomous vehicles or machines, piloted and un-piloted robots or robotic platforms, warehouse vehicles, off-road vehicles, vehicles coupled to one or more trailers, flying vessels, boats, shuttles, emergency response vehicles, motorcycles, electric or motorized bicycles, aircraft, construction vehicles, underwater craft, drones, and/or other vehicle types. Further, the systems and methods described herein may be used for a variety of purposes, by way of example and without limitation, for machine control, machine locomotion, machine driving, synthetic data generation, model training, perception, augmented reality, virtual reality, mixed reality, robotics, security and surveillance, simulation and digital twinning, autonomous or semi-autonomous machine applications, deep learning, environment simulation, object or actor simulation and/or digital twinning, data center processing, conversational AI, light transport simulation (e.g., ray-tracing, path tracing, etc.), collaborative content creation for 3D assets, cloud computing and/or any other suitable applications.

Disclosed embodiments may be comprised in a variety of different systems such as automotive systems (e.g., a control system for an autonomous or semi-autonomous machine, a perception system for an autonomous or semi-autonomous machine), systems implemented using a robot, aerial systems, medial systems, boating systems, smart area monitoring systems, systems for performing deep learning operations, systems for performing simulation operations, systems for performing digital twin operations, systems implemented using an edge device, systems incorporating one or more virtual machines (VMs), systems for performing synthetic data generation operations, systems implemented at least partially in a data center, systems for performing conversational AI operations, systems that implement one or more language models, such as one or more large language models (LLMs) that process textual, audio, image, sensor, and/or other data types to generate one or more outputs, systems for hosting real-time streaming applications, systems for presenting one or more of virtual reality content, augmented reality content, or mixed reality content, systems for performing light transport simulation, systems for performing collaborative content creation for 3D assets, systems implemented at least partially using cloud computing resources, and/or other types of systems.

These and other embodiments of the present disclosure will be explained with reference to the accompanying figures. It is to be understood that the figures are diagrammatic and schematic representations of such example embodiments, and are not limiting, nor are they necessarily drawn to scale. In the figures, features with like numbers indicate like structure and function unless described otherwise.

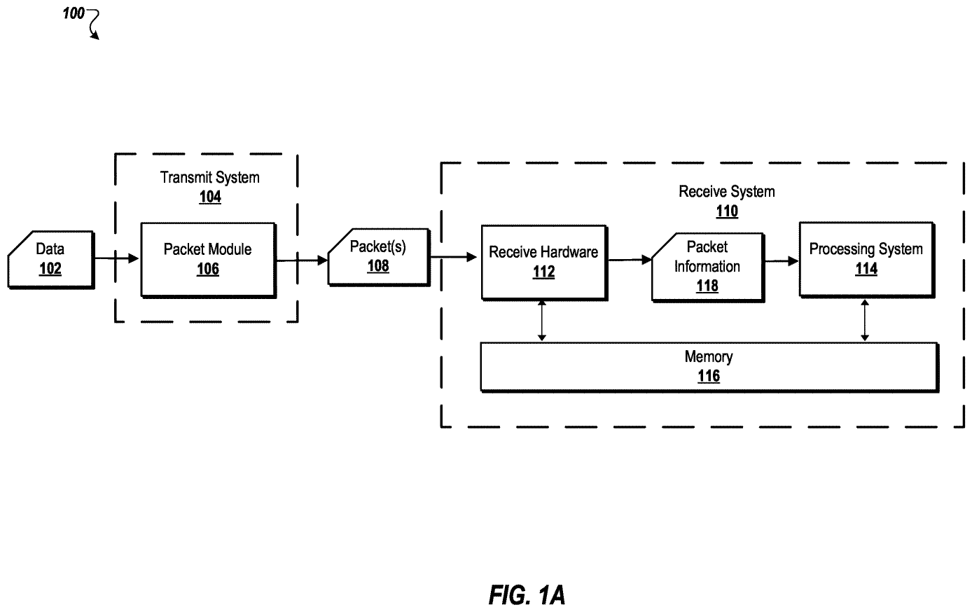

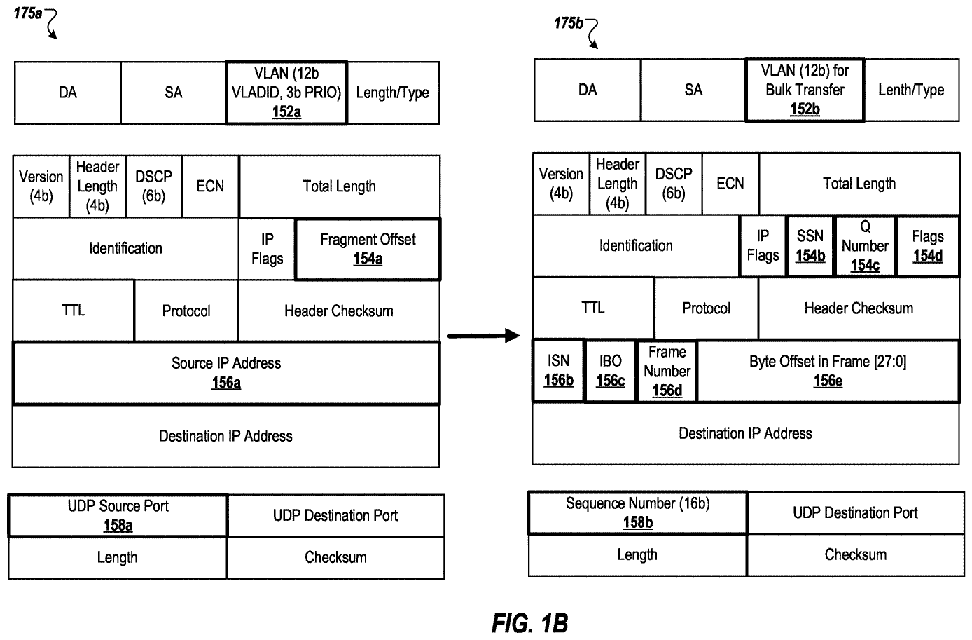

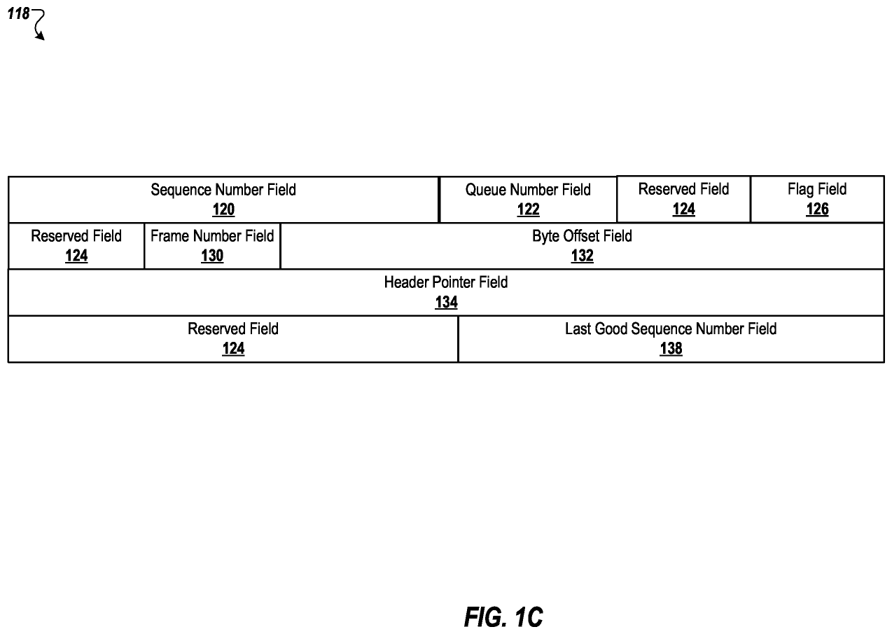

Now referring to FIG. 1A, FIG. 1A is a diagram representing an example environment 100 related to transmitting and receiving data 102, in accordance with one or more embodiments of the present disclosure. In some embodiments, the data 102 may be packaged and transmitted using a transmit system 104 and received and/or stored using a receive system 110.

The data 102 may include one or more bits and/or bytes of data. In some embodiments, the data 102 may include any data and/or information that may be communicated between systems, subsystems, components within a system, etc. In some embodiments, the data 102 may include data communicated between two locations (e.g., from one portion, component, feature, etc. of an autonomous vehicle to another using one or more cables). In particular, the data 102 may include any data that may be transferred and/or communicated between ECUs.

In some embodiments, the data 102 may include data that may be generated using one or more sensors. In some embodiments, the data 102 may include data and/or information corresponding to an environment in which the one or more sensors (e.g., temperature sensors, image sensors, speed sensors, accelerometers, RADAR sensors, LiDAR sensors, proximity sensors, pressure sensors, etc.) may be located. For example, a camera may generate image data corresponding to a portion of a particular environment at a particular time, where the image data may be included in the data 102.

In some embodiments, the data 102 may include data that may have been previously collected. For example, the data 102 may include publicly available temperature data corresponding to a particular environment. Like the data 102 that may have been collected and/or generated in real time or near real-time, the publicly available temperature data may similarly be packaged, processed, used, transmitted, etc. using one or more systems (e.g., the transmit system 104 and/or the receive system 110).

Additionally or alternatively, the data 102 may include data that may not have been generated using one or more sensors. For example, the data 102 may include map data corresponding to a map, and/or any other type of data generated, obtained, received, or otherwise used by the system performing the data communication. Continuing the example, one or more systems may be configured to retrieve and/or otherwise obtain the map data from one or more other systems, servers, web locations, etc.

In some embodiments, the data 102 may be divided and/or organized into one or more data frames. A data frame, as used in the present disclosure, may refer to a grouping or set of the data 102. In some embodiments, the data 102 may all be included in one data frame. Additionally or alternatively, the data 102 may be subdivided and included in more than one data frame. In some embodiments, the data frame may include a particular amount of the data 102. For example, the data 102 may include one hundred (100) kilobytes of data. Continuing the example, the data 102 may be subdivided into one-hundred data frames, each including 1 kilobyte of the data 102.

In some embodiments, a data frame may include data 102 corresponding to one or more sensors. Additionally or alternatively, the data frame may include data 102 corresponding to one particular sensor. For example, the data 102 may include data corresponding to both a LiDAR sensor and a pressure sensor at a particular time.

In some embodiments, the data frame may include data 102 generated using one particular sensor at one particular time stamp. For example, in the context of the camera or other image sensor, the camera may generate image data (e.g., the data 102) corresponding to a particular environment at time t₀ to time t₂. Further, the data 102 may be subdivided into three (3) data frames, a first data frame including the data 102 generated using the camera at time to, a second data frame including the data 102 generated using the camera at time t₁, and a third data frame including the data 102 generated using the camera at time t₂.

In some embodiments, the data 102 may be generated, extracted, retrieved, and/or otherwise obtained using one or more systems—e.g., a transmit system 104. The transmit system 104 may include one or more systems, modules, control units, etc. that may be configured to perform one or more operations on the data 102. In some embodiments, the transmit system 104 may include one or more electronic control units (“ECUs”) corresponding to a larger system. For example, the transmit system 104 may include an ECU corresponding to an autonomous vehicle or semi-autonomous vehicle, where the ECU may include one or more computing systems, embedded systems, devices, controllers, microcontrollers, etc. that may be configured to receive and/or perform one or more operations based on the data 102.

In some embodiments, the transmit system 104 may include one or more hardware components and/or software components that may be configured to perform one or more operations on the data 102. In some embodiments, the transmit system 104 may include one or more hardware units, the hardware units including, for example, counters, arithmetic logic units (ALUs), adders, logic circuits, etc. Additionally or alternatively, the transmit system 104 may include one or more modules, such as, for example, the packet module 106 that may be configured to work in conjunction with the hardware units to organize the data 102 for transmission by dividing, packaging, and/or organizing the data 102.

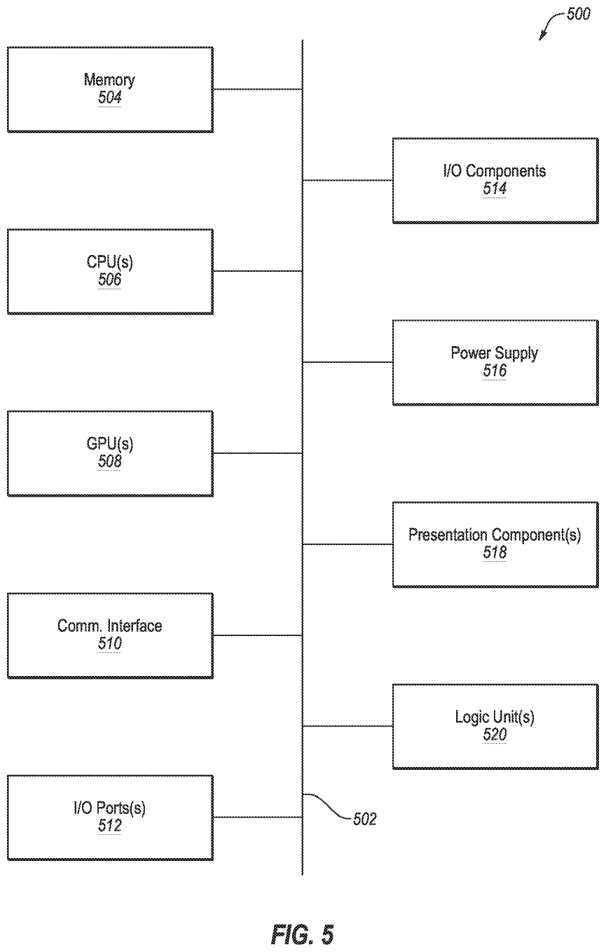

In some embodiments, the packet module 106 may include code and routines configured to allow a computing system to perform one or more operations. Additionally or alternatively, the packet module 106 may be implemented using hardware including one or more processors, CPUs graphics processing units (GPUs), data processing units (DPUs), parallel processing units (PPUs), microprocessors (e.g., to perform or control performance of one or more operations), field-programmable gate arrays (FPGA), application-specific integrated circuits (ASICs), accelerators (e.g., deep learning accelerators (DLAs)), and/or other processor types. In these and other embodiments, the packet module 106 may be implemented using a combination of hardware and software. In the present disclosure, operations described as being performed by the packet module 106 may include operations that the packet module 106 may direct a corresponding computing system to perform. In these or other embodiments, the packet module 106 may be implemented by one or more computing devices, such as that described in further detail with respect to FIGS. 4A-4D, 5, and/or 6.

In some embodiments, the packet module 106 may be configured to assign a data frame to a particular queue of data frames. A queue, as used in the present disclosure, may refer to a data structure that may be used to organize data frames and corresponding segments and packets 108 to facilitate efficient data transfer. For example, a particular queue may be used to organize transmission of four (4) data frames. Continuing the example, the byte offsets associated with the four (4) data frames may each be included in the queue such that packets 108 transporting respective segments corresponding to the four (4) data frames may include and communicate the correct byte offsets associated with respective segments to one or more other systems (e.g., the receive system 110).

In some embodiments, the packet module 106 may be configured to subdivide and/or organize the data 102 into one or more sets or groupings. In particular, the one or more data frames may be subdivided into one or more segments. In some embodiments, the one or more segments may include one or more corresponding portions of the data 102. In some embodiments, a segment may include all of the data 102 associated with the one or more data frames. Additionally or alternatively, the segment may include a subset of data 102 included in an individual data frame. For example, a data frame may include one (1) megabyte of data, the data 102 included in the data frame may be subdivided into one thousand (1000) segments where each of the segments include one (1) kilobyte of data. In some embodiments, the size of the segments (e.g., the amount of data included in the segments) may be determined based on a size of one or more payloads that may be carried by respective packets—e.g., packets 108. For example, an Ethernet protocol may define a particular payload size of 64 bytes corresponding to a particular packet. Continuing the example, in response to the defined payload size of 64 bytes, the data 102 may be subdivided into one or more segments, in which the segments include 64 bytes or less of data 102.

In some embodiments, each of the segments that may correspond to a particular data frame may be assigned a sequence number. For example, each of the segments may be given a sequence number based on a sequence. In some embodiments, the sequence number may be an integer, beginning at zero (0), and incrementally moving upward in increments of one (1). Additionally or alternatively, the sequence numbering may include one or more other sequences that may begin using one or more other values and incrementally moving upward using one or more other increments—e.g., 2, 3, 4, etc.

In some embodiments, sequence numbers corresponding to segments in particular data frames may be initialized using the packet module 106 and/or one or more other processing units and/or software corresponding to the packet module 106. For example, a first sequence number may be assigned to a first segment using the packet module 106. In some embodiments, remaining segments corresponding to particular data frames may be assigned corresponding sequence numbers using one or more hardware elements (e.g., hardware elements associated with the transmit system 104) based on the first sequence number.

In some embodiments, the sequence numbers may additionally be stored in one or more registers, where registers may include data storage structures configured to store data 102 that may be readily accessible. For example, one or more processing units (e.g., the packet module 106) and/or hardware units (e.g., one or more portions of the transmit system 104) may write sequence numbers corresponding to segments in a data frame in the one or more registers. The one or more registers may be used to keep track of the sequence numbers and segments corresponding to the sequence numbers during communication of the segments. Further, the one or more registers may be configured to include data and/or information linking the segments with respective sequence numbers. By storing the sequence numbers, the segments, and the data and/or information linking the segments with respective sequence numbers in the one or more registers, the packets 108 corresponding to the sequence numbers may be identified by the packet module 106. In some embodiments, in response to one or more packets 108 being lost or otherwise corrupted in transmission, the lost or corrupted packets 108 may be re-sent.

For example, a data frame may include ten (10) segments. Continuing the example, the packet module 106 may assign the first segment a first sequence number of zero (0). Upon assigning the first segment, the remaining segments may be assigned subsequent sequence numbers using one or more hardware elements by incrementing sequence numbers by one (1) such that subsequent segments are assigned sequence numbers 1, 2, 3, 4, and so on. In some embodiments, using hardware units in this manner may decrease an overall amount of processing power for designating segment storage locations in memory.

In some embodiments, the packet module 106 may be configured to generate individual packets 108. In some embodiments, the packet module 106 may be configured to transfer and/or otherwise communicate the one or more segments corresponding to the data 102 using the packets 108.

In some embodiments, a packet 108 may refer to a particular data package, structure, format, etc. that may be used to transport segments corresponding to the data 102. In some embodiments, an individual packet 108 may include one or more fields that may be defined by one or more protocols for transporting data. In particular, the packets 108 may be organized as one or more Ethernet packets. Accordingly, the packets 108 may be organized and defined in accordance with one or more Ethernet protocols associated with Ethernet packets.

In some embodiments, the one or more fields corresponding to the packets 108 may refer to specific portions or sections of the packet 108 that carry particular information. In some embodiments, the one or more fields associated with the particular packet 108 may include a payload field and/or one or more header fields.

In some embodiments, the payload field may be populated with data 102 that may be carried using a particular packet 108. In some embodiments, the payload field may carry portions of the data 102 being transmitted; for example, from the transmit system 104 to the receive system 110. More specifically, the payload field may be populated with a subset of the data 102—e.g., the payload may be populated with a segment corresponding to the data 102. In these or other embodiments, payloads corresponding to respective packets 108 may be populated with respective segments corresponding to the data 102. As used in the present disclosure, “payload” may refer to a payload field corresponding to a particular packet 108. Additionally or alternatively, “payload” may refer to the data 102 that may be included in the payload field corresponding to the particular packet 108.

For example, the data 102 may be organized into a data frame that may be subdivided into a first segment and a second segment. Continuing the example, a first payload corresponding to a first packet 108 may include the first segment and a second payload corresponding to a second packet 108 may include the second segment. The first segment and the second segment may accordingly be carried as the respective payloads of the first packet 108 and the second packet 108.

In some embodiments, the one or more header fields (also referred to herein as “header”) may include one or more data fields included in respective packets 108 that may include information associated with the transmission and storage of the respective packets 108 (e.g., source address of a sender, destination address corresponding to an intended recipient of the payload, etc.). Additionally or alternatively, the header may include information describing the payload. For example, the header may include a data type of the data 102 included in the payload, length of the payload, length of the header, one or more checksums corresponding to the header and/or the payload, etc. Further, the header may include information indicating one or more storage locations corresponding to data 102 included in the payload.

An example implementation of a header may be described with respect to FIG. 1B, FIG. 1B illustrates an example diagram representing a modified header 175b modified from a traditional header 175a, in accordance with one or more embodiments of the present disclosure. As illustrated in FIG. 1B, the numbered and bolded portions of the traditional header 175a may be modified to include the bolded portions of the modified header 175b to include data and/or information that may be transmitted and/or received using the one or more packets 108. In some embodiments, the traditional header 175a may include one or more fields that may include what may be traditionally labelled as an Ethernet header, an Internet Protocol (IP) header, and/or a user datagram protocol (UDP) header. Further, the modified header 175b may include one or more fields that may have been modified and/or changed from the traditional header 175a to include fields in an Ethernet header, an IP header, and/or a UDP header.

As illustrated in FIG. 1B, a VLAN ID field 152a included in the traditional header 175a may be changed such that the modified header 175b may instead include a VLAN for bulk transfer field 154b. Additionally or alternatively, a fragment offset field 154a included in the traditional header 175a may be changed such that the modified header 175b may instead include an SSN field 154b, a queue number field 154c, and/or a flag field 154d. Additionally or alternatively, a source IP address 156a included in the traditional header 175a may be changed such that the modified header 175b may instead include an ISN field 156b, an IBO field 156c, a frame number field 156d, and/or a byte offset field 156e. Additionally or alternatively, a UDP source port 158a included in the traditional header 175a may be changed such that the modified header 175b may instead include a sequence number field 158b.

The VLAN ID field 152a may include bits and/or bytes of data that may indicate a virtual local area network (VLAN) to which the packet 108 corresponding to the VLAN ID field 152a may belong. In some embodiments, the VLAN ID 152a may be the same for packet 108 included in a particular data frame. For example, a particular data frame may include three (3) different segments that may correspond to three (3) different payloads corresponding to three (3) respective packets 108. Continuing the example, the VLAN ID field 152a corresponding to each of the three (3) data packets 108 may include the same VLAN ID or VLAN tag.

In some embodiments, the traditional header 175a may be changed and/or modified to include a VLAD ID for bulk data transfer field 152b rather than the VLAN ID field 152a. In some embodiments, the VLAN ID for bulk data transfer field 152b may include data that may indicate a different VLAN to which the packet 108 may belong. In some embodiments, the VLAN configuration and network settings may be changed and otherwise modified in preparation for bulk data transfer. For example, the VLAN configuration may be changed to prioritize bulk data transfer over other less time-sensitive traffic. The prioritization may be indicated, for example, using a priority (“PRIO”) field. For example, an encoding of “0” corresponding to the PRIO field may indicate lowest priority or best effort, and an encoding of “111” corresponding to the PRIO field may indicate highest priority. In some embodiments, one or more bandwidth allocation settings and traffic shaping settings may be modified to allocate sufficient resources based on an amount of data being transferred. In some embodiments, in response to the VLAN being modified to allocate sufficient resources and bandwidth for bulk data transfer, the VLAN ID for bulk data transfer field 152b may include a VLAN ID that may be different from the VLAN ID included in the VLAN ID field 152a.

The fragment offset field 154a that may be included in the traditional header 175a (e.g., as part of an IP header corresponding to a particular packet 108) may indicate a fragment or portion of the data included in the packet 108. In some embodiments, the fragment offset field 154a may be modified, changed, or otherwise manipulated to include one or more other fields in the modified header 175b (e.g., the start value for the sequence number (“SSN”) field 154b, the queue number field 154c, and/or the flags field 154d).

The SSN field 154b may include data and/or information that may indicate to one or more processing units and/or systems that a local sequence number register may be initialized with the value provided in 158b. For example, the SSN field 154b may be populated with a zero “0” or a one “1.” Continuing the example, a “1” may indicate that one or more hardware components may use the sequence number included in the header, e.g., the sequence number corresponding to the sequence number field 158b. By comparison, a “0” populated in the SSN field 154b may indicate to the one or more hardware components that the sequence number may be incremented from one or more sequence numbers corresponding to one or more previous packets 108, for example, using one or more counters.

In some embodiments, the modified header 175b may additionally include a queue number field 154c that may indicate a particular queue to which data 102 included in a particular packet 108 may correspond. In some embodiments, data 102 may be transmitted using a number of different queues; for example, four (4) different queues. In some embodiments, the segment included in a payload of a particular packet 108 may also be associated with a particular data frame. For example, each of the segments corresponding to a particular data frame may include the same queue number included in each of their respective queue number fields 154c.

The flag field 154d may include data and/or information that may provide information corresponding to the data 102 included in a particular packet 108. In some embodiments, the values included in the flag field 154d may indicate that the segment included in the payload may be the first segment corresponding to a data frame. In some embodiments, the flag field 154d may include one or more values that may indicate that a second segment included in a second payload of a second packet 108 may be a final segment corresponding to the data frame. In some embodiments, the flag field 154d may include one or more values that may indicate that the particular packet 108 may include data 102 corresponding to a segment that may not be the first segment, or the final segment included in the data frame.

In some embodiments, the flag field 154d may include one or more values that may indicate that one or more errors may have occurred corresponding to the segment included in the payload of the respective packet 108. For example, one or more errors may have occurred in the collection or transfer of the segment included in a respective payload of a respective packet 108 which may be indicated in the flag field 154d.

In some embodiments, the flag field 154d may indicate that the packet 108 may have been sent successfully. Additionally or alternatively, the flag field 154d may indicate that a packet 108 may have been lost. Further, the flag field 154d may include information indicating that more than one packet 108 may have been lost or that more than one packet 108 was not transmitted corresponding to a particular data frame.

In some embodiments, the flag field 154d may indicate that a particular packet 108 should be sent and/or transmitted to one or more processing units (e.g., one or more CPUs). The one or more processing units may be configured to determine one or more operations to perform based on the information included in the flag field 154d. For example, the flag field 154d may include information indicating one or more errors may have occurred—e.g., that the one or more packets 108 corresponding to a particular data frame may not have been transmitted or may have been lost. In response to the information included in the flag field 154d, one or more processing units may be configured to request retransmission of the missing packet 108 and/or requesting retransmission of data 102 corresponding to a data frame.

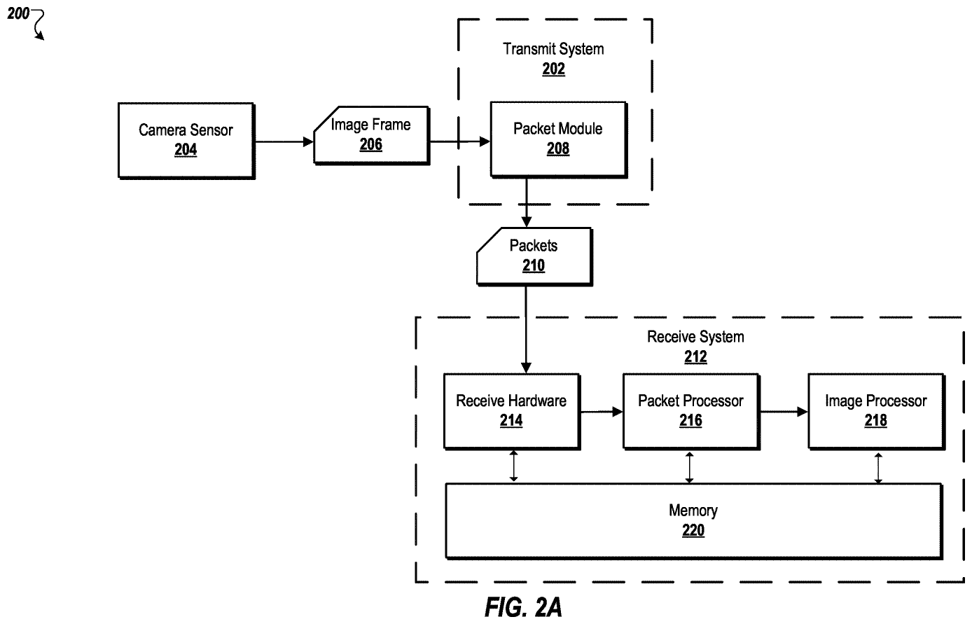

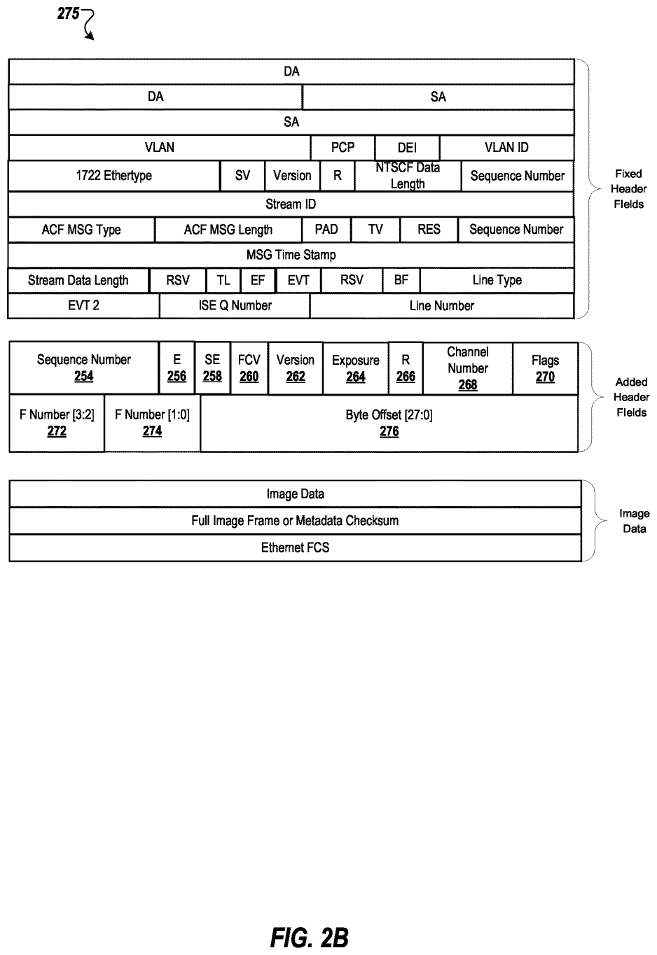

In some embodiments, in response to missing packet 108 corresponding to real-time or near real-time sensor data, the one or more processing units may be configured to delete or otherwise remove data 102 corresponding to data frame(s) corresponding to the missing packets 108. Additionally or alternatively, information indicating additional information corresponding to sensor data 102 (e.g., image data) may be included in the flag field 154d as described further in the present disclosure, such as, for example, with respect to FIG. 2B.

An example of possible data included in the flag field 154d of corresponding packets 108 may be illustrated and/or explained further with respect to Table 1:

TABLE 1

| Flags [7:0] | Description |
|---|---|
| [2:0] | 000: Middle |
| | 001: Frame Start (SOF) |
| | 010: Frame End (EOF) |
| | 011: Reserved |
| | 100: Reserved |
| | 101: Reserved |
| | 110: Reserved |
| | 111: Reserved |
| [3] | When 1, Notify Processing System |
| [4] | Reset Discontinuity State |
| [7:5] | Data Type |
| | 100: Reserved |
| | 101: Data Type 1 |
| | 110: Data Type 2 |
| | 111: Reserved |
| | 000: Reserved |
| | 001: Error |
| | 010: Reserved |
| | 011: Reserved |

Table 1 illustrates an example of the flag field 154d that may include 8-bits indicated using indicator [7:0] indicating a range of bits within a bit field. Using this notation, the numbers before and after the colon (:) represent the most significant bit and the least significant bit of the field, respectively.

The first three bits, represented in the second row of Table 1 as [2:0], are used to convey information corresponding to the payload included in the packet 108. For example, in instances where the first three bits include “000” the segment carried by the packet 108 may include data 102 corresponding to the middle of the data frame. Continuing the example, “001” may indicate that the segment carried by the packet 108 may include the data 102 corresponding to the start of the data frame, and “010” may indicate that the segment may include data 102 that may correspond to the end of the data frame. Further, as illustrated in Table 1, remaining bit combinations corresponding to the first three bits in the flag field 154d (“011”, “100”, “101”, “110”, and “111”) may be reserved to indicate information in subsequent iterations or versions of the flag field 154d corresponding to respective packets 108.

The fourth bit, represented in the third row of Table 1 as [3], is used to convey whether the data packet 108 may need to be processed using one or more processing systems. For example, processing system 114 described and/or illustrated further in the present disclosure, such as, for example, with respect to FIG. 1A. Instances in which the fourth bit may include a “1,” may indicate that the packet 108 may be sent and/or processed using one or more processing systems. By contrast, instances in which the fourth bit may include a “0,” may indicate that the packet 108 and/or corresponding data 102 that may be carried by the packet 108 may not be sent and/or processed using one or more processing systems.

The fifth bit, represented in the fourth row of Table 1 as [4], may be used to convey information corresponding to resetting a discontinuity state associated with a particular data frame. For example, a positive discontinuity state may indicate that more than one data packet 108 carrying segments of the data 102 corresponding to a particular data frame may have been lost in transmission. Continuing the example, a processing system, in response to a positive discontinuity state, may request retransmission of an entire data frame corresponding to the more than one data packet 108 that may have been lost. In some embodiments, upon retransmission of packets 108 corresponding to the data frame, the fifth bit may include a “1” to indicate a reset of the excessive discontinuity state associated with a particular data frame.

The last three bits, represented in the fourth row of Table 1, may indicate a particular data type associated with the data 102 populated in the payload field corresponding to a particular packet 108. In some embodiments, the data type may refer to different kinds of data, such as, for example, integers, chars, floats, strings, etc. Additionally or alternatively, the data type may refer to one or more other distinctions between data. For example, the data type may indicate the data populated in the payload field corresponding to the packet 108 may include data corresponding to a particular sensor; for example, image data corresponding to a particular camera, temperature data corresponding to a temperature sensor, data corresponding to a particular accelerometer, etc. In some embodiments, the data type may indicate that the data may include ECU-to-ECU data, map data, etc. Table 1 illustrates a number of bit combinations that may be reserved to indicate information in subsequent iterations or versions of the flag field 154d corresponding to respective packets 108.

Referring again to FIG. 1B, the source Internet Protocol (IP) address field 156a in the traditional header 175a may include a source IP address associated with the packet 108. In some embodiments, the IP address field 156a may be modified, changed, replaced, or otherwise manipulated to include the ISN frame 156b, the IBO frame 156c, the frame number field 156d, and/or the byte offset in frame field 156e.

The ISN field 156b may include an indicator that may signal or otherwise indicate to one or more hardware components to determine and input a sequence number corresponding to the segment included in the payload of the particular packet 108. For example, the data included in the ISN field 156b may indicate to a hardware component to insert a sequence number corresponding to the particular packet 108. In response to the indication using the data included in the ISN field 156b, one or more hardware components may insert a sequence number based on a sequence and one or more sequence numbers corresponding to one or more other packets 108 including other data 102 associated with the same data frame.

The insert byte offset (IBO) field 156c may include an indicator that may signal to one or more hardware components to provide and/or insert a byte offset corresponding to the packet 108 in the byte offset in frame field 156e. In some embodiments, one or more processing units may determine whether to insert a current byte offset or not. In response to the determination made by the one or more processing units, the IBO field 156c may reflect that determination with a corresponding indicator (e.g., a “0” not to insert a byte offset or a “1” to insert a byte offset).

The frame number field 156d may include one or more values that may indicate a particular data frame corresponding to the segment included in the payload. In some embodiments, the frame number field 156d may indicate a particular buffer in which data 102 corresponding to a particular data frame may be stored. In some embodiments, data and/or information corresponding to the frame number field 156d may be used to select one or more base addresses that may be selected and to which a byte offset may be added to determine an address at which a particular segment corresponding to a particular payload may be stored. In these or other embodiments, the queue number included in the queue number field 122 in conjunction with the frame number included in the frame number field 156d may both be used to determine, for example, a base address corresponding to the segment included in the packet 108.

For example, four (4) data frames may be included in a particular queue. The four (4) data frames may be indicated using a 2-bit indicator in the frame number field 128—e.g., 00, 01, 10, and 11. Continuing the example, the 2-bit indicators may correspond to each of the four (4) frames corresponding to the queue, e.g., a first frame indicated using indicator “00,” a second frame indicated using indicator “01,” a third frame indicated using indicator “10,” and a fourth frame indicated using indicator “11.” Further, the base addresses corresponding to each of the four (4) data frames may be selected and/or determined based on the frame number that may be indicated using data and/or information included in the frame number field 156d.

The byte offset field 156e may include a byte offset corresponding to the segment included in the payload of the packet 108. In some embodiments, the byte offset may indicate a designated storage location associated with the segment in the form of a number of bytes away from the beginning of the data frame to which the segment corresponds. In some embodiments, the byte offset may indicate how many bytes away the respective segment is to be stored from a base memory location associated with a data frame—for example, the data frame indicated using the information corresponding to the frame number field 156d. The base memory location may include a base address for storage of the set of data 102 corresponding to a data frame. As such, in some embodiments, the byte offset may indicate an offset away from the base address at which the respective segment is to be stored. For example, a particular memory address for a particular segment may be the base address with the corresponding byte offset added thereto.

In some embodiments, a respective byte offset corresponding to the byte offset field 156e may be based on an amount of data 102 used to store one or more segments in packets 108 corresponding to sequence numbers prior to the sequence number corresponding to the respective byte offset. For example, the packets 108 may include a first packet 108, a second packet 108, and a third packet 108, where each of the packets 108 includes a respective payload including 500 bytes of data. The first packet 108 may include a first sequence number of zero (0), the second packet 108 may correspond to a second sequence number of one (1), and the third packet 108 may correspond to a third sequence number of (2). Continuing the example, each of the first packet 108, the second packet 108, and the third packet 108 may additionally correspond to respective byte offsets that may correspond to the number of bytes in the respective payloads. The first packet 108 corresponds to a first byte offset of zero (0), the second packet 108 corresponds to a second byte offset five hundred (500), and the third packet 108 corresponds to a third byte offset of one thousand (1,000). In these or other embodiments, the byte offset field 156e may include data and/or information that may be used and/or otherwise communicated to a processing system as described and/or illustrated further in the present disclosure, such as, for example, with respect to FIG. 1C.

In some embodiments, the user datagram protocol (UDP) source port field 158a that may be included in the UDP header portion of the traditional header 175a may include information corresponding to the port number of the transmitting application, system, module, etc. In some embodiments, the UDP source port field 158a may be changed, replaced, modified, and/or otherwise manipulated to instead include the sequence number field 158b.

The sequence number field 158b may include a sequence number corresponding to the segment included in the payload of the packet 108. In some embodiments, the sequence number field 158b may include a 16b sequence number that may be assigned, determined, and/or inserted using one or more hardware components in response to the indicator associated with the ISN field 156b. In some embodiments, the sequence number may be input using one or more hardware components based on prior sequence numbers corresponding to segments associated with the same data frame

Modifications, additions, or omissions may be made to FIG. 1B without departing from the scope of the present disclosure. For example, the amount of data included in the one or more fields corresponding to the traditional header 175a and/or the modified Ethernet header 175b may vary. Additionally or alternatively, the traditional header 175a and/or the modified Ethernet header 175b may include one or more other header fields than those illustrated and discussed herein. The specifics given and discussed are to help provide explanation and understanding of concepts of the present disclosure and are not meant to be limiting.

Returning to the description of FIG. 1A, the one or more packets 108, the respective headers, and respective payloads may be communicated to the receive system 110. In some embodiments, the receive system 110 may include one or more systems, modules, control units, etc. that may be configured to perform one or more operations using data 102 included in the packets 108. In some embodiments, the receive system 110 may include one or more electronic control units (“ECUs”) corresponding to a larger system. For example, the receive system 110 may include an ECU corresponding to an autonomous vehicle or semi-autonomous vehicle, where the ECU may include one or more computing systems, embedded systems, devices, controllers, microcontrollers, etc. that may be configured to receive the packets 108, store data 102 included in the payloads corresponding to respective packets 108 in memory 116, and/or perform one or more other operations using data 102 included in the packets 108.

In some embodiments, the receive system 110 may include one or more modules and/or systems that may be configured to perform one or more operations using data 102 included in the packets 108. In some embodiments, the receive system 110 may include receive hardware 112 and/or a processing system 114 that may be configured to extract data 102 corresponding to respective payloads of respective packets 108 and/or store the extracted data 102 in memory 116 corresponding to the receive system 110.

The memory 116 may include one or more components corresponding to the receive system 110 configured to store data 102 corresponding to the packets 108. In some embodiments, the memory 116 may include one or more forms of volatile or non-volatile memory such as, for example, Random Access Memory (RAM), Dynamic Random access memory (DRAM), flash memory, cache memory, buffer memory, secondary storage, and/or other forms of memory that may be configured to store data 102 corresponding to the packets 108. In some embodiments, the memory 116 may be included in the receive system 110. Additionally or alternatively, the memory 116 may be included in one or more other systems, devices, etc. that may be associated with the receive system 110.

The receive hardware 112 may include one or more hardware units that may perform one or more operations using data 102 corresponding to the packets 108 without using one or more processing units, e.g., one or more CPUs. The receive hardware 112 may include one or more counters, comparators, arithmetic logic units (ALUs), adders, logic circuits, and/or other hardware units configured to perform one or more operations without using processing units and/or using a decreased amount of processing power and/or resources as compared to one or more other Ethernet protocols where one or more processing units designate storage locations in memory 116 for the packets 108.

In some embodiments, the receive hardware 112 may be configured to direct the storage of the segments to their corresponding storage locations in the memory 116. For example, the receive hardware 112 of the receive system 110 may be configured to read the byte offsets included in the byte offset fields of respective packets 108. Based on the byte offset and the base memory address, the receive hardware 112 may be configured to direct the storage of the segments of the corresponding packets 108 to corresponding memory locations. For example, the receive hardware 112 may add the base memory address to a particular byte offset included in a particular packet 108 to determine a particular memory address of a particular segment included in the payload of the particular packet 108. In these and other embodiments, the receive hardware 112 may direct that the particular segment be stored at the particular memory address in the memory 116.

In some embodiments, the receive hardware 112 may be configured to determine whether the order of the sequence numbers follows an expected sequence—e.g., the receive hardware 112 may be configured to determine whether the sequence numbers incrementally increase by one as the packets 108 corresponding to data 102 corresponding to a particular data frame are received. In these and other embodiments, the receive hardware 112 may be configured to report to the processing system 114 instances in which received sequence numbers do not follow the sequence, which may indicate that a particular packet 108 carrying a particular segment was lost during transmission.

For example, the receive hardware 112 may include at least a counter and a comparator. The counter may be configured to increment a value included in a local register that may be used to store one or more sequence numbers corresponding to one or more received packets 108. In some embodiments, a sequence number corresponding to a packet 108 successfully received prior to a current sequence number corresponding to the most recently received packet 108 may be referred to herein as a last good sequence number. In some embodiments, the comparator may be configured to compare the last good sequence number plus 1 (+1) with a current sequence number. The comparison may indicate packet loss should the sequence numbers mismatch. For example, in the context of a first packet 108 corresponding to a first sequence number “0,” a second packet 108 corresponding to a second sequence number “1,” and a third packet 108 corresponding to a third sequence number “2.” Continuing the example, the last good sequence number may be zero and the current sequence number may be 2 indicating that the first packet and the third packet may have been received. Further, the counter may be configured to increment the last good sequence number in the local register by 1 and the comparator may be configured to compare the current sequence number and the last good sequence number+1. In this example, the last good sequence number+1 is equal to 1 and the current sequence number is 2, 2≠1. The comparison, therefore, may indicate that the second packet was lost or otherwise not transmitted. In response, the receive hardware 112 may indicate that information corresponding to the packet 108 may be sent or otherwise communicates to the processing system 114.

In some embodiments, the receive hardware 112 may be configured to read the flag data included in the header to determine additional information about the segment. For example, the receive hardware 112 may be configured to identify whether the corresponding segment is a beginning segment or an ending segment of a particular data frame. Such indications may be used by the receive hardware 112 in determining whether to reset a sequence counter related to verifying that all the segments of a corresponding set of data 102 corresponding to a data frame have been received. In some embodiments, in response to the flag data indicating the segment corresponding to a particular packet 108 may include data 102 corresponding to the beginning of a data frame or the end of a data frame, the receive hardware 112 may additionally be configured to flag the particular packet 108 for review by the processing system 114.

In some embodiments, the receive hardware may be configured to generate packet information 118 corresponding to one or more packets 108. Further, in some embodiments, the receive hardware 112 may be configured to communicate the packet information 118 to the processing system 114.

In some embodiments, the packet information 118 may include data corresponding to one or more packets 108 that may be communicated to the processing system 114. In some embodiments, the information communicated to the processing system 114 may include data and/or information derived using information corresponding to one or more header fields; for example, one or more header fields corresponding to the modified header 175b. Additionally or alternatively, the packet information 118 may include information generated based on the data corresponding to respective packets 108. For example, the receive system 110 may include one or more descriptors that may generate and/or otherwise determine information associated with respective packets 108 that may be communicated to the processing system 114.

FIG. 1C illustrates an example diagram representing packet information 118, in accordance with one or more embodiments of the present disclosure. The packet information 118 may include one or more fields representing information that may be communicated to the processing system 114.

In some embodiments, the packet information 118 may include one or more fields that may include data and/or information corresponding to the packet 108, the payload corresponding to the packet 108, and/or the data 102 corresponding to the payload. In some embodiments, the one or more fields may include, for example, a sequence number field 120, a queue number field 122 one or more reserved fields 124, a flag field 126, a frame number field 130, a byte offset field 132, a header pointer field 134, and a last good sequence number field 138.

The sequence number field 120 may indicate a respective sequence number that is assigned to a respective segment included in the payload of a corresponding packet 108. In some embodiments, the sequence number may be the same as the sequence number included in the sequence number field 158b described and/or illustrated further in the present disclosure, such as, for example, with respect to FIG. 1B.

The queue number field 122 may indicate a particular queue to which a data frame may correspond. In some embodiments, the segment included in a payload of a particular packet 108 may also be associated with a particular data frame. For example, each of the segments corresponding to a particular data frame may include the same queue number included in each of their respective queue number fields 122. In these or other embodiments, the queue number 122 may include data and/or information included in the queue number field 175b described and/or illustrated further in the present disclosure, such as, for example, with respect to FIG. 1B.

In some embodiments, one or more reserved fields 124 may be included in the packet information 118. In some embodiments, the one or more reserved fields 124 may include one or more bits of data, for example, one or more zeros (0s). In some embodiments, the one or more reserved fields 124 may serve as a placeholder for future use and may be left intentionally blank and/or undefined. In some embodiments, the one or more reserved fields 124 may provide flexibility to standardize the number of bits and/or bytes that may be included in the packet information 118.

The flag field 126 may include one or more values that may indicate a status corresponding to the packet 108 and/or the segment included in the payload corresponding to the packet 108. For example, data included in the flag field 126 may indicate that the segment included in a payload corresponding to the packet 108 is data 102 corresponding to a start of a data frame, an end to the data frame, or data 102 included in the middle of the data frame. In some embodiments, the data included in the flag field 126 may indicate one or more errors and/or discontinuities associated with the data 102 included in the payload of a respective packet 108. For example, data included in the flag field 126 may indicate that one or more packets 108 may have not been transmitted, the data may indicate that one or more errors corresponding to the data 102 included in the payload. In these or other embodiments, the data and/or information included in the flag field 126 may be the same as, and/or analogous to, the data and/or information included in the flag field 154d described and/or illustrated further in the present disclosure, such as, for example, with respect to FIG. 1B and/or Table 1.

The frame number field 130 may include data indicating a frame number corresponding to the segment included in the payload corresponding to the particular packet 108. In some embodiments, the frame number may be indicated using a 2-bit encoding—e.g., 00, 01, 10, or 11 indicating a frame number corresponding to a particular queue. In these or other embodiments, the frame number field may be the same as and/or analogous to the frame number field 156d described and illustrated further in the present disclosure, such as, for example, with respect to FIG. 1B.

The byte offset field 132 may include a respective byte offset to be applied to the respective segment included in the payload of the corresponding packet 108. In some embodiments, the byte offset may indicate a designated storage location associated with the segment in the form of a number of bytes away from the beginning of the data frame to which the segment corresponds. The byte offset field 132 may include the byte offset included in the byte offset field 156e described and/or illustrated further in the present disclosure, such as, for example, with respect to FIG. 1B.

The header pointer field 134 may include a pointer that may indicate a storage memory location to which the header information may be stored. In some embodiments, the pointer included in the header pointer field 134 may increase sequentially such that the number of packets 108 successfully stored may be determined. For example, determining a difference between header pointers included in respective header pointer fields 134 of respective packets 108 may be used to determine the number of packets 108 that may have been successfully received. Further, the pointer included in the header pointer field may be used by one or more hardware components (e.g., receive hardware 112) or processing systems 114 to store the header information corresponding to particular packets 108.

The last good sequence number field 138 may include a sequence number corresponding to a packet 108 that may have been received prior to a current packet 108. For example, a first packet 108 corresponding to a first sequence number “0” may have been received successfully. Continuing the example, a second packet 108 corresponding to a second sequence number “1” may include sequence number “0” in the last good sequence number field 138.

Modifications, additions, or omissions may be made to FIG. 1C without departing from the scope of the present disclosure. For example, the amount of data included in the one or more fields corresponding to the packet information 118 and/or the number of reserved fields 124 may vary. The specifics given and discussed are to help provide explanation and understanding of concepts of the present disclosure and are not meant to be limiting.

Returning to FIG. 1A, in response to receiving the packet information 118, the processing system 114 may be configured to perform one or more operations and/or direct one or more corresponding systems to perform one or more operations. For example, in response to an indication that one or more packets 108 were lost during transmission, the processing system 114 may be configured to request that the segment or segments corresponding to the lost packets 108 be retransmitted. Further, due to the byte offsets, the segments that are received after the missing segment may be stored in their designated memory locations corresponding to the memory 116.

In some embodiments, the processing system 114 may include code and routines configured to allow a computing system to perform one or more operations. Additionally or alternatively, the processing system 114 may be implemented using hardware including one or more processors, CPUs, GPUs, DPUs, PPUs, microprocessors (e.g., to perform or control performance of one or more operations), FPGA, ASICS, accelerators (e.g., DLAs), and/or other processor types. In these or other embodiments, the processing system 114 may be implemented using a combination of hardware and software. In the present disclosure, operations described as being performed by the processing system 114 may include operations that the processing system 114 may direct a corresponding computing system to perform. In these or other embodiments, the processing system 114 may be implemented by one or more computing devices, such as that described in further detail with respect to FIGS. 4A-4D, 5, and/or 6.

In these and other embodiments, the processing system 114 may be notified, for example, using the packet information 118 that a new set of data 102 corresponding to a new data frame may be received using the receive hardware 112. Additionally or alternatively, the processing system 114 may be notified that a particular set of data 102 corresponding to a particular data frame has been received based on the flag data. The processing system 114 may be configured to perform one or more operations accordingly. For example, the processing system 114 may determine a new base address for a next set of data 102 corresponding to a particular data frame in response to an indication that a current set of data 102 corresponding to a particular data frame has all been received and/or in response to an indication that a new set of data 102 corresponding to a new data frame is being received.

In some embodiments, in response to the receive hardware 112 notifying the processing system 114 that one or more packets 108 may not have been received, the processor system 114 and/or the receive system 110 may be configured to communicate information corresponding to the missing packet 108 information to the transmit system 104. For example, the receive hardware 112 may receive a first packet 108 including a first sequence number of zero (0) and a second packet 108 including a second sequence number of two (2). The receive hardware 112 may be configured to recognize that a packet 108 is missing with a corresponding missing sequence number of one (1). Further continuing the example, the processing system 114 may communicate the missing packet 108 by sending sequence numbers zero (0) and two (2) and requesting the transmission or re-transmission of the segment that was included in the missing packet 108.

In some embodiments, the processing system 114 may receive a notification from the receive hardware 112, e.g., via the packet information 118, that more than one packet 108 may be missing. In response to such a notification, the processing system 114 may be configured to request retransmission of a set of packets 108. For example, the transmit system 104 may transmit a set of packets 108 corresponding to a data frame. Continuing the example, the receive hardware 112 may notify the processing system 114 that multiple packets 108 may be missing from the transmission. In response, the processing system 114 may request the retransmission of all of the packets 108 corresponding to the data frame. In some embodiments, in response to a notification that an individual packet 108 may be missing from a transmission, the processing system 114 may be configured to request retransmission of an entire data frame, the data frame corresponding to the missing individual packet 108.

In contrast to other protocols and systems that may use one or more processing units to determine storage locations corresponding to each segment included in one or more packets 108, embodiments described herein may use the processing system 114 in select instances. For example, when the receive hardware 112 encounters one or more missing packets 108 and/or when the receive hardware 112 encounters one or more flags corresponding to flag fields in corresponding packets 108. In some embodiments, using the processing system 114 selectively in this manner may decrease an amount of processing resources that may be used to store respective segments corresponding to respective packets 108 in memory 116.

Modifications, additions, or omissions may be made to FIG. 1A without departing from the scope of the present disclosure. For example, the amount of data 102, the number of transmit systems 104, packet modules 106, packets 108, receive systems 110, receive hardware 112, processing systems 114, packet information 118, and/or memory 116 may vary. Further, operations performed using the packet module 106, the transmit system 104, the receive hardware 112, the processing system 114, and/or the receive system 110 are meant to be illustrative. The operations may be performed using one or more other systems, modules, devices, hardware, software, etc. The specifics given and discussed are to help provide explanation and understanding of concepts of the present disclosure and are not meant to be limiting.

FIG. 2A is a diagram representing an example environment 200 related to transmitting and receiving image frame 206, in accordance with one or more embodiments of the present disclosure. In some embodiments, the example environment 200 may be an example implementation of the environment 100 described further in the present disclosure, such as, for example, with respect to FIG. 1A. In some embodiments, the example environment 200 may include one or more camera sensors 204 that may be configured to generate and/or otherwise collect image frame 206.

In some embodiments, the camera sensor 204 may include one or more types of image sensors such as, for example, charge-coupled devices (“CCD”), complementary metal-oxide-semiconductor (“CMOS”) sensors, etc. In some embodiments, CCD and CMOS sensors may be used in connection with one or more cameras to capture and/or generate image data corresponding to one or more captured images. In some embodiments, the camera sensor 204 may be an example of multiple camera sensors 204 that may be configured to capture image data included in one or more image frames 206 corresponding to an environment in which each of the camera sensors 204 may be located. In some embodiments, the camera sensor 204 may be located in the same environment as the transmit system 202 and/or the receive system 212.

In some embodiments, the camera sensor 204 may be configured to generate image data associated with one or more image frames 206 corresponding to the environment in which the camera sensor 204 may be located. In some embodiments, the camera sensor 204 may additionally be configured to generate other data corresponding to the image frame 206. For example, the camera sensor 204 may generate metadata corresponding to the image frame 206—e.g., time stamps, sensor types, location information, etc. Continuing the example, the camera sensor 204 may be configured to communicate and/or indicate that one or more errors may have occurred during data generation and/or in sending image data corresponding to the one or more image frames 206 to the transmit system 202.

In some embodiments, the camera sensor 204 may be configured to assign the image frame 206 to one or more channels over which the image frame 206 may be communicated. For example, the image frame 206 may correspond to a first camera sensor 204 and a second camera sensor 204. Continuing the example, the image frame 206 corresponding to the first camera sensor 204 may be assigned to and communicated over a first channel and the image frame 206 corresponding to the second camera sensor 204 may be assigned to and communicated over a second channel.

In some embodiments, the image frame 206 may correspond to a particular camera sensor 204. For example, image frame 206 may include image data corresponding to a first camera sensor 204. Additionally or alternatively, the image frame 206 may include data that may correspond to several different camera sensors 204. In some embodiments, the image frame 206 as referred to herein may additionally include information including, for example, corresponding metadata, error information, etc.

In some embodiments, image data generated using the one or more camera sensors 204 may be divided and/or organized into one or more image frames 206. In some embodiments, in the context of an image frame 206 corresponding to an image, the image frame 206 may refer to image data corresponding to a particular image captured at a particular time (e.g., all of the pixels included in a single image). In some embodiments, the image frame 206 may include one or more lines of image data (referred to herein as “lines”) that may include image data corresponding to a particular line of pixels in an image. In some embodiments, a line may include all of the pixels spanning the width of a particular image corresponding to the image frame 206. Additionally or alternatively, a line may include a set amount of image data included in a particular image frame 206. In these or other embodiments, the image frame 206 may be an example of the data 102 that may be described further in the present disclosure, such as, for example, with respect to FIG. 1A. In some embodiments, the image frame 206 may be transmitted, communicated, or otherwise provided to the transmit system 202.

The transmit system 202 may include one or more systems, modules, control units, etc. that may be configured to perform one or more operations on the image frame 206. In some embodiments, the transmit system 202 may include one or more Media Access Control (“MAC”) layers corresponding to a larger module, system, etc. such as, for example, a system on a chip (“SoC”). For example, the transmit system 202 may include an SoC corresponding to an autonomous vehicle or semi-autonomous vehicle, where the SoC may include one or more computing systems, embedded systems, processing systems, memory, etc. where the SoC may be configured to perform one or more operations on the image frame 206.

In some embodiments, the transmit system 202 may additionally include one or more modules that may be configured to perform one or more operations on the image frame 206. In some embodiments, the transmit system 202 may include a packet module 208 that may be configured to collect, generate, and/or prepare the image frame 206 for transmission by dividing, packaging, and/or organizing the image frame 206. In these or other embodiments, the transmit system 202 may be an example and/or analogous to the transmit system 104 described and/or illustrated further in the present disclosure, such as, for example, with respect to FIG. 1A.

In some embodiments, the packet module 208 may include code and routines configured to allow a computing system to perform one or more operations. Additionally or alternatively, the packet module 208 may be implemented using hardware including one or more processors, CPUs GPUs, DPUs, PPUs, microprocessors (e.g., to perform or control performance of one or more operations), FPGA, ASICS, accelerators (e.g., DLAs), and/or other processor types. In these or other embodiments, the packet module 208 may be implemented using a combination of hardware and software. In the present disclosure, operations described as being performed by the packet module 208 may include operations that the packet module 208 may direct a corresponding computing system to perform. In these or other embodiments, the packet module 208 may be implemented by one or more computing devices, such as that described in further detail with respect to FIGS. 4A-4D, 5, and/or 6.

In some embodiments, the packet module 208 may be configured to generate one or more checksums corresponding to the image data associated with a particular image frame 206. For example, the one or more checksums may include a cyclic redundancy check (“CRC”), a secure hash algorithm, and/or other checksums configured to ensure that image frame 206 transmitted using the transmit system 202 may be the same image frame 206 as the image frame 206 that may be received using, for example, the receive system 212. For example, the packet module 208 may be configured to generate a respective sixteen-byte (16B) checksum corresponding to image data included in respective image frames 206. In some embodiments, the packet module 208 may be configured to send respective checksums with respective image frames 206 using one or more packets 210.

In some embodiments, the packet module 208 may be configured to subdivide and/or organize the image data included in the one or more image frames 206 into one or more segments. In some embodiments, a segment may include all of the image data included in an image frame 206. In some embodiments, a segment may include all of the data in a line. Additionally or alternatively, a particular segment may include image data corresponding to a portion of a line. In some embodiments, multiple segments may correspond to a same line. In some embodiments, the segments may correspond to image data included in the one or more image frames 206 that may be used as payloads and transported in respective packets 210. In some embodiments, the payload, and therefore, the corresponding segment may include a particular amount of data (e.g., 64 Bytes) to maintain uniformity in the payload and in data transmission overall.

In some embodiments, one or more subframes may be determined, assigned, and/or identified using the packet module 208. As used in the present disclosure, a subframe may indicate a portion of the image frame 206 that, when received using one or more systems, one or more data processing operations may begin on the image frame 206. In some embodiments, one or more lines of an image frame 206 may be a respective subframe. In some embodiments, the subframe may include a predetermined amount of image data or a set number of pixels corresponding to an image. In these or other embodiments, the packet module 208 may be configured to include an indication that particular image data corresponds to an end of a subframe corresponding to a particular image frame 206. The indication may be included in one or more packets 210.

In some embodiments, each of the segments that may correspond to a particular image frame 206 may be assigned and/or given a sequence number such as described, for example, with respect to FIGS. 1A, 1B, and/or 1C.

In some embodiments, the sequence numbers may be initialized using one or more processing systems that may be included in the transmit system 202, the packet module 208, and/or one or more other associated systems. In some embodiments, after a sequence number may have been initialized using one or more processing systems, one or more hardware units may be configured to assign subsequent sequence numbers to respective packets 210. For example, the image data corresponding to a particular image frame 206 may be organized into three segments. Continuing the example, the one or more processing systems may initialize the sequence numbering by assigning the first segment a first sequence number, e.g., “0.” Continuing the example, one or more hardware units may thereafter be configured to increment the sequence numbers to assign the second segment a second sequence number, “1” and the third segment a third sequence number, “2.”

In some embodiments, the packet module 208 may be configured to assign a byte offset to respective segments. In some embodiments, a respective byte offset may be assigned based on an amount of image data used to store one or more segments in packets 210 corresponding to sequence numbers prior to the sequence number corresponding to the respective byte offset. For example, an image frame 206 may include a first segment, a second segment, and a third segment, each segment including 64 Bytes of image data. The first segment may be assigned a first sequence number of zero (0), the second segment may be assigned a second sequence number of one (1), and the third segment may be assigned a third sequence number of (2). Continuing the example, each of the first segment, the second segment, and the third segment may additionally correspond to respective byte offsets that may correspond to the number of bytes in the respective segments. The first segment may correspond to a first byte offset of zero (0), the second segment corresponds to a second byte offset sixty-four (64), and the third segment may be assigned a third byte offset of one-hundred twenty-eight (128).

In some embodiments, the packet module 208 may be configured to package the image data corresponding to an image frame 206 into one or more packets 210. The packets 210 may include a payload field that may be populated with image data corresponding to a particular segment of the image frame 206. As used in the present disclosure, “payload” may refer to a payload field corresponding to a particular packet 210. Additionally or alternatively, “payload” may refer to the image data that may be included in the payload field corresponding to the particular packet 210. More specifically, the payload may be populated with a subset of the image frame 206—e.g., the payload may be populated with a segment corresponding to the image frame 206. In these or other embodiments, payloads corresponding to respective packets 210 may be populated with respective segments corresponding to the image frame 206. In these or other embodiments, the payload may be an example of the payload and/or payload fields described and/or illustrated further in the present disclosure, such as, for example, with respect to FIGS. 1A, 1B, and 1C.

In some embodiments, the packets 210 may additionally include respective headers. In some embodiments, a header may include one or more data fields included in respective packets 210 that may include information associated with the transmission and storage of the respective packets 210 (e.g., source address of a sender, destination address corresponding to an intended recipient of the payload, etc.). In some embodiments, the header may be modified by adding one or more additional header fields to one or more existing Ethernet protocols, such as, for example, the 1722 Ethernet protocol. In these or other embodiments, the header may be an example of the header and/or header fields described and/or illustrated further in the present disclosure, such as, for example, with respect to FIGS. 1A, 1B, and 1C.

An example implementation of a header corresponding to one or more packets 210 may be described with respect to FIG. 2B. FIG. 2B is an example diagram representing a modified 1722 header 275 corresponding to image data corresponding to one or more image frames 206 and/or packets 210 of FIG. 2A, in accordance with one or more embodiments of the present disclosure. The modified 1722 header 275 may include fixed header fields that may already be included in the 1722 IEEE Ethernet protocol standard. In some embodiments, header fields may be added to the 1722 Ethernet header to include data and/or information included in, for example, the modified header 175b described further in the present disclosure, such as, for example, with respect to FIGS. 1A and 1B.

In some embodiments, the modified 1722 header 275 may include one or more fields that may include data and/or information corresponding to the packet 210, the payload corresponding to the packet 210, and/or the image data corresponding to the payload. In some embodiments, the one or more fields may include, for example, a sequence number field 254, an error (“E”) field 256, a sticky error (“SE”) field 258, a frame checksum (“FCV”) field 260, a version field 262, a channel number field 268, a flag field 270, a frame number field 272, a frame number reserved field 274, and/or a byte offset field 276.

The sequence number field 254 may include a sequence number corresponding to respective payloads of respective packets 210. In these or other embodiments, the sequence number field 254 may include the same information as, and/or be analogous to the sequence number field 120 and/or the sequence number field 158a described and/or illustrated further in the present disclosure, such as, for example, with respect to FIGS. 1B and 1C.

The error field 256, represented in the present figure is “E” 256 may indicate one or more errors corresponding to the segment associated with the particular packet 210. In some embodiments, in response to an error occurring while the image frame 206 is generated, the camera sensor 204 may be configured to assign, report, or otherwise indicate that an error has occurred. In some embodiments, the indication that an error has occurred corresponding to generating the image frame 206 may be included in the error field 256.

The sticky error (“SE”) field 258 may indicate a particular error corresponding to an image frame 206. In some embodiments, in response to an error affecting or potentially affecting the entirety of an image frame 206, the SE field 258 may indicate that the error may correspond to all of the image data included in the image frame 206—e.g., image data included in payloads of multiple packets 210. The SE field 258 may be reset after each image frame 206. In some embodiments, the SE field 258 may indicate an existence of an error even in instances where the segment may have been lost and/or otherwise compromised.

The frame checksum field 260 may include an indication that a checksum—e.g., a cyclic redundancy check (“CRC”), hash algorithm, and/or some other checksum may have been determined to be valid. In some embodiments, the indication may include one or more values that may serve as an indicator that either the checksum is valid or invalid. In some embodiments, the packet 210 that may include an indication that the checksum is valid may also be the packet 210 including image data corresponding to the end of a particular image frame 206. In some embodiments, the frame checksum may be included in the payload of a packet 210 including image data corresponding to an end of a particular image frame 206. For example, a payload including image data corresponding to the end of a particular image frame 206 may include a 16B CRC corresponding to all of the image data corresponding to the particular image frame 206. Continuing the example, in response to the CRC being valid, the frame checksum field 260 may indicate the result using a value (e.g., “1”).

The version field 262 may include the version of the protocol with which the packet 210 and corresponding payload may be sent. In some embodiments, the version field 262 may allow for subsequent versions and/or improvements to the modified 1722 header 275 without confusing the receive system 212 and/or the transmit system 202 regarding which version is being used.

The exposure field 264 may include a value indicating an exposure corresponding to the image frame 206 that may be included in the payload of the respective packet 210. In some embodiments, photographic and cinematic images may include one or more exposures corresponding to one or more times that a camera shutter may be opened to capture the image. The exposure field 264 may include information corresponding to the number and duration of exposures included in the image frame 206.

In some embodiments, one or more reserved fields 266 may be included in the modified 1722 header 275. In some embodiments, the one or more reserved fields 266 may include one or more bits of data, for example, one or more zeros (0s). In some embodiments, the one or more reserved fields 266 may serve as a placeholder for future use and may be left intentionally blank and/or undefined in a current version of the modified 1722 Ethernet protocol. In some embodiments, the one or more reserved fields 266 may provide flexibility in the modified 1722 protocol design and/or to standardize the number of bits and/or bytes that may be included in the modified 1722 header 275. In these or other embodiments, the one or more reserved fields 266 may be the same as and/or analogous to the reserved field(s) 124 described and/or illustrated in the present disclosure, such as, for example, with respect to FIG. 1C.

The channel number field 268 may include a value indicating a channel corresponding to the image frame 206. In some embodiments, the channel number included in the channel number field 268 may be used by the receive system 212 to identify particular camera sensors 204, base addresses corresponding to particular image frames 206, etc.

The flag field 270 may include data that may indicate a status corresponding to the packet 210 and/or the segment included in the payload corresponding to the packet 210. In some embodiments, data included in the flag field 270 may indicate that the segment included in the payload may be the first segment corresponding to an image frame 206. In some embodiments, the flag field 270 may include data that may indicate that a second segment included in a second payload of a second packet 210 may be a final segment corresponding to the image frame 206.

In some embodiments, data included in the flag field 270 may indicate that the segment included in the payload may be the first segment corresponding to metadata included in an image frame 206. In some embodiments, the flag field 270 may include data that may indicate that a second segment included in a second payload of a second packet 210 may be a final segment corresponding to metadata included in the image frame 206.

In some embodiments, the flag field 270 may include an indication of an end to a sub frame corresponding to a particular image frame 206. In some embodiments, the end of a subframe may indicate that one or more processing operations may be performed on image data (e.g., operations performed using an image processor 218) that may have already been transmitted corresponding to the image frame 206. In some embodiments, the subframe may include a pre-defined number of lines or a predefined amount of image data corresponding to the image frame 206.

In some embodiments, the flag field 270 may include data and/or information that may indicate that one or more errors may have occurred corresponding to the segment included in the payload of the respective packet 210. For example, one or more errors may have occurred in the collection or transfer of the segment included in a respective payload of a respective packet 210 which may be indicated in the flag field 270.

In some embodiments, the flag field 270 may indicate that a particular packet 210 should be sent and/or transmitted to one or more processing units (e.g., one or more CPUs). The one or more processing units may be configured to determine one or more operations to perform based on the information included in the flag field 270. For example, the flag field 270 may include information indicating one or more errors may have occurred—e.g., that the one or more packets 210 corresponding to a particular image frame 206 may not have been transmitted or may have been lost. In some embodiments, the one or more processing units may be configured to delete, remove, or otherwise not store the image frame 206 corresponding to the missing segment.

An example of possible data included in the flag field 270 of corresponding packets 210 may be illustrated and/or explained further with respect to Table 2:

TABLE 2

| Flags [7:0] | Description |
|---|---|
| [2:0] | 000: Middle |
| | 001: Frame Start (SOF) |
| | 010: Frame End (EOF) |
| | 011: Metadata Start |
| | 100: Metadata End |
| | 101: Subframe End |
| | 110: Reserved |
| | 111: Reserved |
| [3] | When 1, Notify Packet Processor |
| [4] | Line End (EOL) |
| [7:5] | Packet Type |
| | 100: Reserved |
| | 101: Image Data |
| | 110: Meta Data |
| | 111: Reserved |
| | 000: Reserved |
| | 001: Error |
| | 010: I2C ACKS |
| | 011: Safety Events |

Table 2 illustrates an example of the flag field 270 that may include 8-bits indicated using indicator [7:0] indicating a range of bits within a bit field. Using this notation, the numbers before and after the colon (:) represent the most significant bit and the least significant bit of the field, respectively. In some embodiments, Table 2 may be an example implementation of the flag field 154d described further in the present disclosure, such as, for example, with respect to FIGS. 1A, 1B, and Table 1.

The first three bits, represented in the second row of Table 1 as [2:0], may be used to convey information corresponding to the payload carried using the packet 210. For example, in instances where the first three bits include “000,” the segment carried by the packet 210 may include image data corresponding to the image frame 206 associated with the middle of the image frame 206. Continuing the example, “001” may indicate that the segment carried by the packet 210 may include the image data at the start of the image frame 206, and “010” may indicate that the segment may include image data that may be at the end of the image frame 206.

Further, as illustrated in Table 2, the first three bits may indicate that the segment corresponding to the particular packet may include the start and/or the end of metadata corresponding to a particular image frame 206. For example, bit combination “011” may indicate that the segment carried by a particular packet 210 may include the start of metadata corresponding to a particular image frame 206. Additionally or alternatively, bit combination “100” may indicate that the segment carried by a particular packet 210 may include the end of the metadata corresponding to a particular image frame 206.

In some embodiments, the first three bits may indicate that the segment carried by a particular packet 210 may include an end of a subframe corresponding to a particular image frame 206. For example, as shown in Table 2, the three-bit combination “101” may indicate that the segment included in the payload may include data 102 corresponding to the end of a subframe associated with the particular image frame 206.

As illustrated in Table 2, the remaining bit combinations corresponding to the first three bits in the flag field 270 (“110” and “111”) may be reserved to indicate information in subsequent iterations or versions of the flag field 270 corresponding to respective packets 210.

The fourth bit, represented in the third row of Table 2 as [3], is used to convey whether the data packet 210 may need to be processed using one or more processing systems. For example, packet processor 216 described and/or illustrated further in the present disclosure, such as, for example, with respect to FIG. 2A. Instances in which the fourth bit may include a “1,” may indicate that the packet 210 may be sent and/or processed using one or more processing systems. By contrast, instances in which the fourth bit may include a “0,” may indicate that the packet 210 and/or corresponding image data that may be carried by the packet 210 may not be sent and/or processed using one or more processing systems.

The fifth bit, represented in the fourth row of Table 1 as [4], may indicate that the image data being transported using a particular packet 210 may include image data corresponding to an end of a line. For example, the fourth bit including a “1” may indicate that the payload may include image data corresponding to the end of a line associated with a particular image frame 206. Additionally or alternatively, the fourth bit including a “0” may indicate that the payload may include image data that may not correspond to the end of a line associated with a particular image frame 206.

The last three bits in the example flag field 270 as indicated by Table 2 may indicate a packet type associated with the packet 210. For example, bit combination “101” may indicate that the payload of a particular packet 210 may be populated with image data. By comparison, a bit combination “110” may indicate that the payload of the particular packet 210 may be populated with metadata corresponding to the image frame 206.

In some embodiments, as illustrated in Table 2, the final three bits may indicate that the payload may include image data that may be associated with one or more errors or that the payload may include image data that may have been transmitted successfully. For example, bit combination “001” may indicate that an error may have occurred when generating the image frame 206. As another example, bit combination “010” may indicate successful receipt of the image frame 206, for example, using an acknowledgement signal (“ACK”) used in an inter-integrated circuit (“I2C”).

In some embodiments, as illustrated in Table 2, the final three bits may indicate that the payload may include image data associated with a safety event. For example, the image frame 206 captured at particular time stamps may have been generated during one or more safety events corresponding to the system. The safety event may include, for example, an accident of an ego-machine corresponding to the camera sensor 204. In some embodiments, the final three bits may indicate that the image frame 206 carried by a particular packet 210 may have been associated with a safety event.

Returning again to the description of FIG. 2B, the frame number field 272 may indicate a frame number corresponding to the segment included in the payload corresponding to the particular packet 210. In some embodiments, the frame number may be indicated using a 2-bit encoding—e.g., 00, 01, 10, or 11 indicating a frame number corresponding to a particular queue. In these or other embodiments, the frame number field may be the same as and/or analogous to the frame number field 130 and/or the frame number field 156c described and illustrated further in the present disclosure, such as, for example, with respect to FIGS. 1B and 1C.

The byte offset field 276 may include a byte offset corresponding to the segment included in the payload of the packet 210. In some embodiments, the byte offset may indicate a storage location for the segment in the form of a number of bytes away from the beginning of the image frame 206 to which the segment corresponds. For example, the byte offset field 276 may include a 28-bit value indicating a memory location in which to store the segment. In these or other embodiments, the byte offset field 276 may be the same as and/or analogous to the byte offset field 132 and/or 156d described and illustrated further in the present disclosure, such as, for example, with respect to FIGS. 1B and 1C.

Modifications, additions, or omissions may be made to FIG. 2B without departing from the scope of the present disclosure. For example, one or more other fields corresponding to the fixed header fields may be changed, amended, and/or modified to include one or more other fields and/or new information corresponding to existing fields. Further, the amount of data included in the one or more fields corresponding to the modified 1722 header 275 may vary. The specifics given and discussed are to help provide explanation and understanding of concepts of the present disclosure and are not meant to be limiting.

Returning to the description of FIG. 2A, the one or more packets 210, the respective headers, and respective payloads may be communicated to the receive system 212. In some embodiments, the receive system 212 may include one or more systems, modules, SoC's, MAC layers, etc. that may be configured to perform one or more operations on the image data that may be included in the packets 210. For example, the transmit system 202 may include an SoC corresponding to an autonomous vehicle or semi-autonomous vehicle, where the SoC may include one or more computing systems, embedded systems, processing systems, etc. where the SoC may be configured to perform one or more operations on the image data included in the one or more image frames 206 and/or the packets 210.

In some embodiments, the receive system 212 may include one or more modules and/or systems that may be configured to perform one or more operations on the image data included in the packets 210. In some embodiments, the receive system 212 may include receive hardware 214, a packet processor 216, and an image processor 218 that may be configured to extract data corresponding to respective payloads of respective packets 210 and/or store the extracted data in memory 220 corresponding to the receive system 212.

The memory 220 may include one or more components corresponding to the receive system 212 configured to store data corresponding to the packets 210. In these or other embodiments, the memory 220 may be an example of the memory 116 described and illustrated further in the present disclosure, such as, for example, with respect to FIG. 1A.

The receive hardware 214 may include one or more hardware units that may perform one or more operations using image data corresponding to the packets 210 without using one or more processing units, e.g., one or more CPUs. Receive hardware 214 may include one or more counters, comparators, arithmetic logic units (ALUs), adders, logic circuits, and/or other hardware units configured to perform one or more operations without using processing units and/or using a decreased amount of processing power and/or resources as compared to one or more other Ethernet protocols where one or more processing units designate storage locations in memory 220 for the packets 210.

In some embodiments, the receive hardware 214 may be configured to direct the storage of the segments to their corresponding storage locations in the memory 220. For example, the receive hardware 214 of the receive system 212 may be configured to read the byte offsets included in the byte offset fields of respective packets 210. Based on the byte offset and the base memory address, the receive hardware 214 may be configured to direct the storage of the segments of the corresponding packets 210 to respective memory locations. For example, the receive hardware 214 may add the particular byte offset to the base memory address to determine a particular memory address of a particular segment. In these and other embodiments, the receive hardware 214 may direct that the particular segment be stored at the particular memory address in the memory 220.

In some embodiments, the receive hardware 214 may be configured to determine whether the order of the sequence numbers follows the sequence—e.g., the receive hardware 214 may be configured to determine whether the sequence numbers incrementally increase by one as the packets 210 corresponding to image data associated with a particular image frame 206 are received. In these and other embodiments, the receive hardware 214 may be configured to report to the packet processor 216 instances in which received sequence numbers do not follow the sequence, which may indicate that a particular packet 210 carrying a particular segment was lost during transmission. In response, the packet processor 216 may be configured to delete, remove, or otherwise not store data in the image frame 206 corresponding to the particular segment.

In these or other embodiments, the receive hardware 214 may be configured to determine additional information associated with the segment based on the flag field 270. For example, the receive hardware 214 may be configured to identify whether the corresponding segment is a beginning segment or an ending segment of a particular image frame 206. Such indications may be used by the receive hardware 214 in determining whether to reset a sequence counter related to verifying that all the segments of a corresponding set of image data associated with an image frame 206 have been received. In some embodiments, in response to the flag data indicating the segment corresponding to a particular packet 210 may include data corresponding to the beginning of an image frame 206 or the end of an image frame 206, the receive hardware 214 may additionally be configured to flag the particular packet 210 for review and/or additional processing using the image processor 218.

In some embodiments, the receive hardware 214 may be configured to detect and/or determine, using the information corresponding to the flag field 270, that a segment corresponding to a particular packet 210 includes an end of a subframe. In some embodiments, in response to detecting that a segment includes image data corresponding to the end of a subframe, the receive hardware 214 may be configured to flag the particular packet 210 for review and/or additional processing using the packet processor 216. In instances in which the flags may indicate an end of subframe or an end of an image frame 206, the packet processor 216 may notify the image processor 218 to process the image data corresponding to the image frame 206 or the subframe.

In some embodiments, the receive hardware 214 may be the same as, analogous to, and/or an example of, the receive hardware 112 described and/or illustrated further in the present disclosure, such as, for example, with respect to FIG. 1A.

In some embodiments, the packet processor 216 and/or the image processor 218 may include one or more systems, devices, etc. that may be configured to perform one or more processing operations. In some embodiments, the packet processor 216 and/or the image processor 218 may be implemented using hardware including one or more processors, CPUs, GPUs, DPUs, PPUs, microprocessors (e.g., to perform or control performance of one or more operations), FPGAs, ASICs, accelerators (e.g., DLAs), and/or other processor types. In these or other embodiments, the packet processor 216 and/or the image processor 218 may be implemented using a combination of hardware and software. In the present disclosure, operations described as being performed by the packet processor 216 and/or the image processor 218 may include operations that the packet processor 216 and/or the image processor 218 may direct a corresponding computing system to perform. In these or other embodiments, packet processor 216 and/or the image processor 218 may be implemented by one or more computing devices, such as that described in further detail with respect to FIGS. 4A-4D, 5, and/or 6.

In these and other embodiments, the packet processor 216 may be notified that a new set of image data corresponding to a new image frame 206 may be received using the receive hardware 214. Additionally or alternatively, the packet processor 216 may be notified that a particular set of image data corresponding to a particular image frame 206 has been received based on the flag data included, for example, in the flag field 270. The packet processor 216 may be configured to perform one or more operations accordingly. For example, the packet processor 216 may determine a new base address for a next set of image data corresponding to a particular image frame 206 in response to an indication that a current set of image data corresponding to a particular image frame 206 has all been received and/or in response to an indication that a new set of image data corresponding to a new image frame 206 is being received.

In some embodiments, in response to the receive hardware 214 notifying the packet processor 216 that one or more packets 210 may not have been received, the packet processor 216 may be configured to delete or remove the image data corresponding to the image frame 206 associated with the segment in the missing packet(s) 210.

For example, the receive hardware 214 may receive image data corresponding to an image frame 206 including a first packet 210 including a first sequence number of zero (0) and a second packet 210 including a second sequence number of two (2). The receive hardware 214 may be configured to recognize that a packet 210 is missing with a corresponding missing sequence number of one (1). Further continuing the example, the packet processor 216 may be configured to remove segments corresponding to the first packet 210 and the second packet 210 from the memory 220 and/or not store segments corresponding to the first packet 210 and/or the second packet 210.

In some embodiments, the image processor 218 may include a combination of hardware and software that may be configured to process the image frame 206. In some embodiments, the image processor 218 may perform one or more operations on the image frame 206 such as, for example, reconstructing an image corresponding to the image frame 206, reducing noise, correcting colors, controlling exposure, compressing image frame 206, etc.

In some embodiments, the image processor 218 may perform one or more operations on the image frame 206 based on data corresponding to, for example, the flag field 270. In some embodiments, in response to the packet processor 216 notifying the image processor 218 that a segment corresponding to a particular packet 210 may include image data corresponding to the end of an image frame 206, the image processor 218 may be configured to perform one or more processing operations on the image data associated with the particular image frame 206.

In some embodiments, the image processor 218 may begin one or more processing operations on the image data corresponding to a particular image frame 206 in response to the packet processor 216 notifying the image processor 218 that a segment corresponding to a particular image frame 206 may correspond to an end of a subframe. The image processor 218 may perform one or more processing operations on the particular image frame 206 prior to receiving all of the packets 210 and corresponding image data associated with the entirety of the image frame 206. In so doing, the image processor 218 may process all of the image data corresponding to the particular image frame 206 faster than the image processor 218 may process the image data corresponding to the entirety of the image frame 206 when all of the corresponding packets 210 were received.

In some embodiments, the image processor 218 may be configured to write the processed image frame 206 on to the memory 220.

An example of one or more fields included in the modified 1722 Ethernet header of corresponding packets 210 and subsequent operations performed using information included in the one or more fields may be illustrated and/or explained further with respect to Table 3:

TABLE 3

| | | | 1024 | | | |
|---|---|---|---|---|---|---|
| 1722 Payload | | | Bytes | | | |
| Packet | Frame | Sequence | Byte | Flags | | |
| Number | Number | Number | Offset | SOF | EOF | EOL |
| 1 | 0 | 0 | 0 | 1 | 0 | 0 |
| 2 | 0 | 1 | 1024 | 0 | 0 | 0 |
| 3 | 0 | 2 | 2048 | 0 | 0 | 1 |
| 4 | 0 | 3 | 3072 | 0 | 0 | 0 |
| 5 | 0 | 4 | 4096 | 0 | 0 | 0 |
| 6 | 0 | 5 | 5120 | 0 | 1 | 1 |
| 7 | 1 | 0 | 0 | 1 | 0 | 0 |
| 8 | 1 | 1 | 1024 | 0 | 0 | 0 |
| 9 | 1 | 2 | 2048 | 0 | 0 | 1 |
| 10 | 1 | 3 | 3072 | 0 | 0 | 0 |
| 11 | 1 | 4 | 4096 | 0 | 0 | 0 |
| 12 | 1 | 5 | 5120 | 0 | 1 | 1 |

Table 3 illustrates example values corresponding to the additional header fields included in the modified 1722 header 275 including example packet numbers, sequence numbers, frame numbers, byte offsets, and flag values corresponding to twelve (12) individual packets 210. In some embodiments, the receive system 212 corresponding to the environment 200 may perform one or more operations corresponding to the information included in the modified header. With example values included in Table 3, one or more example operations may be performed using the receive system 212, the receive hardware 214, the packet processor 216, and/or the image processor 218. More specifically, Table 3 indicates a sequence of operations where two (2) full image frames 206 are sent using one or more Ethernet protocols. Each packet 210 in the example includes a 1024B payload and each image frame 206 includes six (6) Ethernet packets 210 and two (2) subframes. The operations performed on the packets 210 and/or data included in the packets 210 includes the following.

Packet number one (1) displayed in the third line of Table 3 is the first packet 210 of a first image frame 206—indicated in the second column as frame number “0.” In response to the first packet 210 of an image frame 206, the sequence number assigned to the first packet 210 is “0.” Further, because this is the first packet 210 in the image frame 206, the flags field corresponding to the start of the frame (SOF) may be populated with a value indicating that the first packet 210 includes a first segment of the image frame 206. In this instance, the value corresponding to the SOF field is “1.”

In some embodiments, image memory may be reserved, for example, in memory 220 for image data included in the image frames 206 that may be transferred to the receive system 212. For example, the receive system 212 may reserve about eight (8) kB of data to store the information corresponding to the packets 210 in each of the image frame 206. In some embodiments, the reserved space may include one or more discrete memory locations; for example, two (2) four (4) kB locations in memory 220 may be reserved for one image frame 206. Additionally or alternatively, one contiguous eight (8) kB location in memory 220 may be reserved for image data included in a particular image frame 206.

In some embodiments, the receive system 212, the receive hardware 214, the packet processor 216, and/or the image processor 218 may be configured to write the segments included in corresponding packets 210 onto the memory 220 using the base address and corresponding byte offset. For example, the first packet 210 may include a first byte offset of zero “0” indicating that the memory address corresponding to the segment included in the payload of the first packet 210 is the base memory address.

The second packet 210 is the second packet 210 in a line. Like the first packet 210, the second packet 210 includes a frame number of zero (0). Further, the second packet 210 includes a sequence number one (1) and a byte offset indicating that the segment corresponding to the second packet 210 is to be written onto a storage location in memory 220 beginning at a byte offset of 1024B away from the base address. The second packet 210 may include values indicating that the segment corresponding to the second packet 210 is not the start of the image frame 206, the end of the image frame 206, and/or the end of the line.

The third packet 210 is included in the same image frame 206 as the first packet 210 and the second packet 210—indicated using frame number “0.” Additionally, the sequence number is sequentially increased to two (2) based on the sequence number corresponding to the segment included in the second packet 210. Further, the byte offset corresponding to the segment in the third packet 210 may indicate that the segment corresponding to the third packet 210 is to be written onto a storage location in memory 220 beginning at a byte offset of 2048B away from the base address. The third packet 210 is not the start or the end of the image frame 206 and therefore includes values of zero. The third packet 210 includes a segment that includes image data corresponding to the end of a line in the image frame 206. The end of the line indicated using a value of one (1) in the flag field 270.

In some embodiments, the indication that the third packet includes image data corresponding to the end of a line may also indicate the end of a subframe. In that instance, the receive hardware 214 may send the packet information to the packet processor 216. The packet processor 216 may further indicate to the image processor 218 that one or more processing operations may be performed on the image frame 206 corresponding to the segments included in the first three packets.

Remaining packets 210, four through twelve include respective packet numbers, frame numbers, sequence numbers, byte offsets, start of frames, end of frames, and ends of lines. In some embodiments, the receive system 212, the receive hardware 214, the packet processor 216, and/or the image processor 218 may perform one or more operations on the one or more image frames 206 based on information corresponding to fields in associated headers, like the information included in Table 3.

Modifications, additions, or omissions may be made to FIG. 2A without departing from the scope of the present disclosure. For example, the number of camera sensors 204, the amount of image data included in an image frame 206, the number of image frames 206, the number of transmit systems 202, packet modules 208, packets 210, receive systems 212, receive hardware 214, packet processor 216, image processors 218, and/or memory 220 may vary. Further, operations performed using the packet module 208, the transmit system 202, the receive system 212, the receive hardware 214, the packet processor 216, and/or the image processor 218 are meant to be illustrative. The operations may be performed using one or more other systems, modules, devices, hardware, software, etc. The specifics given and discussed are to help provide explanation and understanding of concepts of the present disclosure and are not meant to be limiting.

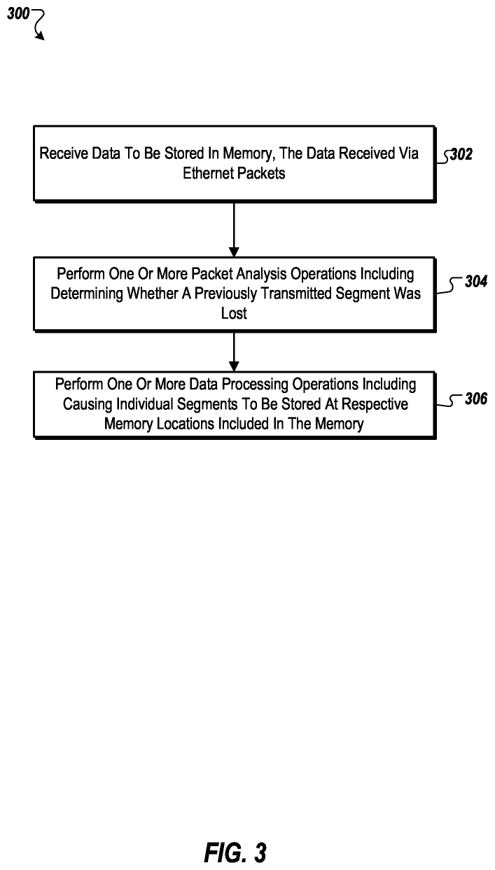

FIG. 3 is a flow diagram showing a method for processing data transferred via Ethernet, in accordance with one or more embodiments of the present disclosure. The method 300 may include one or more blocks 302, 304, and 306. Although illustrated with discrete blocks, the operations associated with one or more of the blocks of the method 300 may be divided into additional blocks, combined into fewer blocks, or eliminated, depending on the particular implementation.

In some embodiments, the method 300 may include block 302. At block 302, data may be received via Ethernet packets that may be stored in memory. In some embodiments, the data that was received may be divided into one or more segments that may be sequentially ordered according to a sequence. In some embodiments, the one or more individual Ethernet packets may include a payload and a header.

In some embodiments, the payload may include a respective segment of the one or more segments corresponding to the received data. Additionally or alternatively, the header may include a sequence number field and a byte offset field. In some embodiments, the sequence number field may indicate a respective sequence umber within the sequence that may correspond to a respective segment. The byte offset field may indicate a respective byte offset that may be applied to the segment. One or more example headers corresponding to the received data may be illustrated and/or described further in the present disclosure, such as, for example, with respect to FIGS. 1B, 1C, and 2B.

At block 304, one or more packet analysis operations may be performed, where the packet analysis operations may include determining whether a previously transmitted segment was lost. In some embodiments, the previously transmitted segment may be determined to be lost based at least on a first sequence number corresponding to the first segment and based at least on a second sequence number corresponding to a second segment that may be received prior to the first segment. In these or other embodiments, the packet analysis operations may be performed using one or more systems described and/or illustrated further in the present disclosure, such as, for example, with respect to the receive system 110, the receive hardware 112, and/or the processing system 114 in FIG. 1A.

At block 306, one or more data processing operations may be performed with respect to the one or more Ethernet packets. The one or more data processing operations may include causing individual segments to be stored at respective memory locations included in the memory based at least on the respective byte offsets included in the one or more Ethernet packets. In these or other embodiments, the one or more packets may be stored in memory 116 based on one or more operations performed using the receive system 110, the receive hardware 112, and/or the processing system 114 described and/or illustrated further in the present disclosure, such as, for example with respect to FIG. 1A.

Modifications, additions, or omissions may be made to the method 300 and/or one or more operations included in the method 300 without departing from the scope of the present disclosure. For example, the operations corresponding to the method 300 may be implemented in differing order. Additionally or alternatively, two or more operations may be performed at the same time. Furthermore, the outlined operations and actions are only provided as examples, and some of the operations and actions may be optional, combined into fewer operations and actions, or expanded into additional operations and actions without detracting from the essence of the described embodiments.

### Example Autonomous Vehicle

FIG. 4A is an illustration of an example autonomous vehicle 400, in accordance with some embodiments of the present disclosure. The autonomous vehicle 400 (alternatively referred to herein as the “vehicle 400”) may include, without limitation, a passenger vehicle, such as a car, a truck, a bus, a first responder vehicle, a shuttle, an electric or motorized bicycle, a motorcycle, a fire truck, a police vehicle, an ambulance, a boat, a construction vehicle, an underwater craft, a drone, and/or another type of vehicle (e.g., that is unmanned and/or that accommodates one or more passengers). Autonomous vehicles are generally described in terms of automation levels, defined by the National Highway Traffic Safety Administration (NHTSA), a division of the US Department of Transportation, and the Society of Automotive Engineers (SAE) “Taxonomy and Definitions for Terms Related to Driving Automation Systems for On-Road Motor Vehicles” (Standard No. J3016-201806, published on Jun. 15, 2018, Standard No. J3016-201609, published on Sep. 30, 2016, and previous and future versions of this standard). The vehicle 400 may be capable of functionality in accordance with one or more of Level 3-Level 5 of the autonomous driving levels. The vehicle 400 may be capable of functionality in accordance with one or more of Level 1-Level 5 of the autonomous driving levels. For example, the vehicle 400 may be capable of driver assistance (Level 1), partial automation (Level 2), conditional automation (Level 3), high automation (Level 4), and/or full automation (Level 5), depending on the embodiment. The term “autonomous,” as used herein, may include any and/or all types of autonomy for the vehicle 400 or other machine, such as being fully autonomous, being highly autonomous, being conditionally autonomous, being partially autonomous, providing assistive autonomy, being semi-autonomous, being primarily autonomous, or other designation.

The vehicle 400 may include components such as a chassis, a vehicle body, wheels (e.g., 2, 4, 6, 8, 18, etc.), tires, axles, and other components of a vehicle. The vehicle 400 may include a propulsion system 450, such as an internal combustion engine, hybrid electric power plant, an all-electric engine, and/or another propulsion system type. The propulsion system 450 may be connected to a drive train of the vehicle 400, which may include a transmission, to enable the propulsion of the vehicle 400. The propulsion system 450 may be controlled in response to receiving signals from the throttle/accelerator 452.

A steering system 454, which may include a steering wheel, may be used to steer the vehicle 400 (e.g., along a desired path or route) when the propulsion system 450 is operating (e.g., when the vehicle is in motion). The steering system 454 may receive signals from a steering actuator 456. The steering wheel may be optional for full automation (Level 5) functionality.

The brake sensor system 446 may be used to operate the vehicle brakes in response to receiving signals from the brake actuators 448 and/or brake sensors.

Controller(s) 436, which may include one or more CPU(s), system on chips (SoCs) 404 (FIG. 4C) and/or GPU(s), may provide signals (e.g., representative of commands) to one or more components and/or systems of the vehicle 400. For example, the controller(s) may send signals to operate the vehicle brakes via one or more brake actuators 448, to operate the steering system 454 via one or more steering actuators 456, and/or to operate the propulsion system 450 via one or more throttle/accelerators 452. The controller(s) 436 may include one or more onboard (e.g., integrated) computing devices (e.g., supercomputers) that process sensor signals, and output operation commands (e.g., signals representing commands) to enable autonomous driving and/or to assist a human driver in driving the vehicle 400. The controller(s) 436 may include a first controller 436 for autonomous driving functions, a second controller 436 for functional safety functions, a third controller 436 for artificial intelligence functionality (e.g., computer vision), a fourth controller 436 for infotainment functionality, a fifth controller 436 for redundancy in emergency conditions, and/or other controllers. In some examples, a single controller 436 may handle two or more of the above functionalities, two or more controllers 436 may handle a single functionality, and/or any combination thereof.

The controller(s) 436 may provide the signals for controlling one or more components and/or systems of the vehicle 400 in response to sensor data received from one or more sensors (e.g., sensor inputs). The sensor data may be received from, for example and without limitation, global navigation satellite systems sensor(s) 458 (e.g., Global Positioning System sensor(s)), RADAR sensor(s) 460, ultrasonic sensor(s) 462, LIDAR sensor(s) 464, inertial measurement unit (IMU) sensor(s) 466 (e.g., accelerometer(s), gyroscope(s), magnetic compass(es), magnetometer(s), etc.), microphone(s) 496, stereo camera(s) 468, wide-view camera(s) 470 (e.g., fisheye cameras), infrared camera(s) 472, surround camera(s) 474 (e.g., 360 degree cameras), long-range and/or mid-range camera(s) 498, speed sensor(s) 444 (e.g., for measuring the speed of the vehicle 400), vibration sensor(s) 442, steering sensor(s) 440, brake sensor(s) 446 (e.g., as part of the brake sensor system 446), and/or other sensor types.

One or more of the controller(s) 436 may receive inputs (e.g., represented by input data) from an instrument cluster 432 of the vehicle 400 and provide outputs (e.g., represented by output data, display data, etc.) via a human-machine interface (HMI) display 434, an audible annunciator, a loudspeaker, and/or via other components of the vehicle 400. The outputs may include information such as vehicle velocity, speed, time, map data (e.g., the HD map 422 of FIG. 4C), location data (e.g., the location of the vehicle 400, such as on a map), direction, location of other vehicles (e.g., an occupancy grid), information about objects and status of objects as perceived by the controller(s) 436, etc. For example, the HMI display 434 may display information about the presence of one or more objects (e.g., a street sign, caution sign, traffic light changing, etc.), and/or information about driving maneuvers the vehicle has made, is making, or will make (e.g., changing lanes now, taking exit 34B in two miles, etc.).

The vehicle 400 further includes a network interface 424, which may use one or more wireless antenna(s) 426 and/or modem(s) to communicate over one or more networks. For example, the network interface 424 may be capable of communication over LTE, WCDMA, UMTS, GSM, CDMA2000, etc. The wireless antenna(s) 426 may also enable communication between objects in the environment (e.g., vehicles, mobile devices, etc.), using local area network(s), such as Bluetooth, Bluetooth LE, Z-Wave, ZigBee, etc., and/or low power wide-area network(s) (LPWANs), such as LoRaWAN, SigFox, etc.

FIG. 4B is an example of camera locations and fields of view for the example autonomous vehicle 400 of FIG. 4A, in accordance with some embodiments of the present disclosure. The cameras and respective fields of view are one example embodiment and are not intended to be limiting. For example, additional and/or alternative cameras may be included and/or the cameras may be located at different locations on the vehicle 400.

The camera types for the cameras may include, but are not limited to, digital cameras that may be adapted for use with the components and/or systems of the vehicle 400. The camera(s) may operate at automotive safety integrity level (ASIL) B and/or at another ASIL. The camera types may be capable of any image capture rate, such as 60 frames per second (fps), 120 fps, 240 fps, etc., depending on the embodiment. The cameras may be capable of using rolling shutters, global shutters, another type of shutter, or a combination thereof. In some examples, the color filter array may include a red clear clear clear (RCCC) color filter array, a red clear clear blue (RCCB) color filter array, a red blue green clear (RBGC) color filter array, a red green blue infra-red (RGB-IR) color filter array, a Foveon X3 color filter array, a Bayer sensors (RGGB) color filter array, a monochrome sensor color filter array, and/or another type of color filter array. In some embodiments, clear pixel cameras, such as cameras with an RCCC, an RCCB, and/or an RBGC color filter array, may be used in an effort to increase light sensitivity.

In some examples, one or more of the camera(s) may be used to perform advanced driver assistance systems (ADAS) functions (e.g., as part of a redundant or fail-safe design). For example, a Multi-Function Mono Camera may be installed to provide functions including lane departure warning, traffic sign assist and intelligent headlamp control. One or more of the camera(s) (e.g., all of the cameras) may record and provide image data (e.g., video) simultaneously.

One or more of the cameras may be mounted in a mounting assembly, such as a custom-designed (3-D printed) assembly, in order to cut out stray light and reflections from within the car (e.g., reflections from the dashboard reflected in the windshield mirrors) which may interfere with the camera's image data capture abilities. With reference to wing-mirror mounting assemblies, the wing-mirror assemblies may be custom 3-D printed so that the camera mounting plate matches the shape of the wing-mirror. In some examples, the camera(s) may be integrated into the wing-mirror. For side-view cameras, the camera(s) may also be integrated within the four pillars at each corner of the cabin.

Cameras with a field of view that include portions of the environment in front of the vehicle 400 (e.g., front-facing cameras) may be used for surround view, to help identify forward-facing paths and obstacles, as well aid in, with the help of one or more controllers 436 and/or control SoCs, providing information critical to generating an occupancy grid and/or determining the preferred vehicle paths. Front-facing cameras may be used to perform many of the same ADAS functions as LIDAR, including emergency braking, pedestrian detection, and collision avoidance. Front-facing cameras may also be used for ADAS functions and systems including Lane Departure Warnings (LDW), Autonomous Cruise Control (ACC), and/or other functions such as traffic sign recognition.

A variety of cameras may be used in a front-facing configuration, including, for example, a monocular camera platform that includes a CMOS (complementary metal oxide semiconductor) color imager. Another example may be a wide-view camera(s) 470 that may be used to perceive objects coming into view from the periphery (e.g., pedestrians, crossing traffic or bicycles). Although only one wide-view camera is illustrated in FIG. 4B, there may any number of wide-view cameras 470 on the vehicle 400. In addition, long-range camera(s) 498 (e.g., a long-view stereo camera pair) may be used for depth-based object detection, especially for objects for which a neural network has not yet been trained. The long-range camera(s) 498 may also be used for object detection and classification, as well as basic object tracking.

One or more stereo cameras 468 may also be included in a front-facing configuration. The stereo camera(s) 468 may include an integrated control unit comprising a scalable processing unit, which may provide a programmable logic (FPGA) and a multi-core micro-processor with an integrated CAN or Ethernet interface on a single chip. Such a unit may be used to generate a 3-D map of the vehicle's environment, including a distance estimate for all the points in the image. An alternative stereo camera(s) 468 may include a compact stereo vision sensor(s) that may include two camera lenses (one each on the left and right) and an image processing chip that may measure the distance from the vehicle to the target object and use the generated information (e.g., metadata) to activate the autonomous emergency braking and lane departure warning functions. Other types of stereo camera(s) 468 may be used in addition to, or alternatively from, those described herein.

Cameras with a field of view that include portions of the environment to the side of the vehicle 400 (e.g., side-view cameras) may be used for surround view, providing information used to create and update the occupancy grid, as well as to generate side impact collision warnings. For example, surround camera(s) 474 (e.g., four surround cameras 474 as illustrated in FIG. 4B) may be positioned to on the vehicle 400. The surround camera(s) 474 may include wide-view camera(s) 470, fisheye camera(s), 360-degree camera(s), and/or the like. For example, four fisheye cameras may be positioned on the vehicle's front, rear, and sides. In an alternative arrangement, the vehicle may use three surround camera(s) 474 (e.g., left, right, and rear), and may leverage one or more other camera(s) (e.g., a forward-facing camera) as a fourth surround-view camera.

Cameras with a field of view that include portions of the environment to the rear of the vehicle 400 (e.g., rear-view cameras) may be used for park assistance, surround view, rear collision warnings, and creating and updating the occupancy grid. A wide variety of cameras may be used including, but not limited to, cameras that are also suitable as a front-facing camera(s) (e.g., long-range and/or mid-range camera(s) 498, stereo camera(s) 468), infrared camera(s) 472, etc.), as described herein.

FIG. 4C is a block diagram of an example system architecture for the example autonomous vehicle 400 of FIG. 4A, in accordance with some embodiments of the present disclosure. It should be understood that this and other arrangements described herein are set forth only as examples. Other arrangements and elements (e.g., machines, interfaces, functions, orders, groupings of functions, etc.) may be used in addition to or instead of those shown, and some elements may be omitted altogether. Further, many of the elements described herein are functional entities that may be implemented as discrete or distributed components or in conjunction with other components, and in any suitable combination and location. Various functions described herein as being performed by entities may be carried out by hardware, firmware, and/or software. For instance, various functions may be carried out by a processor executing instructions stored in memory.

Each of the components, features, and systems of the vehicle 400 in FIG. 4C is illustrated as being connected via bus 402. The bus 402 may include a Controller Area Network (CAN) data interface (alternatively referred to herein as a “CAN bus”). A CAN may be a network inside the vehicle 400 used to aid in control of various features and functionality of the vehicle 400, such as actuation of brakes, acceleration, braking, steering, windshield wipers, etc. A CAN bus may be configured to have dozens or even hundreds of nodes, each with its own unique identifier (e.g., a CAN ID). The CAN bus may be read to find steering wheel angle, ground speed, engine revolutions per minute (RPMs), button positions, and/or other vehicle status indicators. The CAN bus may be ASIL B compliant.

Although the bus 402 is described herein as being a CAN bus, this is not intended to be limiting. For example, in addition to, or alternatively from, the CAN bus, FlexRay and/or Ethernet may be used. Additionally, although a single line is used to represent the bus 402, this is not intended to be limiting. For example, there may be any number of busses 402, which may include one or more CAN busses, one or more FlexRay busses, one or more Ethernet busses, and/or one or more other types of busses using a different protocol. In some examples, two or more busses 402 may be used to perform different functions, and/or may be used for redundancy. For example, a first bus 402 may be used for collision avoidance functionality and a second bus 402 may be used for actuation control. In any example, each bus 402 may communicate with any of the components of the vehicle 400, and two or more busses 402 may communicate with the same components. In some examples, each SoC 404, each controller 436, and/or each computer within the vehicle may have access to the same input data (e.g., inputs from sensors of the vehicle 400), and may be connected to a common bus, such the CAN bus.

The vehicle 400 may include one or more controller(s) 436, such as those described herein with respect to FIG. 4A. The controller(s) 436 may be used for a variety of functions. The controller(s) 436 may be coupled to any of the various other components and systems of the vehicle 400 and may be used for control of the vehicle 400, artificial intelligence of the vehicle 400, infotainment for the vehicle 400, and/or the like.

The vehicle 400 may include a system(s) on a chip (SoC) 404. The SoC 404 may include CPU(s) 406, GPU(s) 408, processor(s) 410, cache(s) 412, accelerator(s) 414, data store(s) 416, and/or other components and features not illustrated. The SoC(s) 404 may be used to control the vehicle 400 in a variety of platforms and systems. For example, the SoC(s) 404 may be combined in a system (e.g., the system of the vehicle 400) with an HD map 422 which may obtain map refreshes and/or updates via a network interface 424 from one or more servers (e.g., server(s) 478 of FIG. 4D).

The CPU(s) 406 may include a CPU cluster or CPU complex (alternatively referred to herein as a “CCPLEX”). The CPU(s) 406 may include multiple cores and/or L2 caches. For example, in some embodiments, the CPU(s) 406 may include eight cores in a coherent multi-processor configuration. In some embodiments, the CPU(s) 406 may include four dual-core clusters where each cluster has a dedicated L2 cache (e.g., a 2 MB L2 cache). The CPU(s) 406 (e.g., the CCPLEX) may be configured to support simultaneous cluster operation enabling any combination of the clusters of the CPU(s) 406 to be active at any given time.

The CPU(s) 406 may implement power management capabilities that include one or more of the following features: individual hardware blocks may be clock-gated automatically when idle to save dynamic power; each core clock may be gated when the core is not actively executing instructions due to execution of WFI/WFE instructions; each core may be independently power-gated; each core cluster may be independently clock-gated when all cores are clock-gated or power-gated; and/or each core cluster may be independently power-gated when all cores are power-gated. The CPU(s) 406 may further implement an enhanced algorithm for managing power states, where allowed power states and expected wakeup times are specified, and the hardware/microcode determines the best power state to enter for the core, cluster, and CCPLEX. The processing cores may support simplified power state entry sequences in software with the work offloaded to microcode.

The GPU(s) 408 may include an integrated GPU (alternatively referred to herein as an “iGPU”). The GPU(s) 408 may be programmable and may be efficient for parallel workloads. The GPU(s) 408, in some examples, may use an enhanced tensor instruction set. The GPU(s) 408 may include one or more streaming microprocessors, where each streaming microprocessor may include an L1 cache (e.g., an L1 cache with at least 96 KB storage capacity), and two or more of the streaming microprocessors may share an L2 cache (e.g., an L2 cache with a 512 KB storage capacity). In some embodiments, the GPU(s) 408 may include at least eight streaming microprocessors. The GPU(s) 408 may use compute application programming interface(s) (API(s)). In addition, the GPU(s) 408 may use one or more parallel computing platforms and/or programming models (e.g., NVIDIA's CUDA).

The GPU(s) 408 may be power-optimized for best performance in automotive and embedded use cases. For example, the GPU(s) 408 may be fabricated on a Fin field-effect transistor (FinFET). However, this is not intended to be limiting, and the GPU(s) 408 may be fabricated using other semiconductor manufacturing processes. Each streaming microprocessor may incorporate a number of mixed-precision processing cores partitioned into multiple blocks. For example, and without limitation, 64 PF32 cores and 32 PF64 cores may be partitioned into four processing blocks. In such an example, each processing block may be allocated 16 FP32 cores, 8 FP64 cores, 16 INT32 cores, two mixed-precision NVIDIA TENSOR COREs for deep learning matrix arithmetic, an L0 instruction cache, a warp scheduler, a dispatch unit, and/or a 64 KB register file. In addition, the streaming microprocessors may include independent parallel integer and floating-point data paths to provide for efficient execution of workloads with a mix of computation and addressing calculations. The streaming microprocessors may include independent thread-scheduling capability to enable finer-grain synchronization and cooperation between parallel threads. The streaming microprocessors may include a combined L1 data cache and shared memory unit in order to improve performance while simplifying programming.

The GPU(s) 408 may include a high bandwidth memory (HBM) and/or a 16 GB HBM2 memory subsystem to provide, in some examples, about 900 GB/second peak memory bandwidth. In some examples, in addition to, or alternatively from, the HBM memory, a synchronous graphics random-access memory (SGRAM) may be used, such as a graphics double data rate type five synchronous random-access memory (GDDR5).

The GPU(s) 408 may include unified memory technology including access counters to allow for more accurate migration of memory pages to the processor that accesses them most frequently, thereby improving efficiency for memory ranges shared between processors. In some examples, address translation services (ATS) support may be used to allow the GPU(s) 408 to access the CPU(s) 406 page tables directly. In such examples, when the GPU(s) 408 memory management unit (MMU) experiences a miss, an address translation request may be transmitted to the CPU(s) 406. In response, the CPU(s) 406 may look in its page tables for the virtual-to-physical mapping for the address and transmits the translation back to the GPU(s) 408. As such, unified memory technology may allow a single unified virtual address space for memory of both the CPU(s) 406 and the GPU(s) 408, thereby simplifying the GPU(s) 408 programming and porting of applications to the GPU(s) 408.

In addition, the GPU(s) 408 may include an access counter that may keep track of the frequency of access of the GPU(s) 408 to memory of other processors. The access counter may help ensure that memory pages are moved to the physical memory of the processor that is accessing the pages most frequently.

The SoC(s) 404 may include any number of cache(s) 412, including those described herein. For example, the cache(s) 412 may include an L3 cache that is available to both the CPU(s) 406 and the GPU(s) 408 (e.g., that is connected to both the CPU(s) 406 and the GPU(s) 408). The cache(s) 412 may include a write-back cache that may keep track of states of lines, such as by using a cache coherence protocol (e.g., MEI, MESI, MSI, etc.). The L3 cache may include 4 MB or more, depending on the embodiment, although smaller cache sizes may be used.

The SoC(s) 404 may include an arithmetic logic unit(s) (ALU(s)) which may be leveraged in performing processing with respect to any of the variety of tasks or operations of the vehicle 400—such as processing DNNs. In addition, the SoC(s) 404 may include a floating point unit(s) (FPU(s))—or other math coprocessor or numeric coprocessor types—for performing mathematical operations within the system. For example, the SoC(s) 104 may include one or more FPUs integrated as execution units within a CPU(s) 406 and/or GPU(s) 408.

The SoC(s) 404 may include one or more accelerators 414 (e.g., hardware accelerators, software accelerators, or a combination thereof). For example, the SoC(s) 404 may include a hardware acceleration cluster that may include optimized hardware accelerators and/or large on-chip memory. The large on-chip memory (e.g., 4 MB of SRAM), may enable the hardware acceleration cluster to accelerate neural networks and other calculations. The hardware acceleration cluster may be used to complement the GPU(s) 408 and to off-load some of the tasks of the GPU(s) 408 (e.g., to free up more cycles of the GPU(s) 408 for performing other tasks). As an example, the accelerator(s) 414 may be used for targeted workloads (e.g., perception, convolutional neural networks (CNNs), etc.) that are stable enough to be amenable to acceleration. The term “CNN,” as used herein, may include all types of CNNs, including region-based or regional convolutional neural networks (RCNNs) and Fast RCNNs (e.g., as used for object detection).

The accelerator(s) 414 (e.g., the hardware acceleration cluster) may include a deep learning accelerator(s) (DLA). The DLA(s) may include one or more Tensor processing units (TPUs) that may be configured to provide an additional ten trillion operations per second for deep learning applications and inferencing. The TPUs may be accelerators configured to, and optimized for, performing image processing functions (e.g., for CNNs, RCNNs, etc.). The DLA(s) may further be optimized for a specific set of neural network types and floating point operations, as well as inferencing. The design of the DLA(s) may provide more performance per millimeter than a general-purpose GPU, and vastly exceeds the performance of a CPU. The TPU(s) may perform several functions, including a single-instance convolution function, supporting, for example, INT8, INT16, and FP16 data types for both features and weights, as well as post-processor functions.

The DLA(s) may quickly and efficiently execute neural networks, especially CNNs, on processed or unprocessed data for any of a variety of functions, including, for example and without limitation: a CNN for object identification and detection using data from camera sensors; a CNN for distance estimation using data from camera sensors; a CNN for emergency vehicle detection and identification and detection using data from microphones; a CNN for facial recognition and vehicle owner identification using data from camera sensors; and/or a CNN for security and/or safety related events.

The DLA(s) may perform any function of the GPU(s) 408, and by using an inference accelerator, for example, a designer may target either the DLA(s) or the GPU(s) 408 for any function. For example, the designer may focus processing of CNNs and floating point operations on the DLA(s) and leave other functions to the GPU(s) 408 and/or other accelerator(s) 414.

The accelerator(s) 414 (e.g., the hardware acceleration cluster) may include a programmable vision accelerator(s) (PVA), which may alternatively be referred to herein as a computer vision accelerator. The PVA(s) may be designed and configured to accelerate computer vision algorithms for the advanced driver assistance systems (ADAS), autonomous driving, and/or augmented reality (AR) and/or virtual reality (VR) applications. The PVA(s) may provide a balance between performance and flexibility. For example, each PVA(s) may include, for example and without limitation, any number of reduced instruction set computer (RISC) cores, direct memory access (DMA), and/or any number of vector processors.

The RISC cores may interact with image sensors (e.g., the image sensors of any of the cameras described herein), image signal processor(s), and/or the like. Each of the RISC cores may include any amount of memory. The RISC cores may use any of a number of protocols, depending on the embodiment. In some examples, the RISC cores may execute a real-time operating system (RTOS). The RISC cores may be implemented using one or more integrated circuit devices, application specific integrated circuits (ASICs), and/or memory devices. For example, the RISC cores may include an instruction cache and/or a tightly coupled RAM.

The DMA may enable components of the PVA(s) to access the system memory independently of the CPU(s) 406. The DMA may support any number of features used to provide optimization to the PVA including, but not limited to, supporting multi-dimensional addressing and/or circular addressing. In some examples, the DMA may support up to six or more dimensions of addressing, which may include block width, block height, block depth, horizontal block stepping, vertical block stepping, and/or depth stepping.

The vector processors may be programmable processors that may be designed to efficiently and flexibly execute programming for computer vision algorithms and provide signal processing capabilities. In some examples, the PVA may include a PVA core and two vector processing subsystem partitions. The PVA core may include a processor subsystem, DMA engine(s) (e.g., two DMA engines), and/or other peripherals. The vector processing subsystem may operate as the primary processing engine of the PVA, and may include a vector processing unit (VPU), an instruction cache, and/or vector memory (e.g., VMEM). A VPU core may include a digital signal processor such as, for example, a single instruction, multiple data (SIMD), very long instruction word (VLIW) digital signal processor. The combination of the SIMD and VLIW may enhance throughput and speed.

Each of the vector processors may include an instruction cache and may be coupled to dedicated memory. As a result, in some examples, each of the vector processors may be configured to execute independently of the other vector processors. In other examples, the vector processors that are included in a particular PVA may be configured to employ data parallelism. For example, in some embodiments, the plurality of vector processors included in a single PVA may execute the same computer vision algorithm, but on different regions of an image. In other examples, the vector processors included in a particular PVA may simultaneously execute different computer vision algorithms, on the same image, or even execute different algorithms on sequential images or portions of an image. Among other things, any number of PVAs may be included in the hardware acceleration cluster and any number of vector processors may be included in each of the PVAs. In addition, the PVA(s) may include additional error correcting code (ECC) memory, to enhance overall system safety.

The accelerator(s) 414 (e.g., the hardware acceleration cluster) may include a computer vision network on-chip and SRAM, for providing a high-bandwidth, low latency SRAM for the accelerator(s) 414. In some examples, the on-chip memory may include at least 4 MB SRAM, consisting of, for example and without limitation, eight field-configurable memory blocks, that may be accessible by both the PVA and the DLA. Each pair of memory blocks may include an advanced peripheral bus (APB) interface, configuration circuitry, a controller, and a multiplexer. Any type of memory may be used. The PVA and DLA may access the memory via a backbone that provides the PVA and DLA with high-speed access to memory. The backbone may include a computer vision network on-chip that interconnects the PVA and the DLA to the memory (e.g., using the APB).

The computer vision network on-chip may include an interface that determines, before transmission of any control signal/address/data, that both the PVA and the DLA provide ready and valid signals. Such an interface may provide for separate phases and separate channels for transmitting control signals/addresses/data, as well as burst-type communications for continuous data transfer. This type of interface may comply with ISO 26262 or IEC 61508 standards, although other standards and protocols may be used.

In some examples, the SoC(s) 404 may include a real-time ray-tracing hardware accelerator, such as described in U.S. patent application Ser. No. 16/101,232, filed on Aug. 10, 2018. The real-time ray-tracing hardware accelerator may be used to quickly and efficiently determine the positions and extents of objects (e.g., within a world model), to generate real-time visualization simulations, for RADAR signal interpretation, for sound propagation synthesis and/or analysis, for simulation of SONAR systems, for general wave propagation simulation, for comparison to LIDAR data for purposes of localization and/or other functions, and/or for other uses. In some embodiments, one or more tree traversal units (TTUs) may be used for executing one or more ray-tracing related operations.

The accelerator(s) 414 (e.g., the hardware accelerator cluster) have a wide array of uses for autonomous driving. The PVA may be a programmable vision accelerator that may be used for key processing stages in ADAS and autonomous vehicles. The PVA's capabilities are a good match for algorithmic domains needing predictable processing, at low power and low latency. In other words, the PVA performs well on semi-dense or dense regular computation, even on small data sets, which need predictable run-times with low latency and low power. Thus, in the context of platforms for autonomous vehicles, the PVAs are designed to run classic computer vision algorithms, as they are efficient at object detection and operating on integer math.

For example, according to one embodiment of the technology, the PVA is used to perform computer stereo vision. A semi-global matching-based algorithm may be used in some examples, although this is not intended to be limiting. Many applications for Level 3-5 autonomous driving require motion estimation/stereo matching on-the-fly (e.g., structure from motion, pedestrian recognition, lane detection, etc.). The PVA may perform computer stereo vision function on inputs from two monocular cameras.

In some examples, the PVA may be used to perform dense optical flow. According to process raw RADAR data (e.g., using a 4D Fast Fourier Transform) to processed RADAR. In other examples, the PVA is used for time of flight depth processing, by processing raw time of flight data to provide processed time of flight data, for example.

The DLA may be used to run any type of network to enhance control and driving safety, including, for example, a neural network that outputs a measure of confidence for each object detection. Such a confidence value may be interpreted as a probability, or as providing a relative “weight” of each detection compared to other detections. This confidence value enables the system to make further decisions regarding which detections should be considered as true positive detections rather than false positive detections. For example, the system may set a threshold value for the confidence and consider only the detections exceeding the threshold value as true positive detections. In an automatic emergency braking (AEB) system, false positive detections would cause the vehicle to automatically perform emergency braking, which is obviously undesirable. Therefore, only the most confident detections should be considered as triggers for AEB. The DLA may run a neural network for regressing the confidence value. The neural network may take as its input at least some subset of parameters, such as bounding box dimensions, ground plane estimate obtained (e.g. from another subsystem), inertial measurement unit (IMU) sensor 466 output that correlates with the vehicle 400 orientation, distance, 3D location estimates of the object obtained from the neural network and/or other sensors (e.g., LIDAR sensor(s) 464 or RADAR sensor(s) 460), among others.

The SoC(s) 404 may include data store(s) 416 (e.g., memory). The data store(s) 416 may be on-chip memory of the SoC(s) 404, which may store neural networks to be executed on the GPU and/or the DLA. In some examples, the data store(s) 416 may be large enough in capacity to store multiple instances of neural networks for redundancy and safety. The data store(s) 416 may comprise L2 or L3 cache(s) 412. Reference to the data store(s) 416 may include reference to the memory associated with the PVA, DLA, and/or other accelerator(s) 414, as described herein.

The SoC(s) 404 may include one or more processor(s) 410 (e.g., embedded processors). The processor(s) 410 may include a boot and power management processor that may be a dedicated processor and subsystem to handle boot power and management functions and related security enforcement. The boot and power management processor may be a part of the SoC(s) 404 boot sequence and may provide runtime power management services. The boot power and management processor may provide clock and voltage programming, assistance in system low power state transitions, management of SoC(s) 404 thermals and temperature sensors, and/or management of the SoC(s) 404 power states. Each temperature sensor may be implemented as a ring-oscillator whose output frequency is proportional to temperature, and the SoC(s) 404 may use the ring-oscillators to detect temperatures of the CPU(s) 406, GPU(s) 408, and/or accelerator(s) 414. If temperatures are determined to exceed a threshold, the boot and power management processor may enter a temperature fault routine and put the SoC(s) 404 into a lower power state and/or put the vehicle 400 into a chauffeur to safe-stop mode (e.g., bring the vehicle 400 to a safe stop).

The processor(s) 410 may further include a set of embedded processors that may serve as an audio processing engine. The audio processing engine may be an audio subsystem that enables full hardware support for multi-channel audio over multiple interfaces, and a broad and flexible range of audio I/O interfaces. In some examples, the audio processing engine is a dedicated processor core with a digital signal processor with dedicated RAM.

The processor(s) 410 may further include an always-on processor engine that may provide necessary hardware features to support low power sensor management and wake use cases. The always-on processor engine may include a processor core, a tightly coupled RAM, supporting peripherals (e.g., timers and interrupt controllers), various I/O controller peripherals, and routing logic.

The processor(s) 410 may further include a safety cluster engine that includes a dedicated processor subsystem to handle safety management for automotive applications. The safety cluster engine may include two or more processor cores, a tightly coupled RAM, support peripherals (e.g., timers, an interrupt controller, etc.), and/or routing logic. In a safety mode, the two or more cores may operate in a lockstep mode and function as a single core with comparison logic to detect any differences between their operations.

The processor(s) 410 may further include a real-time camera engine that may include a dedicated processor subsystem for handling real-time camera management.

The processor(s) 410 may further include a high dynamic range signal processor that may include an image signal processor that is a hardware engine that is part of the camera processing pipeline.

The processor(s) 410 may include a video image compositor that may be a processing block (e.g., implemented on a microprocessor) that implements video post-processing functions needed by a video playback application to produce the final image for the player window. The video image compositor may perform lens distortion correction on wide-view camera(s) 470, surround camera(s) 474, and/or on in-cabin monitoring camera sensors. An in-cabin monitoring camera sensor is preferably monitored by a neural network running on another instance of the Advanced SoC, configured to identify in-cabin events and respond accordingly. In-cabin system may perform lip reading to activate cellular service and place a phone call, dictate emails, change the vehicle's destination, activate or change the vehicle's infotainment system and settings, or provide voice-activated web surfing. Certain functions are available to the driver only when the vehicle is operating in an autonomous mode, and are disabled otherwise.

The video image compositor may include enhanced temporal noise reduction for both spatial and temporal noise reduction. For example, where motion occurs in a video, the noise reduction weights spatial information appropriately, decreasing the weight of information provided by adjacent frames. Where an image or portion of an image does not include motion, the temporal noise reduction performed by the video image compositor may use information from the previous image to reduce noise in the current image.

The video image compositor may also be configured to perform stereo rectification on input stereo lens frames. The video image compositor may further be used for user interface composition when the operating system desktop is in use, and the GPU(s) 408 is not required to continuously render new surfaces. Even when the GPU(s) 408 is powered on and active doing 3D rendering, the video image compositor may be used to offload the GPU(s) 408 to improve performance and responsiveness.

The SoC(s) 404 may further include a mobile industry processor interface (MIPI) camera serial interface for receiving video and input from cameras, a high-speed interface, and/or a video input block that may be used for camera and related pixel input functions. The SoC(s) 404 may further include an input/output controller(s) that may be controlled by software and may be used for receiving I/O signals that are uncommitted to a specific role.

The SoC(s) 404 may further include a broad range of peripheral interfaces to enable communication with peripherals, audio codecs, power management, and/or other devices. The SoC(s) 404 may be used to process data from cameras (e.g., connected over Gigabit Multimedia Serial Link and Ethernet), sensors (e.g., LIDAR sensor(s) 464, RADAR sensor(s) 460, etc. that may be connected over Ethernet), data from bus 402 (e.g., speed of vehicle 400, steering wheel position, etc.), data from GNSS sensor(s) 458 (e.g., connected over Ethernet or CAN bus). The SoC(s) 404 may further include dedicated high-performance mass storage controllers that may include their own DMA engines, and that may be used to free the CPU(s) 406 from routine data management tasks.

The SoC(s) 404 may be an end-to-end platform with a flexible architecture that spans automation levels 3-5, thereby providing a comprehensive functional safety architecture that leverages and makes efficient use of computer vision and ADAS techniques for diversity and redundancy, provides a platform for a flexible, reliable driving software stack, along with deep learning tools. The SoC(s) 404 may be faster, more reliable, and even more energy-efficient and space-efficient than conventional systems. For example, the accelerator(s) 414, when combined with the CPU(s) 406, the GPU(s) 408, and the data store(s) 416, may provide for a fast, efficient platform for level 3-5 autonomous vehicles.

The technology thus provides capabilities and functionality that cannot be achieved by conventional systems. For example, computer vision algorithms may be executed on CPUs, which may be configured using high-level programming language, such as the C programming language, to execute a wide variety of processing algorithms across a wide variety of visual data. However, CPUs are oftentimes unable to meet the performance requirements of many computer vision applications, such as those related to execution time and power consumption, for example. In particular, many CPUs are unable to execute complex object detection algorithms in real-time, which is a requirement of in-vehicle ADAS applications, and a requirement for practical Level 3-5 autonomous vehicles.

In contrast to conventional systems, by providing a CPU complex, GPU complex, and a hardware acceleration cluster, the technology described herein allows for multiple neural networks to be performed simultaneously and/or sequentially, and for the results to be combined together to enable Level 3-5 autonomous driving functionality. For example, a CNN executing on the DLA or dGPU (e.g., the GPU(s) 420) may include a text and word recognition, allowing the supercomputer to read and understand traffic signs, including signs for which the neural network has not been specifically trained. The DLA may further include a neural network that is able to identify, interpret, and provides semantic understanding of the sign, and to pass that semantic understanding to the path-planning modules running on the CPU Complex.

As another example, multiple neural networks may be run simultaneously, as is required for Level 3, 4, or 5 driving. For example, a warning sign consisting of “Caution: flashing lights indicate icy conditions,” along with an electric light, may be independently or collectively interpreted by several neural networks. The sign itself may be identified as a traffic sign by a first deployed neural network (e.g., a neural network that has been trained), the text “Flashing lights indicate icy conditions” may be interpreted by a second deployed neural network, which informs the vehicle's path-planning software (preferably executing on the CPU Complex) that when flashing lights are detected, icy conditions exist. The flashing light may be identified by operating a third deployed neural network over multiple frames, informing the vehicle's path-planning software of the presence (or absence) of flashing lights. All three neural networks may run simultaneously, such as within the DLA and/or on the GPU(s) 408.

In some examples, a CNN for facial recognition and vehicle owner identification may use data from camera sensors to identify the presence of an authorized driver and/or owner of the vehicle 400. The always-on sensor processing engine may be used to unlock the vehicle when the owner approaches the driver door and turn on the lights, and, in security mode, to disable the vehicle when the owner leaves the vehicle. In this way, the SoC(s) 404 provide for security against theft and/or carjacking.

In another example, a CNN for emergency vehicle detection and identification may use data from microphones 496 to detect and identify emergency vehicle sirens. In contrast to conventional systems, that use general classifiers to detect sirens and manually extract features, the SoC(s) 404 use the CNN for classifying environmental and urban sounds, as well as classifying visual data. In a preferred embodiment, the CNN running on the DLA is trained to identify the relative closing speed of the emergency vehicle (e.g., by using the Doppler Effect). The CNN may also be trained to identify emergency vehicles specific to the local area in which the vehicle is operating, as identified by GNSS sensor(s) 458. Thus, for example, when operating in Europe the CNN will seek to detect European sirens, and when in the United States the CNN will seek to identify only North American sirens. Once an emergency vehicle is detected, a control program may be used to execute an emergency vehicle safety routine, slowing the vehicle, pulling over to the side of the road, parking the vehicle, and/or idling the vehicle, with the assistance of ultrasonic sensors 462, until the emergency vehicle(s) passes.

The vehicle may include a CPU(s) 418 (e.g., discrete CPU(s), or dCPU(s)), that may be coupled to the SoC(s) 404 via a high-speed interconnect (e.g., PCIe). The CPU(s) 418 may include an X86 processor, for example. The CPU(s) 418 may be used to perform any of a variety of functions, including arbitrating potentially inconsistent results between ADAS sensors and the SoC(s) 404, and/or monitoring the status and health of the controller(s) 436 and/or infotainment SoC 430, for example.

The vehicle 400 may include a GPU(s) 420 (e.g., discrete GPU(s), or dGPU(s)), that may be coupled to the SoC(s) 404 via a high-speed interconnect (e.g., NVIDIA's NVLINK). The GPU(s) 420 may provide additional artificial intelligence functionality, such as by executing redundant and/or different neural networks, and may be used to train and/or update neural networks based on input (e.g., sensor data) from sensors of the vehicle 400.

The vehicle 400 may further include the network interface 424 which may include one or more wireless antennas 426 (e.g., one or more wireless antennas for different communication protocols, such as a cellular antenna, a Bluetooth antenna, etc.). The network interface 424 may be used to enable wireless connectivity over the Internet with the cloud (e.g., with the server(s) 478 and/or other network devices), with other vehicles, and/or with computing devices (e.g., client devices of passengers). To communicate with other vehicles, a direct link may be established between the two vehicles and/or an indirect link may be established (e.g., across networks and over the Internet). Direct links may be provided using a vehicle-to-vehicle communication link. The vehicle-to-vehicle communication link may provide the vehicle 400 information about vehicles in proximity to the vehicle 400 (e.g., vehicles in front of, on the side of, and/or behind the vehicle 400). This functionality may be part of a cooperative adaptive cruise control functionality of the vehicle 400.

The network interface 424 may include a SoC that provides modulation and demodulation functionality and enables the controller(s) 436 to communicate over wireless networks. The network interface 424 may include a radio frequency front-end for up-conversion from baseband to radio frequency, and down conversion from radio frequency to baseband. The frequency conversions may be performed through well-known processes, and/or may be performed using super-heterodyne processes. In some examples, the radio frequency front end functionality may be provided by a separate chip. The network interface may include wireless functionality for communicating over LTE, WCDMA, UMTS, GSM, CDMA2000, Bluetooth, Bluetooth LE, Wi-Fi, Z-Wave, ZigBee, LoRaWAN, and/or other wireless protocols.

The vehicle 400 may further include data store(s) 428, which may include off-chip (e.g., off the SoC(s) 404) storage. The data store(s) 428 may include one or more storage elements including RAM, SRAM, DRAM, VRAM, Flash, hard disks, and/or other components and/or devices that may store at least one bit of data.

The vehicle 400 may further include GNSS sensor(s) 458. The GNSS sensor(s) 458 (e.g., GPS, assisted GPS sensors, differential GPD (DGPS) sensors, etc.), to assist in mapping, perception, occupancy grid generation, and/or path planning functions. Any number of GNSS sensor(s) 458 may be used, including, for example and without limitation, a GPS using a USB connector with an Ethernet to Serial (RS-232) bridge.

The vehicle 400 may further include RADAR sensor(s) 460. The RADAR sensor(s) 460 may be used by the vehicle 400 for long-range vehicle detection, even in darkness and/or severe weather conditions. RADAR functional safety levels may be ASIL B. The RADAR sensor(s) 460 may use the CAN and/or the bus 402 (e.g., to transmit data generated by the RADAR sensor(s) 460) for control and to access object tracking data, with access to Ethernet to access raw data, in some examples. A wide variety of RADAR sensor types may be used. For example, and without limitation, the RADAR sensor(s) 460 may be suitable for front, rear, and side RADAR use. In some example, Pulse Doppler RADAR sensor(s) are used.

The RADAR sensor(s) 460 may include different configurations, such as long-range with narrow field of view, short-range with wide field of view, short-range side coverage, etc. In some examples, long-range RADAR may be used for adaptive cruise control functionality. The long-range RADAR systems may provide a broad field of view realized by two or more independent scans, such as within a 250 m range. The RADAR sensor(s) 460 may help in distinguishing between static and moving objects, and may be used by ADAS systems for emergency brake assist and forward collision warning. Long-range RADAR sensors may include monostatic multimodal RADAR with multiple (e.g., six or more) fixed RADAR antennae and a high-speed CAN and FlexRay interface. In an example with six antennae, the central four antennae may create a focused beam pattern, designed to record the vehicle's 400 surrounding at higher speeds with minimal interference from traffic in adjacent lanes. The other two antennae may expand the field of view, making it possible to quickly detect vehicles entering or leaving the vehicle's 400 lane.

Mid-range RADAR systems may include, as an example, a range of up to 160 m (front) or 80 m (rear), and a field of view of up to 42 degrees (front) or 150 degrees (rear). Short-range RADAR systems may include, without limitation, RADAR sensors designed to be installed at both ends of the rear bumper. When installed at both ends of the rear bumper, such a RADAR sensor systems may create two beams that constantly monitor the blind spot in the rear and next to the vehicle.

Short-range RADAR systems may be used in an ADAS system for blind spot detection and/or lane change assist.

The vehicle 400 may further include ultrasonic sensor(s) 462. The ultrasonic sensor(s) 462, which may be positioned at the front, back, and/or the sides of the vehicle 400, may be used for park assist and/or to create and update an occupancy grid. A wide variety of ultrasonic sensor(s) 462 may be used, and different ultrasonic sensor(s) 462 may be used for different ranges of detection (e.g., 2.5 m, 4 m). The ultrasonic sensor(s) 462 may operate at functional safety levels of ASIL B.

The vehicle 400 may include LIDAR sensor(s) 464. The LIDAR sensor(s) 464 may be used for object and pedestrian detection, emergency braking, collision avoidance, and/or other functions. The LIDAR sensor(s) 464 may be functional safety level ASIL B. In some examples, the vehicle 400 may include multiple LIDAR sensors 464 (e.g., two, four, six, etc.) that may use Ethernet (e.g., to provide data to a Gigabit Ethernet switch).

In some examples, the LIDAR sensor(s) 464 may be capable of providing a list of objects and their distances for a 360-degree field of view. Commercially available LIDAR sensor(s) 464 may have an advertised range of approximately 100 m, with an accuracy of 2 cm-3 cm, and with support for a 100 Mbps Ethernet connection, for example. In some examples, one or more non-protruding LIDAR sensors 464 may be used. In such examples, the LIDAR sensor(s) 464 may be implemented as a small device that may be embedded into the front, rear, sides, and/or corners of the vehicle 400. The LIDAR sensor(s) 464, in such examples, may provide up to a 120-degree horizontal and 35-degree vertical field-of-view, with a 200 m range even for low-reflectivity objects. Front-mounted LIDAR sensor(s) 464 may be configured for a horizontal field of view between 45 degrees and 135 degrees.

In some examples, LIDAR technologies, such as 3D flash LIDAR, may also be used. 3D Flash LIDAR uses a flash of a laser as a transmission source, to illuminate vehicle surroundings up to approximately 200 m. A flash LIDAR unit includes a receptor, which records the laser pulse transit time and the reflected light on each pixel, which in turn corresponds to the range from the vehicle to the objects. Flash LIDAR may allow for highly accurate and distortion-free images of the surroundings to be generated with every laser flash. In some examples, four flash LIDAR sensors may be deployed, one at each side of the vehicle 400. Available 3D flash LIDAR systems include a solid-state 3D staring array LIDAR camera with no moving parts other than a fan (e.g., a non-scanning LIDAR device). The flash LIDAR device may use a 5 nanosecond class I (eye-safe) laser pulse per frame and may capture the reflected laser light in the form of 3D range point clouds and co-registered intensity data. By using flash LIDAR, and because flash LIDAR is a solid-state device with no moving parts, the LIDAR sensor(s) 464 may be less susceptible to motion blur, vibration, and/or shock.

The vehicle may further include IMU sensor(s) 466. The IMU sensor(s) 466 may be located at a center of the rear axle of the vehicle 400, in some examples. The IMU sensor(s) 466 may include, for example and without limitation, an accelerometer(s), a magnetometer(s), a gyroscope(s), a magnetic compass(es), and/or other sensor types. In some examples, such as in six-axis applications, the IMU sensor(s) 466 may include accelerometers and gyroscopes, while in nine-axis applications, the IMU sensor(s) 466 may include accelerometers, gyroscopes, and magnetometers.

In some embodiments, the IMU sensor(s) 466 may be implemented as a miniature, high-performance GPS-Aided Inertial Navigation System (GPS/INS) that combines micro-electro-mechanical systems (MEMS) inertial sensors, a high-sensitivity GPS receiver, and advanced Kalman filtering algorithms to provide estimates of position, velocity, and attitude. As such, in some examples, the IMU sensor(s) 466 may enable the vehicle 400 to estimate heading without requiring input from a magnetic sensor by directly observing and correlating the changes in velocity from GPS to the IMU sensor(s) 466. In some examples, the IMU sensor(s) 466 and the GNSS sensor(s) 458 may be combined in a single integrated unit.

The vehicle may include microphone(s) 496 placed in and/or around the vehicle 400. The microphone(s) 496 may be used for emergency vehicle detection and identification, among other things.

The vehicle may further include any number of camera types, including stereo camera(s) 468, wide-view camera(s) 470, infrared camera(s) 472, surround camera(s) 474, long-range and/or mid-range camera(s) 498, and/or other camera types. The cameras may be used to capture image data around an entire periphery of the vehicle 400. The types of cameras used depends on the embodiments and requirements for the vehicle 400, and any combination of camera types may be used to provide the necessary coverage around the vehicle 400. In addition, the number of cameras may differ depending on the embodiment. For example, the vehicle may include six cameras, seven cameras, ten cameras, twelve cameras, and/or another number of cameras. The cameras may support, as an example and without limitation, Gigabit Multimedia Serial Link (GMSL) and/or Gigabit Ethernet. Each of the camera(s) is described with more detail herein with respect to FIG. 4A and FIG. 4B.

The vehicle 400 may further include vibration sensor(s) 442. The vibration sensor(s) 442 may measure vibrations of components of the vehicle, such as the axle(s). For example, changes in vibrations may indicate a change in road surfaces. In another example, when two or more vibration sensors 442 are used, the differences between the vibrations may be used to determine friction or slippage of the road surface (e.g., when the difference in vibration is between a power-driven axle and a freely rotating axle).

The vehicle 400 may include an ADAS system 438. The ADAS system 438 may include a SoC, in some examples. The ADAS system 438 may include autonomous/adaptive/automatic cruise control (ACC), cooperative adaptive cruise control (CACC), forward crash warning (FCW), automatic emergency braking (AEB), lane departure warnings (LDW), lane keep assist (LKA), blind spot warning (BSW), rear cross-traffic warning (RCTW), collision warning systems (CWS), lane centering (LC), and/or other features and functionality.

The ACC systems may use RADAR sensor(s) 460, LIDAR sensor(s) 464, and/or a camera(s). The ACC systems may include longitudinal ACC and/or lateral ACC. Longitudinal ACC monitors and controls the distance to the vehicle immediately ahead of the vehicle 400 and automatically adjust the vehicle speed to maintain a safe distance from vehicles ahead. Lateral ACC performs distance keeping, and advises the vehicle 400 to change lanes when necessary. Lateral ACC is related to other ADAS applications such as LCA and CWS.

CACC uses information from other vehicles that may be received via the network interface 424 and/or the wireless antenna(s) 426 from other vehicles via a wireless link, or indirectly, over a network connection (e.g., over the Internet). Direct links may be provided by a vehicle-to-vehicle (V2V) communication link, while indirect links may be infrastructure-to-vehicle (I2V) communication link. In general, the V2V communication concept provides information about the immediately preceding vehicles (e.g., vehicles immediately ahead of and in the same lane as the vehicle 400), while the I2V communication concept provides information about traffic further ahead. CACC systems may include either or both I2V and V2V information sources. Given the information of the vehicles ahead of the vehicle 400, CACC may be more reliable, and it has potential to improve traffic flow smoothness and reduce congestion on the road.

FCW systems are designed to alert the driver to a hazard, so that the driver may take corrective action. FCW systems use a front-facing camera and/or RADAR sensor(s) 460, coupled to a dedicated processor, DSP, FPGA, and/or ASIC, that is electrically coupled to driver feedback, such as a display, speaker, and/or vibrating component. FCW systems may provide a warning, such as in the form of a sound, visual warning, vibration and/or a quick brake pulse.

AEB systems detect an impending forward collision with another vehicle or other object, and may automatically apply the brakes if the driver does not take corrective action within a specified time or distance parameter. AEB systems may use front-facing camera(s) and/or RADAR sensor(s) 460, coupled to a dedicated processor, DSP, FPGA, and/or ASIC. When the AEB system detects a hazard, it typically first alerts the driver to take corrective action to avoid the collision and, if the driver does not take corrective action, the AEB system may automatically apply the brakes in an effort to prevent, or at least mitigate, the impact of the predicted collision. AEB systems, may include techniques such as dynamic brake support and/or crash imminent braking.

LDW systems provide visual, audible, and/or tactile warnings, such as steering wheel or seat vibrations, to alert the driver when the vehicle 400 crosses lane markings. A LDW system does not activate when the driver indicates an intentional lane departure, by activating a turn signal. LDW systems may use front-side facing cameras, coupled to a dedicated processor, DSP, FPGA, and/or ASIC, that is electrically coupled to driver feedback, such as a display, speaker, and/or vibrating component.

LKA systems are a variation of LDW systems. LKA systems provide steering input or braking to correct the vehicle 400 if the vehicle 400 starts to exit the lane. BSW systems detects and warn the driver of vehicles in an automobile's blind spot. BSW systems may provide a visual, audible, and/or tactile alert to indicate that merging or changing lanes is unsafe. The system may provide an additional warning when the driver uses a turn signal. BSW systems may use rear-side facing camera(s) and/or RADAR sensor(s).

RCTW systems may provide visual, audible, and/or tactile notification when an object is detected outside the rear-camera range when the vehicle 400 is backing up. Some RCTW systems include AEB to ensure that the vehicle brakes are applied to avoid a crash. RCTW systems may use one or more rear-facing RADAR sensor(s) 460, coupled to a dedicated processor, DSP, FPGA, and/or ASIC, that is electrically coupled to driver feedback, such as a display, speaker, and/or vibrating component.

Conventional ADAS systems may be prone to false positive results, which may be annoying and distracting to a driver, but typically are not catastrophic, because the ADAS systems alert the driver and allow the driver to decide whether a safety condition truly exists and act accordingly. However, in an autonomous vehicle 400, the vehicle 400 itself must, in the case of conflicting results, decide whether to heed the result from a primary computer or a secondary computer (e.g., a first controller 436 or a second controller 436). For example, in some embodiments, the ADAS system 438 may be a backup and/or secondary computer for providing perception information to a backup computer rationality module. The backup computer rationality monitor may run a redundant diverse software on hardware components to detect faults in perception and dynamic driving tasks. Outputs from the ADAS system 438 may be provided to a supervisory MCU. If outputs from the primary computer and the secondary computer conflict, the supervisory MCU must determine how to reconcile the conflict to ensure safe operation.

In some examples, the primary computer may be configured to provide the supervisory MCU with a confidence score, indicating the primary computer's confidence in the chosen result. If the confidence score exceeds a threshold, the supervisory MCU may follow the primary computer's direction, regardless of whether the secondary computer provides a conflicting or inconsistent result. Where the confidence score does not meet the threshold, and where the primary and secondary computer indicate different results (e.g., the conflict), the supervisory MCU may arbitrate between the computers to determine the appropriate outcome.

The supervisory MCU may be configured to run a neural network(s) that is trained and configured to determine, based on outputs from the primary computer and the secondary computer, conditions under which the secondary computer provides false alarms. Thus, the neural network(s) in the supervisory MCU may learn when the secondary computer's output may be trusted, and when it cannot. For example, when the secondary computer is a RADAR-based FCW system, a neural network(s) in the supervisory MCU may learn when the FCW system is identifying metallic objects that are not, in fact, hazards, such as a drainage grate or manhole cover that triggers an alarm. Similarly, when the secondary computer is a camera-based LDW system, a neural network in the supervisory MCU may learn to override the LDW when bicyclists or pedestrians are present and a lane departure is, in fact, the safest maneuver. In embodiments that include a neural network(s) running on the supervisory MCU, the supervisory MCU may include at least one of a DLA or GPU suitable for running the neural network(s) with associated memory. In preferred embodiments, the supervisory MCU may comprise and/or be included as a component of the SoC(s) 404.

In other examples, ADAS system 438 may include a secondary computer that performs ADAS functionality using traditional rules of computer vision. As such, the secondary computer may use classic computer vision rules (if-then), and the presence of a neural network(s) in the supervisory MCU may improve reliability, safety and performance. For example, the diverse implementation and intentional non-identity makes the overall system more fault-tolerant, especially to faults caused by software (or software-hardware interface) functionality. For example, if there is a software bug or error in the software running on the primary computer, and the non-identical software code running on the secondary computer provides the same overall result, the supervisory MCU may have greater confidence that the overall result is correct, and the bug in software or hardware on primary computer is not causing material error.

In some examples, the output of the ADAS system 438 may be fed into the primary computer's perception block and/or the primary computer's dynamic driving task block. For example, if the ADAS system 438 indicates a forward crash warning due to an object immediately ahead, the perception block may use this information when identifying objects. In other examples, the secondary computer may have its own neural network that is trained and thus reduces the risk of false positives, as described herein.

The vehicle 400 may further include the infotainment SoC 430 (e.g., an in-vehicle infotainment system (IVI)). Although illustrated and described as an SoC, the infotainment system may not be a SoC, and may include two or more discrete components. The infotainment SoC 430 may include a combination of hardware and software that may be used to provide audio (e.g., music, a personal digital assistant, navigational instructions, news, radio, etc.), video (e.g., TV, movies, streaming, etc.), phone (e.g., hands-free calling), network connectivity (e.g., LTE, Wi-Fi, etc.), and/or information services (e.g., navigation systems, rear-parking assistance, a radio data system, vehicle-related information such as fuel level, total distance covered, brake fuel level, oil level, door open/close, air filter information, etc.) to the vehicle 400. For example, the infotainment SoC 430 may include radios, disk players, navigation systems, video players, USB and Bluetooth connectivity, carputers, in-car entertainment, Wi-Fi, steering wheel audio controls, hands-free voice control, a heads-up display (HUD), an HMI display 434, a telematics device, a control panel (e.g., for controlling and/or interacting with various components, features, and/or systems), and/or other components. The infotainment SoC 430 may further be used to provide information (e.g., visual and/or audible) to a user(s) of the vehicle, such as information from the ADAS system 438, autonomous driving information such as planned vehicle maneuvers, trajectories, surrounding environment information (e.g., intersection information, vehicle information, road information, etc.), and/or other information.

The infotainment SoC 430 may include GPU functionality. The infotainment SoC 430 may communicate over the bus 402 (e.g., CAN bus, Ethernet, etc.) with other devices, systems, and/or components of the vehicle 400. In some examples, the infotainment SoC 430 may be coupled to a supervisory MCU such that the GPU of the infotainment system may perform some self-driving functions in the event that the primary controller(s) 436 (e.g., the primary and/or backup computers of the vehicle 400) fail. In such an example, the infotainment SoC 430 may put the vehicle 400 into a chauffeur to safe-stop mode, as described herein.

The vehicle 400 may further include an instrument cluster 432 (e.g., a digital dash, an electronic instrument cluster, a digital instrument panel, etc.). The instrument cluster 432 may include a controller and/or supercomputer (e.g., a discrete controller or supercomputer). The instrument cluster 432 may include a set of instrumentation such as a speedometer, fuel level, oil pressure, tachometer, odometer, turn indicators, gearshift position indicator, seat belt warning light(s), parking-brake warning light(s), engine-malfunction light(s), airbag (SRS) system information, lighting controls, safety system controls, navigation information, etc. In some examples, information may be displayed and/or shared among the infotainment SoC 430 and the instrument cluster 432. In other words, the instrument cluster 432 may be included as part of the infotainment SoC 430, or vice versa.

FIG. 4D is a system diagram for communication between cloud-based server(s) and the example autonomous vehicle 400 of FIG. 4A, in accordance with some embodiments of the present disclosure. The system 476 may include server(s) 478, network(s) 490, and vehicles, including the vehicle 400. The server(s) 478 may include a plurality of GPUs 484(A)-484(H) (collectively referred to herein as GPUs 484), PCIe switches 482(A)-482(H) (collectively referred to herein as PCIe switches 482), and/or CPUs 480(A)-480(B) (collectively referred to herein as CPUs 480). The GPUs 484, the CPUs 480, and the PCIe switches may be interconnected with high-speed interconnects such as, for example and without limitation, NVLink interfaces 488 developed by NVIDIA and/or PCIe connections 486. In some examples, the GPUs 484 are connected via NVLink and/or NVSwitch SoC and the GPUs 484 and the PCIe switches 482 are connected via PCIe interconnects. Although eight GPUs 484, two CPUs 480, and two PCIe switches are illustrated, this is not intended to be limiting. Depending on the embodiment, each of the server(s) 478 may include any number of GPUs 484, CPUs 480, and/or PCIe switches. For example, the server(s) 478 may each include eight, sixteen, thirty-two, and/or more GPUs 484.

The server(s) 478 may receive, over the network(s) 490 and from the vehicles, image data representative of images showing unexpected or changed road conditions, such as recently commenced road work. The server(s) 478 may transmit, over the network(s) 490 and to the vehicles, neural networks 492, updated neural networks 492, and/or map information 494, including information regarding traffic and road conditions. The updates to the map information 494 may include updates for the HD map 422, such as information regarding construction sites, potholes, detours, flooding, and/or other obstructions. In some examples, the neural networks 492, the updated neural networks 492, and/or the map information 494 may have resulted from new training and/or experiences represented in data received from any number of vehicles in the environment, and/or based on training performed at a datacenter (e.g., using the server(s) 478 and/or other servers).

The server(s) 478 may be used to train machine learning models (e.g., neural networks) based on training data. The training data may be generated by the vehicles, and/or may be generated in a simulation (e.g., using a game engine). In some examples, the training data is tagged (e.g., where the neural network benefits from supervised learning) and/or undergoes other pre-processing, while in other examples the training data is not tagged and/or pre-processed (e.g., where the neural network does not require supervised learning). Training may be executed according to any one or more classes of machine learning techniques, including, without limitation, classes such as: supervised training, semi-supervised training, unsupervised training, self learning, reinforcement learning, federated learning, transfer learning, feature learning (including principal component and cluster analyses), multi-linear subspace learning, manifold learning, representation learning (including spare dictionary learning), rule-based machine learning, anomaly detection, and any variants or combinations therefor. Once the machine learning models are trained, the machine learning models may be used by the vehicles (e.g., transmitted to the vehicles over the network(s) 490, and/or the machine learning models may be used by the server(s) 478 to remotely monitor the vehicles.

In some examples, the server(s) 478 may receive data from the vehicles and apply the data to up-to-date real-time neural networks for real-time intelligent inferencing. The server(s) 478 may include deep-learning supercomputers and/or dedicated AI computers powered by GPU(s) 484, such as a DGX and DGX Station machines developed by NVIDIA. However, in some examples, the server(s) 478 may include deep learning infrastructure that use only CPU-powered datacenters.

The deep-learning infrastructure of the server(s) 478 may be capable of fast, real-time inferencing, and may use that capability to evaluate and verify the health of the processors, software, and/or associated hardware in the vehicle 400. For example, the deep-learning infrastructure may receive periodic updates from the vehicle 400, such as a sequence of images and/or objects that the vehicle 400 has located in that sequence of images (e.g., via computer vision and/or other machine learning object classification techniques). The deep-learning infrastructure may run its own neural network to identify the objects and compare them with the objects identified by the vehicle 400 and, if the results do not match and the infrastructure concludes that the AI in the vehicle 400 is malfunctioning, the server(s) 478 may transmit a signal to the vehicle 400 instructing a fail-safe computer of the vehicle 400 to assume control, notify the passengers, and complete a safe parking maneuver.

For inferencing, the server(s) 478 may include the GPU(s) 484 and one or more programmable inference accelerators (e.g., NVIDIA's TensorRT). The combination of GPU-powered servers and inference acceleration may make real-time responsiveness possible. In other examples, such as where performance is less critical, servers powered by CPUs, FPGAs, and other processors may be used for inferencing

### Example Computing Device

FIG. 5 is a block diagram of an example computing device(s) 500 suitable for use in implementing some embodiments of the present disclosure. Computing device 500 may include an interconnect system 502 that directly or indirectly couples the following devices: memory 504, one or more central processing units (CPUs) 506, one or more graphics processing units (GPUs) 508, a communication interface 510, input/output (I/O) ports 512, input/output components 514, a power supply 516, one or more presentation components 518 (e.g., display(s)), and one or more logic units 520. In at least one embodiment, the computing device(s) 500 may comprise one or more virtual machines (VMs), and/or any of the components thereof may comprise virtual components (e.g., virtual hardware components). For non-limiting examples, one or more of the GPUs 508 may comprise one or more vGPUs, one or more of the CPUs 506 may comprise one or more vCPUs, and/or one or more of the logic units 520 may comprise one or more virtual logic units. As such, a computing device(s) 500 may include discrete components (e.g., a full GPU dedicated to the computing device 500), virtual components (e.g., a portion of a GPU dedicated to the computing device 500), or a combination thereof.

Although the various blocks of FIG. 5 are shown as connected via the interconnect system 502 with lines, this is not intended to be limiting and is for clarity only. For example, in some embodiments, a presentation component 518, such as a display device, may be considered an I/O component 514 (e.g., if the display is a touch screen). As another example, the CPUs 506 and/or GPUs 508 may include memory (e.g., the memory 504 may be representative of a storage device in addition to the memory of the GPUs 508, the CPUs 506, and/or other components). In other words, the computing device of FIG. 5 is merely illustrative. Distinction is not made between such categories as “workstation,” “server,” “laptop,” “desktop,” “tablet,” “client device,” “mobile device,” “hand-held device,” “game console,” “electronic control unit (ECU),” “virtual reality system,” and/or other device or system types, as all are contemplated within the scope of the computing device of FIG. 5.

The interconnect system 502 may represent one or more links or busses, such as an address bus, a data bus, a control bus, or a combination thereof. The interconnect system 502 may include one or more bus or link types, such as an industry standard architecture (ISA) bus, an extended industry standard architecture (EISA) bus, a video electronics standards association (VESA) bus, a peripheral component interconnect (PCI) bus, a peripheral component interconnect express (PCIe) bus, and/or another type of bus or link. In some embodiments, there are direct connections between components. As an example, the CPU 506 may be directly connected to the memory 504. Further, the CPU 506 may be directly connected to the GPU 508. Where there is direct, or point-to-point, connection between components, the interconnect system 502 may include a PCIe link to carry out the connection. In these examples, a PCI bus need not be included in the computing device 500.

The memory 504 may include any of a variety of computer-readable media. The computer-readable media may be any available media that may be accessed by the computing device 500. The computer-readable media may include both volatile and nonvolatile media, and removable and non-removable media. By way of example, and not limitation, the computer-readable media may comprise computer-storage media and communication media.

The computer-storage media may include both volatile and nonvolatile media and/or removable and non-removable media implemented in any method or technology for storage of information such as computer-readable instructions, data structures, program modules, and/or other data types. For example, the memory 504 may store computer-readable instructions (e.g., that represent a program(s) and/or a program element(s), such as an operating system. Computer-storage media may include, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which may be used to store the desired information and which may be accessed by computing device 500. As used herein, computer storage media does not comprise signals per se.

The computer storage media may embody computer-readable instructions, data structures, program modules, and/or other data types in a modulated data signal such as a carrier wave or other transport mechanism and includes any information delivery media. The term “modulated data signal” may refer to a signal that has one or more of its characteristics set or changed in such a manner as to encode information in the signal. By way of example, and not limitation, the computer storage media may include wired media such as a wired network or direct-wired connection, and wireless media such as acoustic, RF, infrared and other wireless media. Combinations of any of the above should also be included within the scope of computer-readable media.

The CPU(s) 506 may be configured to execute at least some of the computer-readable instructions to control one or more components of the computing device 500 to perform one or more of the methods and/or processes described herein. The CPU(s) 506 may each include one or more cores (e.g., one, two, four, eight, twenty-eight, seventy-two, etc.) that are capable of handling a multitude of software threads simultaneously. The CPU(s) 506 may include any type of processor, and may include different types of processors depending on the type of computing device 500 implemented (e.g., processors with fewer cores for mobile devices and processors with more cores for servers). For example, depending on the type of computing device 500, the processor may be an Advanced RISC Machines (ARM) processor implemented using Reduced Instruction Set Computing (RISC) or an x86 processor implemented using Complex Instruction Set Computing (CISC). The computing device 500 may include one or more CPUs 506 in addition to one or more microprocessors or supplementary co-processors, such as math co-processors.

In addition to or alternatively from the CPU(s) 506, the GPU(s) 508 may be configured to execute at least some of the computer-readable instructions to control one or more components of the computing device 500 to perform one or more of the methods and/or processes described herein. One or more of the GPU(s) 508 may be an integrated GPU (e.g., with one or more of the CPU(s) 506 and/or one or more of the GPU(s) 508 may be a discrete GPU. In embodiments, one or more of the GPU(s) 508 may be a coprocessor of one or more of the CPU(s) 506. The GPU(s) 508 may be used by the computing device 500 to render graphics (e.g., 3D graphics) or perform general purpose computations. For example, the GPU(s) 508 may be used for General-Purpose computing on GPUs (GPGPU). The GPU(s) 508 may include hundreds or thousands of cores that are capable of handling hundreds or thousands of software threads simultaneously. The GPU(s) 508 may generate pixel data for output images in response to rendering commands (e.g., rendering commands from the CPU(s) 506 received via a host interface). The GPU(s) 508 may include graphics memory, such as display memory, for storing pixel data or any other suitable data, such as GPGPU data. The display memory may be included as part of the memory 504. The GPU(s) 508 may include two or more GPUs operating in parallel (e.g., via a link). The link may directly connect the GPUs (e.g., using NVLINK) or may connect the GPUs through a switch (e.g., using NVSwitch). When combined together, each GPU 508 may generate pixel data or GPGPU data for different portions of an output or for different outputs (e.g., a first GPU for a first image and a second GPU for a second image). Each GPU may include its own memory, or may share memory with other GPUs.

In addition to or alternatively from the CPU(s) 506 and/or the GPU(s) 508, the logic unit(s) 520 may be configured to execute at least some of the computer-readable instructions to control one or more components of the computing device 500 to perform one or more of the methods and/or processes described herein. In embodiments, the CPU(s) 506, the GPU(s) 508, and/or the logic unit(s) 520 may discretely or jointly perform any combination of the methods, processes and/or portions thereof. One or more of the logic units 520 may be part of and/or integrated in one or more of the CPU(s) 506 and/or the GPU(s) 508 and/or one or more of the logic units 520 may be discrete components or otherwise external to the CPU(s) 506 and/or the GPU(s) 508. In embodiments, one or more of the logic units 520 may be a coprocessor of one or more of the CPU(s) 506 and/or one or more of the GPU(s) 508.

Examples of the logic unit(s) 520 include one or more processing cores and/or components thereof, such as Data Processing Units (DPUs), Tensor Cores (TCs), Tensor Processing Units (TPUs), Pixel Visual Cores (PVCs), Vision Processing Units (VPUs), Graphics Processing Clusters (GPCs), Texture Processing Clusters (TPCs), Streaming Multiprocessors (SMs), Tree Traversal Units (TTUs), Artificial Intelligence Accelerators (AIAs), Deep Learning Accelerators (DLAs), Arithmetic-Logic Units (ALUs), Application-Specific Integrated Circuits (ASICs), Floating Point Units (FPUs), input/output (I/O) elements, peripheral component interconnect (PCI) or peripheral component interconnect express (PCIe) elements, and/or the like.

The communication interface 510 may include one or more receivers, transmitters, and/or transceivers that enable the computing device 500 to communicate with other computing devices via an electronic communication network, include wired and/or wireless communications. The communication interface 510 may include components and functionality to enable communication over any of a number of different networks, such as wireless networks (e.g., Wi-Fi, Z-Wave, Bluetooth, Bluetooth LE, ZigBee, etc.), wired networks (e.g., communicating over Ethernet or InfiniBand), low-power wide-area networks (e.g., LoRaWAN, SigFox, etc.), and/or the Internet. In one or more embodiments, logic unit(s) 520 and/or communication interface 510 may include one or more data processing units (DPUs) to transmit data received over a network and/or through interconnect system 502 directly to (e.g., a memory of) one or more GPU(s) 508.

The I/O ports 512 may enable the computing device 500 to be logically coupled to other devices including the I/O components 514, the presentation component(s) 518, and/or other components, some of which may be built in to (e.g., integrated in) the computing device 500. Illustrative I/O components 514 include a microphone, mouse, keyboard, joystick, game pad, game controller, satellite dish, scanner, printer, wireless device, etc. The I/O components 514 may provide a natural user interface (NUI) that processes air gestures, voice, or other physiological inputs generated by a user. In some instances, inputs may be transmitted to an appropriate network element for further processing. An NUI may implement any combination of speech recognition, stylus recognition, facial recognition, biometric recognition, gesture recognition both on screen and adjacent to the screen, air gestures, head and eye tracking, and touch recognition (as described in more detail in the present disclosure) associated with a display of the computing device 500. The computing device 500 may include depth cameras, such as stereoscopic camera systems, infrared camera systems, RGB camera systems, touchscreen technology, and combinations of these, for gesture detection and recognition. Additionally, the computing device 500 may include accelerometers or gyroscopes (e.g., as part of an inertia measurement unit (IMU)) that enable detection of motion. In some examples, the output of the accelerometers or gyroscopes may be used by the computing device 500 to render immersive augmented reality or virtual reality.

The power supply 516 may include a hard-wired power supply, a battery power supply, or a combination thereof. The power supply 516 may provide power to the computing device 500 to enable the components of the computing device 500 to operate.

The presentation component(s) 518 may include a display (e.g., a monitor, a touch screen, a television screen, a heads-up-display (HUD), other display types, or a combination thereof), speakers, and/or other presentation components. The presentation component(s) 518 may receive data from other components (e.g., the GPU(s) 508, the CPU(s) 506, etc.), and output the data (e.g., as an image, video, sound, etc.).

### Example Data Center

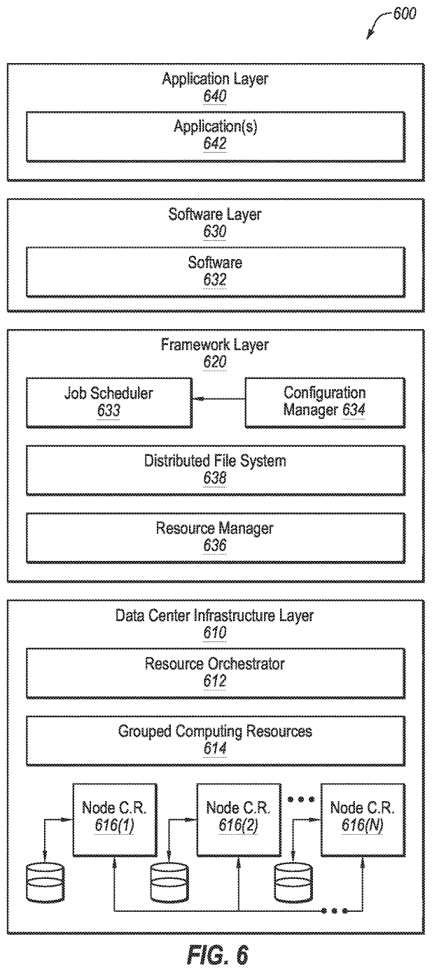

FIG. 6 illustrates an example data center 600 that may be used in at least one embodiments of the present disclosure. The data center 600 may include a data center infrastructure layer 610, a framework layer 620, a software layer 630, and/or an application layer 640.

As shown in FIG. 6, the data center infrastructure layer 610 may include a resource orchestrator 612, grouped computing resources 614, and node computing resources (“node C.R.s”) 616(1)-616(N), where “N” represents any whole, positive integer. In at least one embodiment, node C.R.s 616(1)-616(N) may include, but are not limited to, any number of central processing units (CPUs) or other processors (including DPUs, accelerators, field programmable gate arrays (FPGAs), graphics processors or graphics processing units (GPUs), etc.), memory devices (e.g., dynamic read-only memory), storage devices (e.g., solid state or disk drives), network input/output (NW I/O) devices, network switches, virtual machines (VMs), power modules, and/or cooling modules, etc. In some embodiments, one or more node C.R.s from among node C.R.s 616(1)-616(N) may correspond to a server having one or more of the above-mentioned computing resources. In addition, in some embodiments, the node C.R.s 616(1)-616(N) may include one or more virtual components, such as vGPUs, vCPUs, and/or the like, and/or one or more of the node C.R.s 616(1)-616(N) may correspond to a virtual machine (VM).

In at least one embodiment, grouped computing resources 614 may include separate groupings of node C.R.s 616 housed within one or more racks (not shown), or many racks housed in data centers at various geographical locations (also not shown). Separate groupings of node C.R.s 616 within grouped computing resources 614 may include grouped compute, network, memory or storage resources that may be configured or allocated to support one or more workloads. In at least one embodiment, several node C.R.s 616 including CPUs, GPUs, DPUs, and/or other processors may be grouped within one or more racks to provide compute resources to support one or more workloads. The one or more racks may also include any number of power modules, cooling modules, and/or network switches, in any combination.

The resource orchestrator 612 may configure or otherwise control one or more node C.R.s 616(1)-616(N) and/or grouped computing resources 614. In at least one embodiment, resource orchestrator 612 may include a software design infrastructure (SDI) management entity for the data center 600. The resource orchestrator 612 may include hardware, software, or some combination thereof.

In at least one embodiment, as shown in FIG. 6, framework layer 620 may include a job scheduler 632, a configuration manager 634, a resource manager 636, and/or a distributed file system 638. The framework layer 620 may include a framework to support software 632 of software layer 630 and/or one or more application(s) 642 of application layer 640. The software 632 or application(s) 642 may respectively include web-based service software or applications, such as those provided by Amazon Web Services, Google Cloud and Microsoft Azure. The framework layer 620 may be, but is not limited to, a type of free and open-source software web application framework such as Apache Spark™ (hereinafter “Spark”) that may utilize distributed file system 638 for large-scale data processing (e.g., “big data”). In at least one embodiment, job scheduler 632 may include a Spark driver to facilitate scheduling of workloads supported by various layers of data center 600. The configuration manager 634 may be capable of configuring different layers such as software layer 630 and framework layer 620 including Spark and distributed file system 638 for supporting large-scale data processing. The resource manager 636 may be capable of managing clustered or grouped computing resources mapped to or allocated for support of distributed file system 638 and job scheduler 632. In at least one embodiment, clustered or grouped computing resources may include grouped computing resource 614 at data center infrastructure layer 610. The resource manager 636 may coordinate with resource orchestrator 612 to manage these mapped or allocated computing resources.

In at least one embodiment, software 632 included in software layer 630 may include software used by at least portions of node C.R.s 616(1)-616(N), grouped computing resources 614, and/or distributed file system 638 of framework layer 620. One or more types of software may include, but are not limited to, Internet web page search software, e-mail virus scan software, database software, and streaming video content software.

In at least one embodiment, application(s) 642 included in application layer 640 may include one or more types of applications used by at least portions of node C.R.s 616(1)-616(N), grouped computing resources 614, and/or distributed file system 638 of framework layer 620. One or more types of applications may include, but are not limited to, any number of a genomics application, a cognitive compute, and a machine learning application, including training or inferencing software, machine learning framework software (e.g., PyTorch, TensorFlow, Caffe, etc.), and/or other machine learning applications used in conjunction with one or more embodiments.

In at least one embodiment, any of configuration manager 634, resource manager 636, and resource orchestrator 612 may implement any number and type of self-modifying actions based on any amount and type of data acquired in any technically feasible fashion. Self-modifying actions may relieve a data center operator of data center 600 from making possibly bad configuration decisions and possibly avoiding underutilized and/or poor performing portions of a data center.

The data center 600 may include tools, services, software or other resources to train one or more machine learning models or predict or infer information using one or more machine learning models according to one or more embodiments described herein. For example, a machine learning model(s) may be trained by calculating weight parameters according to a neural network architecture using software and/or computing resources described in the present disclosure with respect to the data center 600. In at least one embodiment, trained or deployed machine learning models corresponding to one or more neural networks may be used to infer or predict information using resources described in the present disclosure with respect to the data center 600 by using weight parameters calculated through one or more training techniques, such as but not limited to those described herein.

In at least one embodiment, the data center 600 may use CPUs, application-specific integrated circuits (ASICs), GPUs, FPGAs, and/or other hardware (or virtual compute resources corresponding thereto) to perform training and/or inferencing using above-described resources. Moreover, one or more software and/or hardware resources described in the present disclosure may be configured as a service to allow users to train or performing inferencing of information, such as image recognition, speech recognition, or other artificial intelligence services.

### Example Network Environments

Network environments suitable for use in implementing embodiments of the disclosure may include one or more client devices, servers, network attached storage (NAS), other backend devices, and/or other device types. The client devices, servers, and/or other device types (e.g., each device) may be implemented on one or more instances of the computing device(s) 500 of FIG. 5—e.g., each device may include similar components, features, and/or functionality of the computing device(s) 500. In addition, where backend devices (e.g., servers, NAS, etc.) are implemented, the backend devices may be included as part of a data center 600, an example of which is described in more detail herein with respect to FIG. 6.

Components of a network environment may communicate with each other via a network(s), which may be wired, wireless, or both. The network may include multiple networks, or a network of networks. By way of example, the network may include one or more Wide Area Networks (WANs), one or more Local Area Networks (LANs), one or more public networks such as the Internet and/or a public switched telephone network (PSTN), and/or one or more private networks. Where the network includes a wireless telecommunications network, components such as a base station, a communications tower, or even access points (as well as other components) may provide wireless connectivity.

Compatible network environments may include one or more peer-to-peer network environments—in which case a server may not be included in a network environment- and one or more client-server network environments—in which case one or more servers may be included in a network environment. In peer-to-peer network environments, functionality described herein with respect to a server(s) may be implemented on any number of client devices.

In at least one embodiment, a network environment may include one or more cloud-based network environments, a distributed computing environment, a combination thereof, etc. A cloud-based network environment may include a framework layer, a job scheduler, a resource manager, and a distributed file system implemented on one or more of servers, which may include one or more core network servers and/or edge servers. A framework layer may include a framework to support software of a software layer and/or one or more application(s) of an application layer. The software or application(s) may respectively include web-based service software or applications. In embodiments, one or more of the client devices may use the web-based service software or applications (e.g., by accessing the service software and/or applications via one or more application programming interfaces (APIs)). The framework layer may be, but is not limited to, a type of free and open-source software web application framework such as that may use a distributed file system for large-scale data processing (e.g., “big data”).

A cloud-based network environment may provide cloud computing and/or cloud storage that carries out any combination of computing and/or data storage functions described herein (or one or more portions thereof). Any of these various functions may be distributed over multiple locations from central or core servers (e.g., of one or more data centers that may be distributed across a state, a region, a country, the globe, etc.). If a connection to a user (e.g., a client device) is relatively close to an edge server(s), a core server(s) may designate at least a portion of the functionality to the edge server(s). A cloud-based network environment may be private (e.g., limited to a single organization), may be public (e.g., available to many organizations), and/or a combination thereof (e.g., a hybrid cloud environment).

The client device(s) may include at least some of the components, features, and functionality of the example computing device(s) 500 described herein with respect to FIG. 5. By way of example and not limitation, a client device may be embodied as a Personal Computer (PC), a laptop computer, a mobile device, a smartphone, a tablet computer, a smart watch, a wearable computer, a Personal Digital Assistant (PDA), an MP3 player, a virtual reality headset, a Global Positioning System (GPS) or device, a video player, a video camera, a surveillance device or system, a vehicle, a boat, a flying vessel, a virtual machine, a drone, a robot, a handheld communications device, a hospital device, a gaming device or system, an entertainment system, a vehicle computer system, an embedded system controller, a remote control, an appliance, a consumer electronic device, a workstation, an edge device, any combination of these delineated devices, or any other suitable device.

The disclosure may be described in the general context of computer code or machine-useable instructions, including computer-executable instructions such as program modules, being executed by a computer or other machine, such as a personal data assistant or other handheld device. Generally, program modules including routines, programs, objects, components, data structures, etc., refer to codes that perform particular tasks or implement particular abstract data types. The disclosure may be practiced in a variety of system configurations, including hand-held devices, consumer electronics, general-purpose computers, more specialty computing devices, etc. The disclosure may also be practiced in distributed computing environments where tasks are performed by remote-processing devices that are linked through a communications network.

As used herein, a recitation of “and/or” with respect to two or more elements should be interpreted to mean only one element, or a combination of elements. For example, “element A, element B, and/or element C” may include only element A, only element B, only element C, element A and element B, element A and element C, element B and element C, or elements A, B, and C. In addition, “at least one of element A or element B” may include at least one of element A, at least one of element B, or at least one of element A and at least one of element B. Further, “at least one of element A and element B” may include at least one of element A, at least one of element B, or at least one of element A and at least one of element B. Additionally, use of the term “based on” should not be interpreted as “only based on” or “based only on.” Rather, a first element being “based on” a second element includes instances in which the first element is based on the second element but may also be based on one or more additional elements.

The subject matter of the present disclosure is described with specificity herein to meet statutory requirements. However, the description itself is not intended to limit the scope of this disclosure. Rather, the inventors have contemplated that the claimed subject matter might also be embodied in other ways, to include different steps or combinations of steps similar to the ones described in this document, in conjunction with other present or future technologies. Moreover, although the terms “step” and/or “block” may be used herein to connote different elements of methods employed, the terms should not be interpreted as implying any particular order among or between various steps herein disclosed unless and except when the order of individual steps is explicitly described.

What is claimed is:

1. An Ethernet packet comprising:
a payload that includes data corresponding to a respective segment of a plurality of segments associated with an amount of data, the plurality of segments being sequentially ordered according to a sequence; and
a header including a sequence number field indicating a respective sequence number within the sequence that corresponds to the respective segment.

2. The Ethernet packet of claim 1, wherein the header includes one or more flag fields having flag data included therein, the flag data indicating whether the respective segment corresponding to the Ethernet packet includes:
a data type corresponding to the data;
a beginning segment of the data; or
an ending segment of the data.

3. The Ethernet packet according to claim 1, wherein the plurality of segments associated with the amount of data are individually included in a respective payload corresponding to a plurality of Ethernet packets.

4. The Ethernet packet of claim 3, wherein an individual header corresponding to a first Ethernet packet of the plurality of Ethernet packets includes a last good sequence number (LGSN) field having LGSN data included therein, the LGSN data indicating a sequence number corresponding to a second Ethernet packet of the plurality of Ethernet packets, wherein the second Ethernet packet is transmitted prior to the first Ethernet packet.

5. The Ethernet packet of claim 1, wherein the Ethernet packet is used to carry data corresponding to a system, the system being comprised in at least one of:
a control system for an autonomous or semi-autonomous machine;
a perception system for an autonomous or semi-autonomous machine;
a system for performing simulation operations;
a system for performing digital twin operations;
a system for performing light transport simulation;
a system for performing collaborative content creation for 3D assets;
a system for performing deep learning operations;
a system for presenting at least one of augmented reality content, virtual reality content, or mixed reality content;
a system for hosting one or more real-time streaming applications;
a system implemented using an edge device;
a system implemented using a robot;
a system for performing conversational AI operations;
a system implementing one or more large language models (LLMs);
a system for generating synthetic data;
a system incorporating one or more virtual machines (VMs);
a system implemented at least partially in a data center; or
a system implemented at least partially using cloud computing resources.

6. A system comprising:
memory to store data corresponding to a frame as received via a plurality of Ethernet packets, the data being divided into a plurality of segments that are sequentially ordered according to a sequence, one or more individual Ethernet packets respectively including:
a payload that includes a respective segment of the plurality of segments; and
a header including one or more of:
a sequence number field indicating a respective sequence number within the sequence that corresponds to the respective segment; and
a byte offset field indicating a respective byte offset to be applied to the segment;
hardware to perform one or more packet analysis operations including determining whether a previously transmitted segment was lost based at least on a first sequence number corresponding to a first segment and a second sequence number corresponding to a second segment.

7. The system of claim 6, further comprising:
a processing system to perform one or more or data processing operations with respect to the plurality of Ethernet packets, the one or more data processing operations including causing individual segments corresponding to the plurality of segments to be stored at respective memory locations included in the memory based at least on the respective byte offsets included in the plurality of Ethernet packets.

8. The system of claim 6, wherein the one or more data processing operations further include requesting retransmission of the data in response to a determination, made using the hardware, that one or more Ethernet packets were lost.

9. The system of claim 7, wherein the causing of the segment corresponding to the plurality of segments to be stored at respective memory locations included in the memory is further based at least on applying the respective byte offsets to a base memory address.

10. The system of claim 9, wherein the one or more data processing operations further include determining the base memory address.

11. The system of claim 7, wherein the header of one or more individual Ethernet packets respectively includes one or more flag fields having flag data included therein, the flag data indicating whether the respective segment corresponding to the one or more individual Ethernet packets includes:
a data type corresponding to the data;
a beginning segment of the data; or
an ending segment of the data.

12. The system of claim 11, wherein the processing system only processes data corresponding to the one or more Ethernet packets in response to the header of the one or more Ethernet packets including flag data in the one or more flag fields.

13. The system of claim 6, wherein the hardware includes one or more counters, comparators, arithmetic logic units, adders, or logic circuits.

14. The system of claim 7, wherein the processing system includes one or more central processing units (CPUs), graphics processing units (GPUs), data processing units (DPUs), parallel processing units (PPUs), microprocessors, field-programmable gate arrays (FPGA), application-specific integrated circuits (ASICs), accelerators, or deep learning accelerators (DLAs).

15. The system of claim 6, wherein the system is comprised in at least one of:
a control system for an autonomous or semi-autonomous machine;
a perception system for an autonomous or semi-autonomous machine;
a system for performing simulation operations;
a system for performing digital twin operations;
a system for performing light transport simulation;
a system for performing collaborative content creation for 3D assets;
a system for performing deep learning operations;
a system for presenting at least one of augmented reality content, virtual reality content, or mixed reality content;
a system for hosting one or more real-time streaming applications;
a system implemented using an edge device;
a system implemented using a robot;
a system for performing conversational AI operations;
a system implementing one or more large language models (LLMs);
a system for generating synthetic data;
a system incorporating one or more virtual machines (VMs);
a system implemented at least partially in a data center; or
a system implemented at least partially using cloud computing resources.

16. A method comprising:
performing one or more data processing operations with respect to a plurality of Ethernet packets, at least one data processing operation including causing individual segments, corresponding to a plurality of segments of data included in the plurality of Ethernet packets, to be stored at respective memory locations based at least on respective byte offsets included in the plurality of Ethernet packets, wherein individual Ethernet packets of the plurality of Ethernet packets include a header including a sequence number field indicating a respective sequence number within a sequence of segments corresponding to the data.

17. The method of claim 16, wherein the one or more data processing operations further include requesting retransmission of the data in response to a determination that one or more Ethernet packets were lost.

18. The method of claim 16, the header further including a byte offset field indicating a respective byte offset to be applied to the segment; and wherein the causing of the segment corresponding to the plurality of segments to be stored at respective memory locations included in the memory is further based at least on applying the respective byte offsets to a base memory address.

19. The method of claim 16, wherein the one or more data processing operations further include determining a base memory address.

20. The method of claim 16, wherein the header of one or more individual Ethernet packets respectively includes one or more flag fields having flag data included therein, the flag data indicating whether the respective segment corresponding to the one or more individual Ethernet packets includes:
a data type corresponding to the data;
a beginning segment of the data; or
an ending segment of the data.
